(19) United States
(12) Patent Application Publication
(10) Pub. No.: US 2013/0086328 A1
(43) Pub. Date: Apr. 4, 2013

(54) General Purpose Digital Data Processor, Systems and Methods

(71) Applicants: Steven J. Frank, Florence, MA (US); Hai Lin, Northampton, MA (US)

(72) Inventors: Steven J. Frank, Florence, MA (US); Hai Lin, Northampton, MA (US)

(73) Assignee: PANEVE, LLC, Hadley, MA (US)

(21) Appl. No.: 13/495,807

(22) Filed: Jun. 13, 2012

Related U.S. Application Data
(60) Provisional application No. 61/496,080, filed on Jun. 13, 2011.
(60) Provisional application No. 61/496,088, filed on Jun. 13, 2011.
(60) Provisional application No. 61/496,084, filed on Jun. 13, 2011.
(60) Provisional application No. 61/496,081, filed on Jun. 13, 2011.
(60) Provisional application No. 61/496,079, filed on Jun. 13, 2011.
(60) Provisional application No. 61/496,076, filed on Jun. 13, 2011.
(60) Provisional application No. 61/496,075, filed on Jun. 13, 2011.
(60) Provisional application No. 61/496,074, filed on Jun. 13, 2011.
(60) Provisional application No. 61/496,073, filed on Jun. 13, 2011.

(51) Int. Cl. G06F 12/08

(52) U.S. Cl. CPC G06F 12/0875
USPC 711/125

(57) ABSTRACT

The invention provides improved data processing apparatus, systems and methods that include one or more nodes, e.g., processor modules or otherwise, that include or are otherwise coupled to cache, physical or other memory (e.g., attached flash drives or other mounted storage devices) collectively, “system memory.” At least one of the nodes includes a cache memory system that stores data (and/or instructions) recently accessed (and/or expected to be accessed) by the respective node, along with tags specifying addresses and statuses (e.g., modified, reference count, etc.) for the respective data (and/or instructions). The tags facilitate translating system addresses to physical addresses, e.g., for purposes of moving data (and/or instructions) between system memory (and, specifically, for example, physical memory—such as attached drives or other mounted storage) and the cache memory system.

### REFERENCE TO RELATED APPLICATIONS

This application claims the benefit of filing of all of the following applications, the teachings of all of which are incorporated herein by reference:
General Purpose Embedded Processor and Digital Data Processing System Executing a Pipeline of Software Components that Replace a Like Pipeline of Hardware Components, Application No. 61/496,080, Filed Jun. 13, 2011—Atty Docket 109451-20
General Purpose Embedded Processor with Provision of Quality of Service Through Thread Installation, Maintenance and Optimization, Application No. 61/496,088, Filed Jun. 13, 2011—Atty Docket 109451-21
General Purpose Embedded Processor with Location-Independent Shared Execution Environment, Application No. 61/496,084, Filed Jun. 13, 2011—Atty Docket 109451-22
General Purpose Embedded Processor with Dynamic Assignment of Events to Threads, Application No. 61/496,081, Filed Jun. 13, 2011—Atty Docket 109451-23
Digital Data Processor with JPEG2000 BIT Plane Stripe Column Encoding, Application No. 61/496,079, Filed Jun. 13, 2011—Atty Docket 109451-24
Digital Data Processor with JPEG2000 Binary Arithmetic Coder Lookup, Application No. 61/496,076, Filed Jun. 13, 2011—Atty Docket 109451-25
Digital Data Processor with Cache-Managed System Memory, Application No. 61/496,075, Filed Jun. 13, 2011—Atty Docket 109451-26
Digital Data Processor With Cache Control Instruction Set and Cache-Initiated Optimization, Application No. 61/496,074, Filed Jun. 13, 2011—Atty Docket 109451-27
Digital Data Processor with Arithmetic Operation Transpose Parameter, Application No. 61/496,073, Filed Jun. 13, 2011—Atty Docket 109451-28

### BACKGROUND OF THE INVENTION

The invention pertains to digital data processing and, more particularly, to digital data processing modules, systems and methods with improved software execution. The invention has application, by way of example, to embedded processor architectures and operation. The invention has application in high-definition digital television, game systems, digital video recorders, video and/or audio players, personal digital assistants, personal knowledge navigators, mobile phones, and other multimedia and non-multimedia devices. It also has application in desktop, laptop, mini computer, mainframe computer and other computing devices.

Prior art embedded processor-based or application systems typically combine: (1) one or more general purpose processors, e.g., of the ARM, MIPs or x86 variety, for handling user interface processing, high level application processing, and operating system tasks, with (2) one or more digital signal processors (DSPs), including media processors, dedicated to handling specific types of arithmetic computations at specific interfaces or within specific applications, on real-time/low latency bases. Instead of, or in addition to, the DSPs, special-purpose hardware is often provided to handle dedicated needs that a DSP is unable to handle on a programmable basis, e.g., because the DSP cannot handle multiple activities at once or because the DSP cannot meet needs for a very specialized computational element.

The prior art also includes personal computers, workstations, laptop computers and other such computing devices which typically combine a main processor with a separate graphics processor and a separate sound processor; game systems, which typically combine a main processor and separately programmed graphics processor; digital video recorders, which typically combine a general purpose processor, mpeg2 decoder and encoder chips, and special-purpose digital signal processors; digital televisions, which typically combine a general purpose processor, mpeg2 decoder and encoder chips, and special-purpose DSPs or media processors; mobile phones, which typically combine a processor for user interface and applications processing and special-purpose DSPs for mobile phone GSM, CDMA or other protocol processing.

Earlier prior art patents include U.S. Pat. No. 6,408,381, disclosing a pipeline processor utilizing snapshot files with entries indicating the state of instructions in the various pipeline stages, and U.S. Pat. No. 6,219,780, which concerns improving the throughput of computers with multiple execution units grouped in clusters. One problem with the earlier prior art approaches was hardware design complexity, combined with software complexity in programming and interfacing heterogeneous types of computing elements. Another problem was that both hardware and software must be re-engineered for every application. Moreover, early prior art systems do not load balance: capacity cannot be transferred from one hardware element to another.

Among other trends, the world is going video—that is, the consumer, commercial, educational, governmental and other markets are increasingly demanding video creation and/or playback to meet user needs. Video and image processing is, thus, one dominant usage for embedded devices and is pervasive in devices, throughout the consumer and business devices, among others. However, many of the processors still in use today rely on decades-old Intel and ARM architectures that were optimized for text processing in eras gone by.

An object of this invention is to provide improved modules, systems and methods for digital data processing.

A further object of the invention is to provide such modules, systems and methods with improved software execution.

A related object is to provide such modules, systems and methods as are suitable for an embedded environment or application.

A further related object is to provide such modules, systems and methods as are suitable for video and image processing.

Another related object is to provide such modules, systems and methods as facilitate design, manufacture, time-to-market, cost and/or maintenance.

A further object of the invention is to provide improved modules, systems and methods for embedded (or other) processing that meet the computational, size, power and cost requirements of today's and future appliances, including by way of non-limiting example, digital televisions, digital video recorders, video and/or audio players, personal digital assistants, personal knowledge navigators, and mobile phones, to name but a few.

Yet another object is to provide improved modules, systems and methods that support a range of applications.

Still yet another object is to provide such modules, systems and methods which are low-cost, low-power and/or support robust rapid-to-market implementations.

Yet still another object is to provide such modules, systems and methods which are suitable for use with desktop, laptop, mini computer, mainframe computer and other computing devices.

These and other aspects of the invention are evident in the discussion that follows and in the drawings.

### SUMMARY OF THE INVENTION

### Digital Data Processor with Cache-Managed Memory

The foregoing are among the objects attained by the invention which provides, in some aspects, an improved digital data processing system with cache-controlled system memory. A system according to one such aspect of the invention includes one or more nodes, e.g., processor modules or otherwise, that include or are otherwise coupled to cache, physical or other memory (e.g., attached flash drives or other mounted storage devices)—collectively, “system memory”

At least one of the nodes includes a cache memory system that stores data (and/or instructions) recently accessed (and/or expected to be accessed) by the respective node, along with tags specifying addresses and statuses (e.g., modified, reference count, etc.) for the respective data (and/or instructions). The caches may be organized in multiple hierarchical levels (e.g., a level 1 cache, a level 2 cache, and so forth), and the addresses may form part of a “system” address that is common to multiple ones of the nodes.

The system memory and/or the cache memory may include additional (or “extension”) tags. In addition to specifying system addresses and statuses for respective data (and/or instructions), the extension tags specify physical address of those data in system memory. As such, they facilitate translating system addresses to physical addresses, e.g., for purposes of moving data (and/or instructions) between system memory (and, specifically, for example, physical memory—such as attached drives or other mounted storage) and the cache memory system.

Related aspects of the invention provide a system, e.g., as described above, in which one extension tag is provided for each addressable datum (or data block or page, as the case may be) in system memory.

Further aspects of the invention provide a system, e.g., as described above, in which the extension tags are organized as a tree in system memory.

Related aspects of the invention provide such a system in which one or more of the extension tags are cached in the cache memory system of one or more nodes. These may include, for example, extension tags for data recently accessed (or expected to be accessed) by those nodes following cache “misses” for that data within their respective cache memory systems.

Further related aspects of the invention provide such a system that comprises a plurality of nodes that are coupled for communications with one another as well, preferably, as with the memory system, e.g., by a bus, network or other media. In related aspects, this comprises a ring interconnect.

A node, according to still further aspects of the invention, can signal a request for a datum along that bus, network or other media following a cache miss within its own internal cache memory system for that datum. System memory can satisfy that request, or a subsequent related request for the datum, if none of the other nodes do so.

In related aspects of the invention, a node can utilize the bus, network or other media to communicate to other nodes and/or the memory system updates to cached data and/or extension tags.

Further aspects of the invention provide a system, e.g., as described above, in which one or more nodes, includes a first level of cache that contains frequently and/or recently used data and/or instructions, and at least a second level of cache that contains a superset of data and/or instructions in the first level of cache.

Other aspects of the invention provide systems e.g., as described above, that utilize fewer or greater than the two levels of cache within the nodes. Thus, for example, the system nodes may include only a single level of cache, along with extension tags of the type described above.

Still further aspects of the invention provide systems, e.g., as described above, wherein the nodes comprise, for example, processor modules, memory modules, digital data processing systems (or interconnects thereto), and/or a combination thereof.

Yet still further aspects of the invention provide such systems where, for example, one or more levels of cache (e.g., the first and second levels) are contained, in whole or in part, on one or more of the nodes, e.g., processor modules.

Advantages of digital data modules, systems and methods according to the invention are that all system addresses are treated as if cached in the memory system. Accordingly an addressable item that is present in the system—regardless, for example, of whether it is in cache memory, physical memory (e.g., an attached flash drive or other mounted storage device)—has an entry in one of the levels of cache. An item that is not present in any cache (and the memory system), i.e., is not reflected in any of the cache levels, is then not present in the memory system. Thus the memory system can be filled sparsely in a way that is natural to software and operating system, without the overhead of tables on the processor.

Advantages of digital data modules, systems and methods according to the invention are that they afford efficient utilization of memory, esp., where that might be limited, e.g., on mobile and consumer devices.

Further advantages are that digital data modules, systems and methods experience performance improvements of all memory being managed as cache without on-chip area penalty. This in turn enables memory, e.g., of mobile and consumer devices, to be expanded by another networked device. It can also be used, by way of further non limiting example, to manage RAM and FLASH memory, e.g., on more recent portable devices such as net books.

General Purpose Processor with Dynamic Assignment of Events to Threads

Further aspects of the invention provide processor modules, systems and methods, e.g., as described above, in which a processing module comprises a plurality of processing units that each execute processes or threads (collectively, “threads”). An event table maps events—such as, by way of non-limiting example, hardware interrupts, software interrupts and memory events—to respective threads. Devices and/or software (e.g., applications, processes and/or threads) register, e.g., with a default system thread or otherwise, to identify event-processing services that they require and/or that they can provide. That thread or other mechanism continually matches those and updates the event table to reflect a mapping of events to threads, based on the demands and capabilities of the overall environment.

Related aspects of the invention provide systems and methods incorporating a processor, e.g., as described above, in which code utilized by hardware devices or software to register their event-processing needs and/or capabilities is generated, for example, by a preprocessor based on directives supplied by a developer, manufacturer, distributor, retailer, post-sale support personnel, end user or otherwise about actual or expected runtime environments in which the processor is or will be used.

Further related aspects of the invention provide such a method in which such code can be inserted into the individual applications' respective runtime code by the preprocessor, etc.

General Purpose Processor With Location-Independent Shared Execution Environment

Further aspects of the invention provide processor modules, systems and methods, e.g., as described above, that permit application and operating system-level threads to be transparently executed across different devices (including mobile devices) and which enable such device to automatically off load work to improve performance and lower power consumption.

Related aspects of the invention provide such modules, systems and methods in which events detected by a processor executing on one device can be routed for processing to a processor, e.g., executing on another device.

Other related aspects of the invention provide such modules, systems and methods in which threads executing on one device can be migrated, e.g., to a processor on another device and, thereby, for example, to processor events local to that other device and/or to achieve load balancing, both way way of example. Thus, for example, threads can migrated, e.g., to less busy devices, to better suited devices or, simply, to a device where most of events are expected to occur. Further aspects of the invention provide modules, systems and methods, e.g., as described above in which events are routed and/or threads are migrated between and among processors in multiple different devices and/or among multiple processors on a single device.

Yet still other aspects of the invention provide modules, systems and methods, e.g., as described above in which tables for routing events are implemented in novel memory/cache structures, e.g., such that the tables of cooperating processor modules (e.g., those on a local area network) comprise single shared hierarchical table.

General Purpose Processor with Provision of Quality of Service Through Thread Instantiation, Maintenance and Optimization

Further aspects of the invention provide processor modules, systems and methods, e.g., as described above, in which a processor comprises a plurality of processing units that each execute processes or threads (collectively, “threads”). An event delivery mechanism delivers events—such as, by way of non-limiting example, hardware interrupts, software interrupts and memory events—to respective threads. A preprocessor (or other functionality), e.g., executed by a designer, manufacturer, distributor, retailer, post-sale support personnel, end-user, or other responds to expected core and/or site resource availability, as well as to user prioritization, to generate default system thread code, link parameters, etc., that optimize thread instantiation, maintenance and thread assignment at runtime.

Related aspects of the invention provide modules, systems and methods executing threads, e.g., a default system thread, created as discussed above.

Still further related aspects of the invention provide modules, systems and methods executing threads that are compiled, linked, loaded and/or invoked in accord with the foregoing.

Yet still further related aspects of the invention provide modules, systems and methods, e.g., as described above, in which the default system thread or other functionality insures instantiation of an appropriate number of threads at an appropriate time, e.g., to meet quality of service requirements.

Further related aspects of the invention provide such a method in which such code can be inserted into the individual applications' respective source code by the preprocessor, etc.

General Purpose Processor with JPEG2000 Bit Plane Stripe Column Encoding

Further aspects of the invention provide processor modules, systems and methods, e.g., as described above, that include an arithmetic logic or other execution unit that is in communications coupling with one or more registers. That execution unit executes a selected processor-level instruction by encoding and storing to one (or more) of the register(s) a stripe column for bit plane coding within JPEG2000 EBCOT (Embedded Block Coding with Optimized Truncation).

Related aspects of the invention provide processor modules, systems and methods, e.g., as described above, in which the execution unit generates the encoded stripe column based on specified bits of a column to be encoded and on bits adjacent thereto.

Further related aspects of the invention provide processor modules, systems and methods, e.g., as described above, in which the execution unit generates the encoded stripe column from four bits of the column to be encoded and on the bits adjacent thereto.

Still further aspects of the invention provide processor modules, systems and methods, e.g., as described above, in which the execution unit generates the encoded stripe column in response to execution of an instruction that specifies, in addition to the bits of the column to be encoded and adjacent thereto, a current coding state of at least one of the bits to be encoded.

Yet still further aspects of the invention provide processor modules, systems and methods, e.g., as described above, in which the coding state of each bit to be encoded is represented in three bits.

Still further aspects of the invention provide processor modules, systems and methods, e.g., as described above, in which the execution unit generates the encoded stripe column in response to execution of an instruction that specifies an encoding pass that includes any of a significance propagation pass (SP), a magnitude refinement pass (MR), a cleanup pass, and a combined MR and CP pass.

Yet still further related aspects of the invention provides processor modules, systems and methods, e.g., as described above, in which the execution unit selectively generates and stores to one or more registers an updated coding state of at least one of the bits to be encoded.

General Purpose Processor with JPEG2000 Binary Arithmetic Code Lookup

Further aspects of the invention provide processor modules, systems and methods, e.g., as described above, in which an arithmetic logic or other execution unit that is in communications coupling with one or more registers executes a selected processor-level instruction by storing to that/those register(s) value(s) from a JPEG2000 binary arithmetic coder lookup table.

Related aspects of the invention provide processor modules, systems and methods as described above in which the JPEG2000 binary arithmetic coder lookup table is a Qe-value and probability estimation lookup table.

Related aspects of the invention provide processor modules, systems and methods as describe above in which the execution unit responds to such a selected processor-level instruction by storing to said one or more registers one or more function values from such a lookup table, where those functions are selected from a group Qe-value, NMPS, NLPS and SWITCH functions.

In further related aspects, the invention provides processor modules, systems and methods, e.g., as described above, in which the execution logic unit stores said one or more values to said one or more registers as part of a JPEG2000 decode or encode instruction sequence.

General Purpose Processor with Arithmetic Operation Transpose Parameter

Further aspects of the invention provide processor modules, systems and methods, e.g., as described above, in which an arithmetic logic or other execution unit that is in communications coupling with one or more registers executes a selected processor-level instruction specifying arithmetic operations with transpose by performing the specified arithmetic operations on one or more specified operands, e.g., longwords, words or bytes, contained in respective ones of the registers to generate and store the result of that operation in transposed format, e.g., across multiple specified registers.

In related aspects, the invention provides processor modules, systems and methods, e.g., as described above, in which the arithmetic logic unit writes the result, for example, as a one-quarter word column of four adjacent registers or, by way of further example, a byte column of eight adjacent registers.

In further related aspects, the invention provides processor modules, systems and methods, e.g., as described above, in which the arithmetic logic unit breaks the result (e.g., longwords, words or bytes) into separate portions (e.g., words, bytes or bits) and puts them into separate registers, e.g., at a specific common byte, bit or other location in each of those registers.

In further related aspects, the invention provides processor modules, systems and methods, e.g., as described above, in which the selected arithmetic operation is an addition operation.

In further related aspects, the invention provides processor modules, systems and methods, e.g., as described above, in which the selected arithmetic operation is a subtraction operation.

General Purpose Processor with Cache Control Instruction Set and Cache-Initiated Optimization

Further aspects of the invention provide processor modules, systems and methods, e.g., as described above, with improved cache operation. A processor module according to such aspects, for example, can include an arithmetic logic or other execution unit that is in communications coupling with one or more registers, as well as with cache memory. Functionality associated with the cache memory works cooperatively with the execution unit to vary utilization of the cache memory in response to load, store and other requests that effect data and/or instruction exchanges between the registers and the cache memory.

Related aspects of the invention provide processor modules, systems and methods, e.g., as described above, in which the (aforesaid functionality associated with the) cache memory varies replacement and modified block writeback selectively in response to memory reference instructions (a term that is used interchangeably herein, unless otherwise evident from context, with the term “memory reference instructions”) executed by the execution unit.

Further related aspects of the invention provide processor modules, systems and methods, e.g., as described above, in which the (aforesaid functionality associated with the) cache memory varies a value of a “reference count” that is associated with cached instructions and/or data selectively in response to such memory reference instructions.

Still further aspects of the invention provide processor modules, systems and methods, e.g., as described above, in which the (aforesaid functionality associated with the) cache memory forces the reference count value to a lowest value in response to selected memory reference instructions, thereby, insuring that the corresponding cache entry will be a next one to be replaced.

Related aspects of the invention provide such processor modules, systems and methods in which such instructions include parameters (e.g., the “reuse/no-reuse cache hint”) for influencing the reference counts accordingly. These can include, by way of example, any of load, store, “fill” and “empty” instructions and, more particularly, by way of example, can include one or more of LOAD (Load Register), STORE (Store to Memory), LOADPAIR (Load Register Pair), STOREPAIR (Store Pair to Memory), PREFETCH (Prefetch Memory), LOADPRED (Load Predicate Register), STOREPRED (Store Predicate Register), EMPTY (Empty Memory), and FILL (Fill Memory) instructions.

Yet still further aspects of the invention provide processor modules, systems and methods, e.g., as described above, in which the (aforesaid functionality associated with the) cache memory works cooperatively with the execution unit to prevent large memory arrays that are not frequently accessed from removing other cache entries that are frequently used.

Other aspects of the invention provide processor modules, systems and methods with functionality that varies replacement and writeback of cached data/instructions and updates in accord with (a) the access rights of the acquiring cache, and (b) the nature of utilization of such data by in other processor modules. This can be effected in connection memory access instruction execution parameters and/or via “automatic” operation of the caching subsystems (and/or cooperating mechanisms in the operating system).

Still yet further aspects of the invention provide processor modules, systems and methods, e.g., as described above, that include a novel virtual memory and memory system architecture features in which inter alia all memory is effectively managed as cache.

Other aspects of the invention provide processor modules, systems and methods, e.g., as described above, in which the (aforesaid functionality associated with the) cache memory works cooperatively with the execution unit to perform requested operations on behalf of an executing thread. On multiprocessor systems these operations can span to non-local level2 and level2 extended caches.

General Purpose Processor and Digital Data Processing System Executing a Pipeline of Software Components that Replace a Like Pipeline of Hardware Components

Further aspects of the invention provide processor modules, systems and methods, e.g., as described above, that execute pipelines of software components in lieu of like pipelines of hardware components of the type normally employed by prior art devices.

Thus, for example, a processor according to the invention can execute software components pipelined for video processing and including a H.264 decoder software module, a scalar and noise reduction software module, a color correction software module, a frame race control software module—all in lieu of a like hardware pipeline, namely, one including a semiconductor chip that functions as a system controller with H.264 decoding, pipelined to a semiconductor chip that functions as a scaler and noise reduction module, pipelined to a semiconductor chip that functions for color correction, and further pipelined to a semiconductor chip that functions as a frame rate controller.

Related aspects of the invention provide such digital data processing systems and methods in which the processing modules execute the pipelined software components as separate respective threads.

Further related aspects of the invention provide digital data processing systems and methods, e.g., as described above, comprising a plurality of processing modules, each executing pipelines of software components in lieu of like hardware components.

Yet further related aspects of the invention provide digital data processing systems and methods, e.g., as described above, in which at least one of plural threads defining different respective components of a pipeline (e.g., for video processing) is executed on a different processing module than one or more threads defining those other respective components.

Still yet further related aspects of the invention provide digital data processing systems and methods, e.g., as described above, in which at least one of the processor modules includes an arithmetic logic or other execution unit and further includes a plurality of levels of cache, at least one of which stores some information on circuitry common to the execution unit (i.e., on chip) and which stores other information off circuitry common to the execution unit (i.e., off chip).

Yet still further aspects of the invention provide digital data processing systems and methods, e.g., as described above, in which plural ones of the processing modules include levels of cache as described above. The cache levels of those respective processors can, according, to related aspects of the invention, manage the storage and access or data and/or instructions common to the entire digital data processing system.

Advantages of processing modules, digital data processing systems, and methods according to the invention are, among others, that they enable a single processor to handle all application, image, signal and network processing—by way of example—of a mobile, consumer and/or other products, resulting in lower cost and power consumption. A further advantage is that they avoid the recurring complexity designing, manufacturing, assembling and testing hardware pipelines, as well as that of writing software for such hardware pipelined-devices.

These and other aspects of the invention are evident in the discussion that follows and in the drawings.

### BRIEF DESCRIPTION OF THE DRAWINGS

A more complete understanding of the invention may be attained by reference to the drawings, in which:

FIG. 1 depicts a system including processor modules according to the invention;

FIG. 2 depicts a system comprising two processor modules of the type shown in FIG. 1;

FIG. 3 depicts thread states and transitions in a system according to the invention;

FIG. 4 depicts thread-instruction abstraction in a system according to the invention;

FIG. 5 depicts event binding and processing in a processor module according to the invention;

FIG. 6 depicts registers in a processor module of a system according to the invention;

FIGS. 7-10 depict add instructions in a processor module of a system according to the invention;

FIGS. 11-16 depict pack and unpack instructions in a processor module of a system according to the invention;

FIGS. 17-18 depict bit plane stripe instructions in a processor module of a system according to the invention;

FIG. 19 depicts a memory address model in a system according to the invention;

FIG. 20 depicts a cache memory hierarchy organization in a system according to the invention;

FIG. 21 depicts overall flow of an L2 and L2E cache operation in a system according to the invention;

FIG. 22 depicts organization of the L2 cache in a system according to the invention;

FIG. 23 depicts the result of an L2E access hit in a system according to the invention;

FIG. 24 depicts an L2E descriptor tree look-up in a system according to the invention;

FIG. 25 depicts an L2E physical memory layout in a system according to the invention;

FIG. 26 depicts a segment table entry format in a system according to the invention;

FIGS. 27-29 depict, respectively, L1, L2 and L2E Cache addressing and tag formats in an SEP system according to the invention;

FIG. 30 depicts an IO address space format in a system according to the invention;

FIG. 31 depicts a memory system implementation in a system according to the invention;

FIG. 32 depicts a runtime environment provided by a system according to the invention for executing tiles;

FIG. 33 depicts a further runtime environment provided by a system according to the invention;

FIG. 34 depicts advantages of processor modules and systems according to the invention;

FIG. 35 depicts typical implementation of a consumer (or other) device for video processing;

FIG. 36 depicts implementation of the device of FIG. 35 in a system according to the invention;

FIG. 37 depicts use of a processor in accord with one practice of the invention for parallel execution of applications and other components of the runtime environment;

FIG. 38 depicts a system according to the invention that permits dynamic assignment of events to threads;

FIG. 39 depicts a system according to the invention that provides a location-independent shared execution environment;

FIG. 40 depicts migration of threads in a system according to the invention with a location-independent shared execution environment and with dynamic assignment of events to threads;

FIG. 41 is a key to symbols used in FIG. 40;

FIG. 42 depicts a system according to the invention that facilitates the permits of quality of service through thread instantiation, maintenance and optimization;

FIG. 43 depicts a system according to the invention in which the functional units execute selected arithmetic operations concurrently with transposes;

FIG. 44 depicts a system according to the invention in which the functional units execute processor-level instructions by storing to register(s) value(s) from a JPEG2000 binary arithmetic coder lookup table;

FIG. 45 depicts a system according to the invention in which the functional units execute processor-level instructions by encoding a stripe column of values in registers for bit plane coding within JPEG2000 EBCOT;

FIG. 46 depicts a system according to the invention wherein a pipeline of instructions executing on cores serve as software equivalents of corresponding hardware pipelines of the type traditionally practiced in the prior art; and

FIGS. 47 and 48 show the effect of memory access instructions with and without a no-reuse hint on caches in a system according to the invention.

### DETAILED DESCRIPTION OF THE ILLUSTRATED EMBODIMENT

### Overview

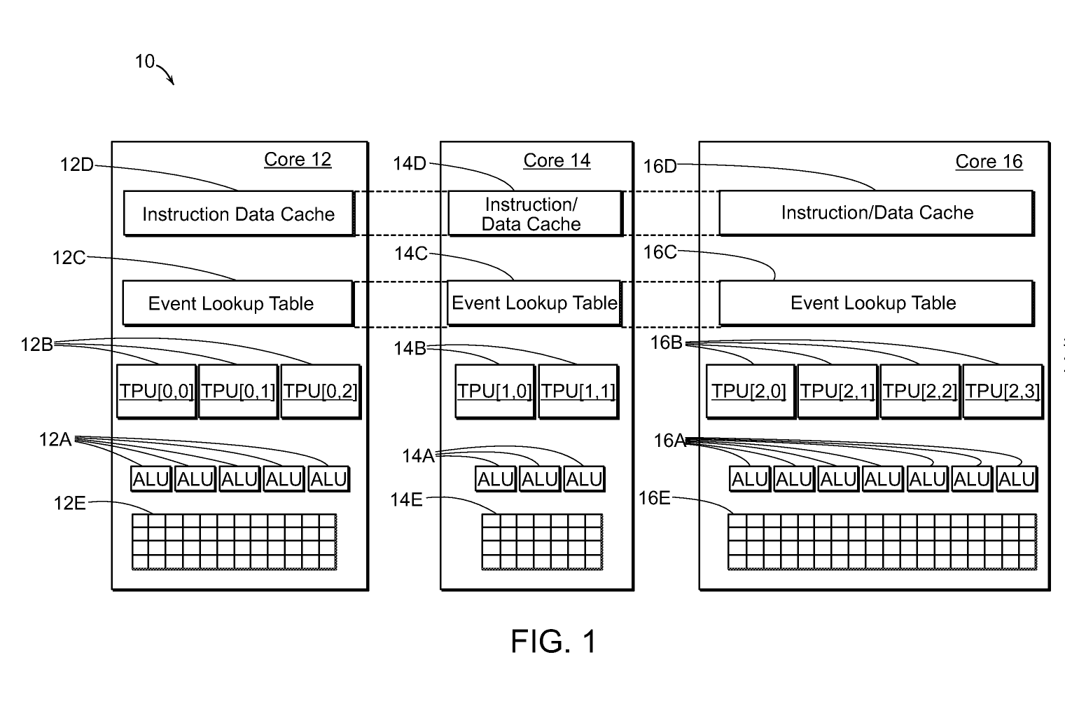

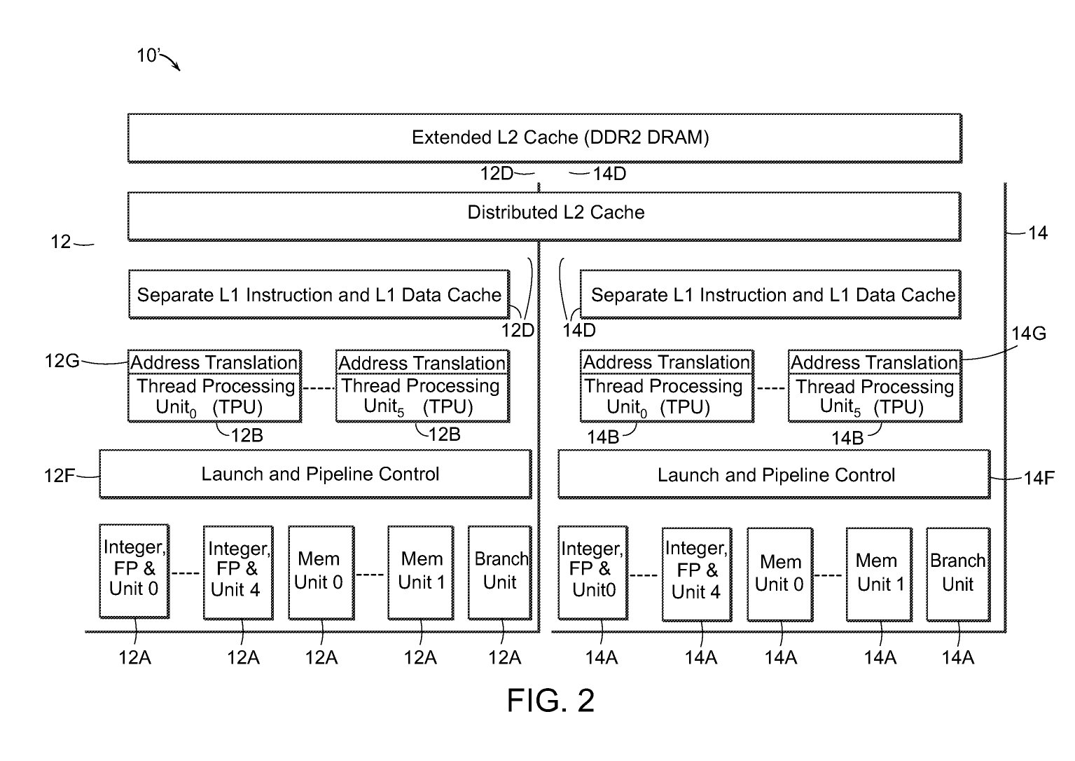

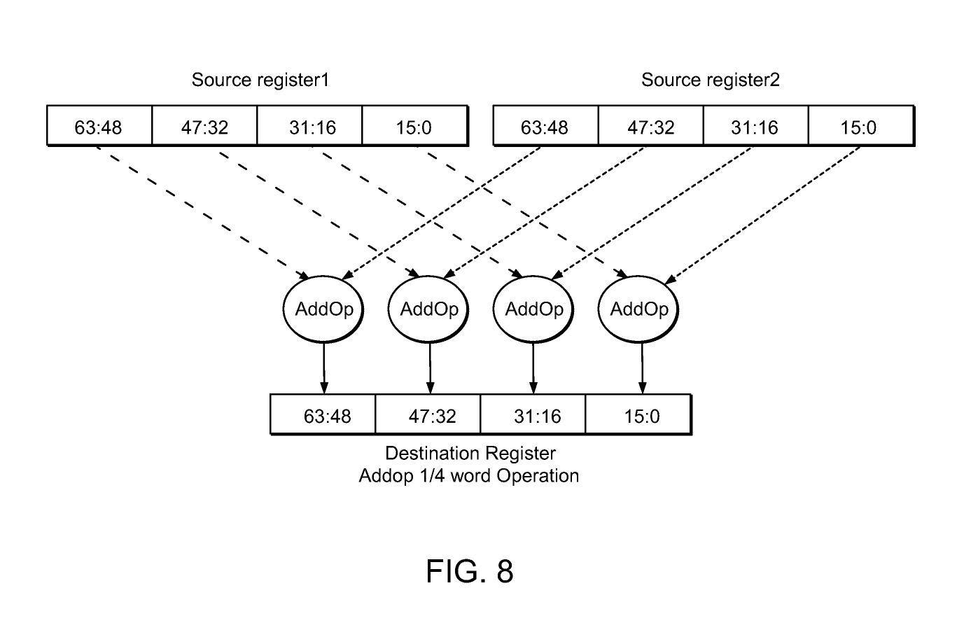

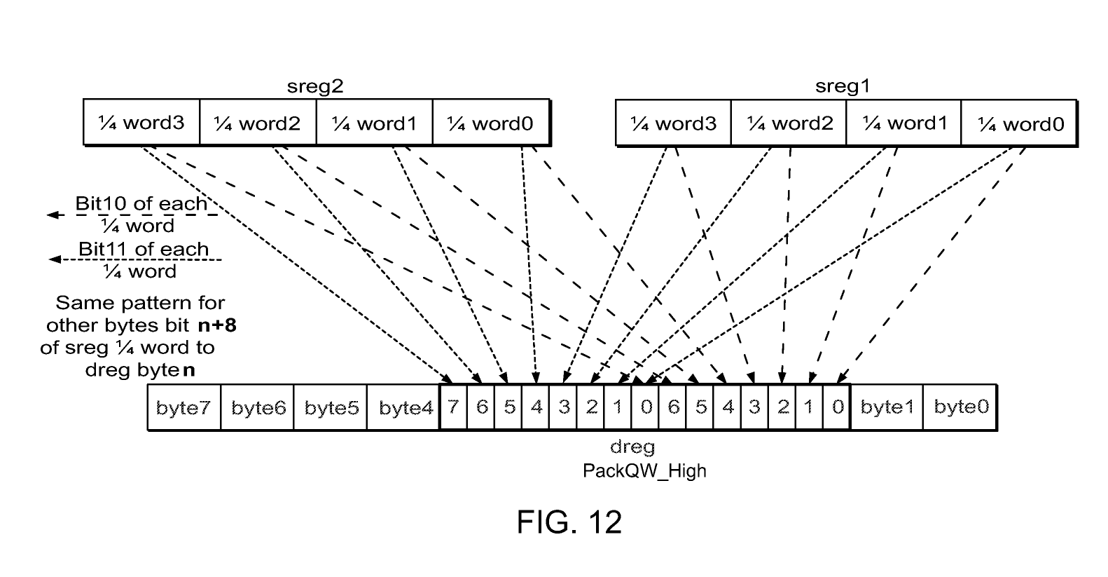

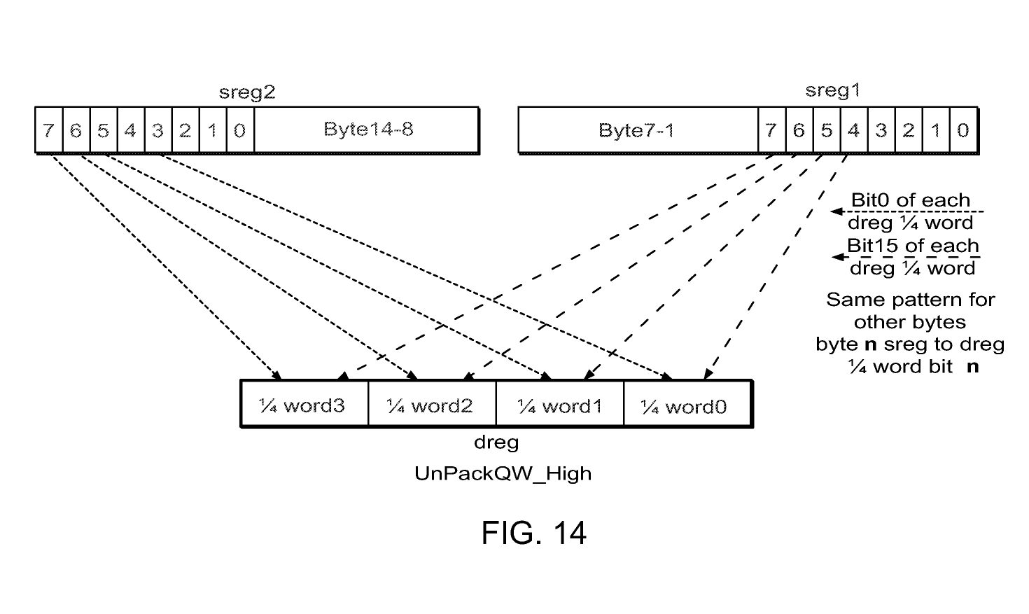

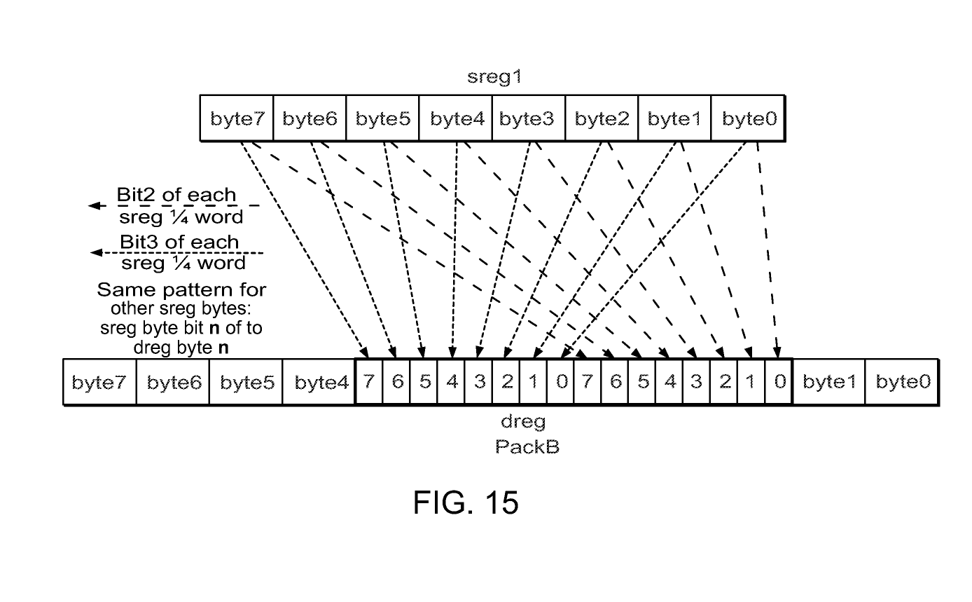

FIG. 1 depicts a system 10 including processor modules (generally, referred to as “SEP” and/or as “cores” elsewhere herein) 12, 14, 16 according to one practice of the invention. Each of these is generally constructed, operated, and utilized in the manner of the “processor module” disclosed, e.g., as element 5, of FIG. 1, and the accompanying text of U.S. Pat. No. 7,685,607 and U.S. Pat. No. 7,653,912, entitled “General Purpose Embedded Processor” and “Virtual Processor Methods and Apparatus With Unified Event Notification and Consumer-Producer Memory Operations,” respectively, and further details of which are disclosed in FIGS. 2-26 and the accompanying text of those two patents, the teachings of which figures and text are incorporated herein by reference, and a copy of U.S. Pat. No. 7,685,607 of which is filed herewith by example as Appendix A, as adapted in accord with the teachings hereof.

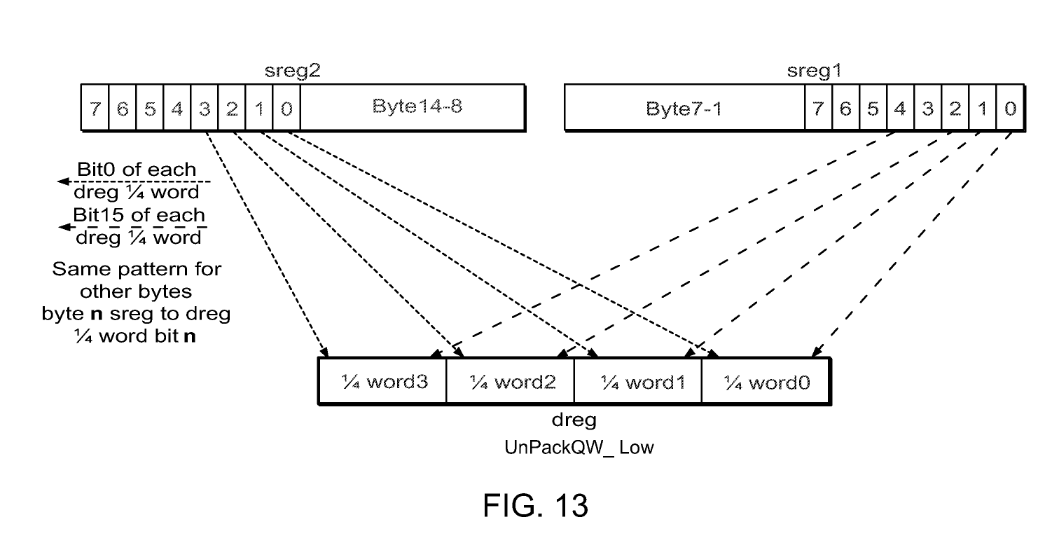

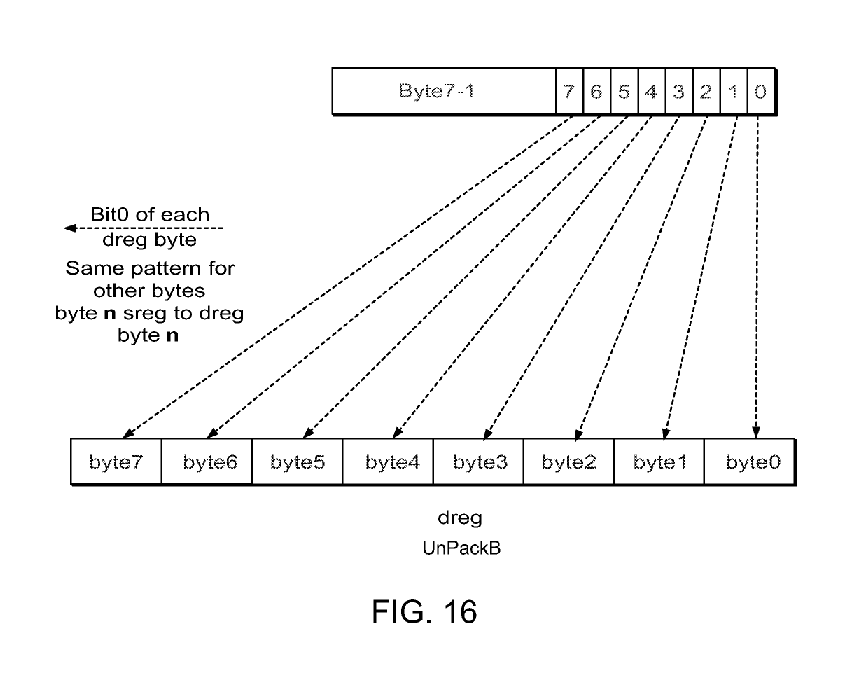

Thus, for example, the illustrated cores 12-16 include functional units 12A-16A, respectively, that are generally constructed, operated, and utilized in the manner of the “execution units” (or “functional units”) disclosed, by way of non-limiting example, as elements 30-38, of FIG. 1 and the accompanying text of aforementioned U.S. Pat. No. 7,685,607 and U.S. Pat. No. 7,653,912, and further details of which are disclosed, by way of non-limiting example, in FIGS. 13, 16 (branch unit), 17 (memory unit), 20, 21-22 (integer and compare units), 23A-23B (floating point unit) and the accompanying text of those two patents, the teachings of which figures and text (and others of which pertain to the functional or execution units) are incorporated herein by reference, as adapted in accord with the teachings hereof. The functional units 12A-16A are labelled “ALU” for arithmetic logic unit in the drawing, although they may serve other functions instead or in addition (e.g., branching, memory, etc.).

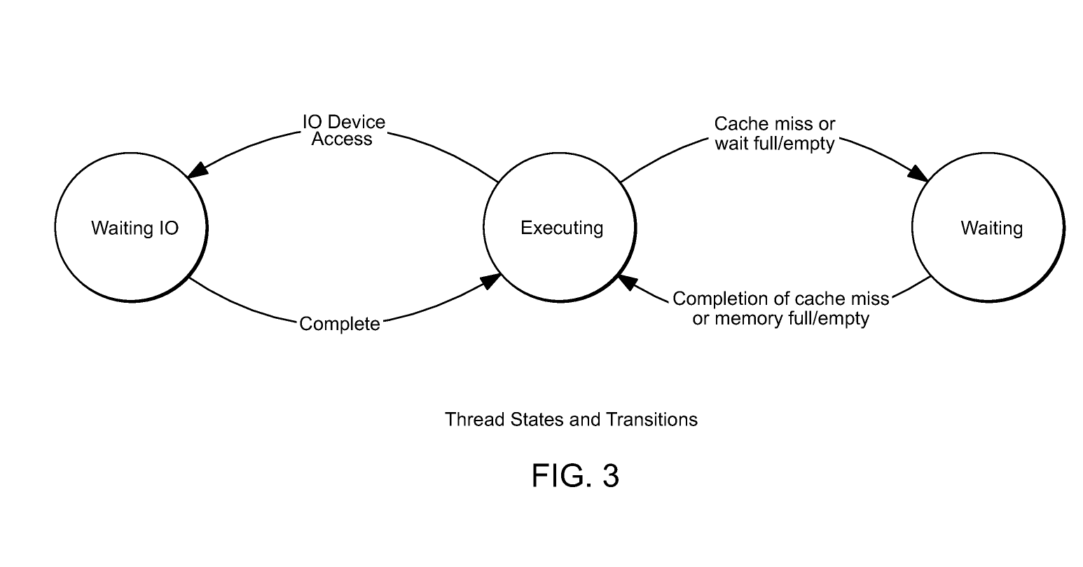

By way of further example, cores 12-16 include thread processing units 12B-16B, respectively, that are generally constructed, operated, and utilized in the manner of the “thread processing units (TPUs)” disclosed, by way of non-limiting example, as elements 10-20, of FIG. 1 and the accompanying text of aforementioned U.S. Pat. No. 7,685,607 and U.S. Pat. No. 7,653,912, and further details of which are disclosed, by way of non-limiting example, in FIGS. 3, 9, 10, 13 and the accompanying text of those two patents, the teachings of which figures and text (and others of which pertain to the thread processing units or TPUs) are incorporated herein by reference, as adapted in accord with the teachings hereof.

Consistent with those teachings, the respective cores 12-16 may have one or more TPUs and the number of those TPUs per core may differ (here, for example, core 12 has three TPUs 12B; core 14, two TPUs 14B; and, core 16, four TPUs 16B). Moreover, although the drawing shows a system 10 with three cores 12-16, other embodiments may have a greater or lesser number of cores.

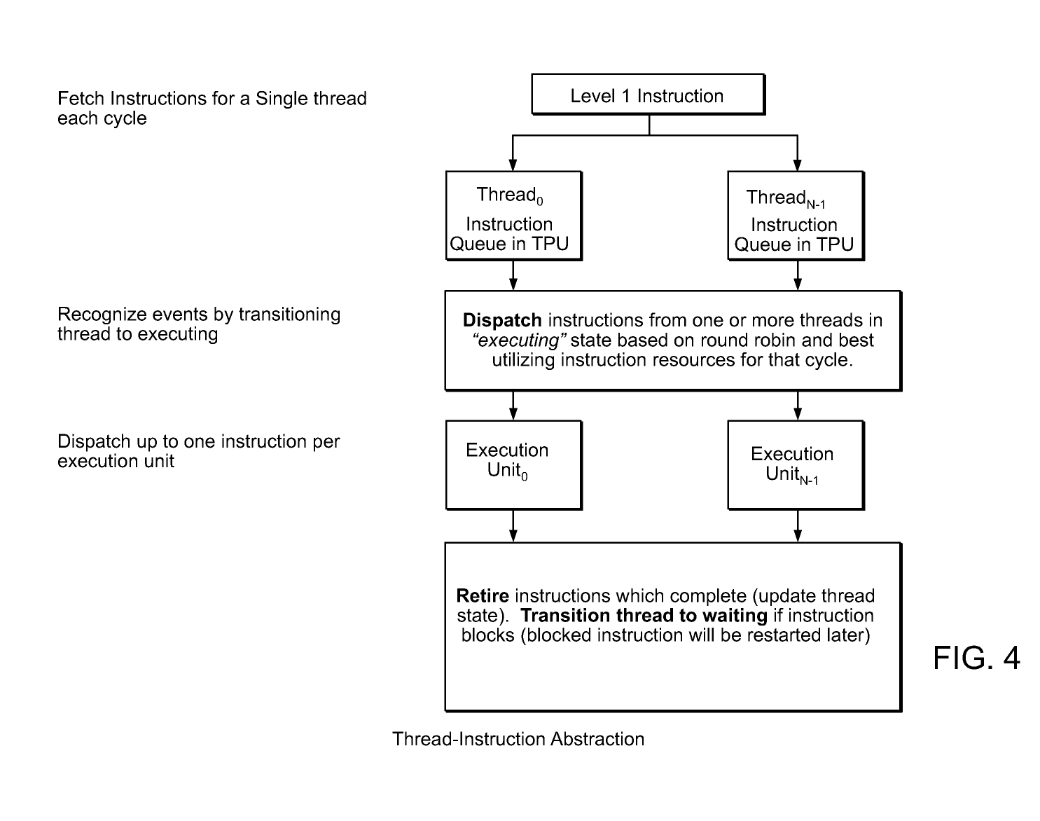

By way of still further example, cores 12-16 include respective event lookup tables 12C-16C, which are generally constructed, operated and utilized in the manner of the “event-to-thread lookup table” (also referred to as the “event table” or “thread lookup table,” or the like) disclosed, by way of non-limiting example, as element 42 in FIG. 4 and the accompanying text of aforementioned U.S. Pat. No. 7,685,607 and U.S. Pat. No. 7,653,912, the teachings of which figures and text (and others of which pertain to the “event-to-thread lookup table”) are incorporated herein by reference, as adapted in accord with the teachings hereof, e.g., to provide for matching events to threads executing within or across processor boundaries (i.e., on other processors).

The tables 12C-16C are shown as a single structure within each core of the drawing for sake of convenience; in practice, they may be shared in whole or in part, logically, functionally and/or physically, between and/or among the cores (as indicated by dashed lines)—and which, therefore, may be referred to herein as “virtual” event lookup tables, “virtual” event-to-thread lookup tables, and so forth. Moreover, those tables 12C-16C can be implemented as part of a single hierarchical table that is shared among cooperating processor modules within a “zone” of the type discussed below and that operates in the manner of the novel virtual memory and memory system architecture discussed here.

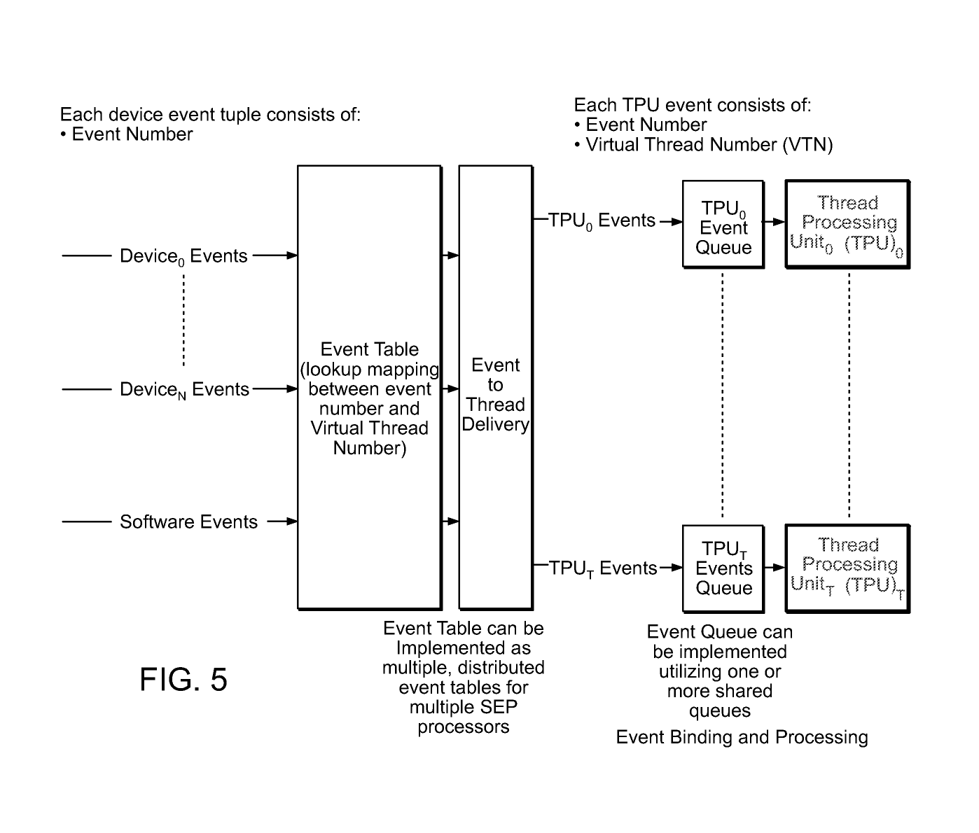

By way of yet still further example, cores 12-16 include respective caches 12D-16D, which are generally constructed, operated and utilized in the manner of the “instruction cache,” the “data cache,” the “Level1 (L1)” cache, the “Level2 (L2)” cache, and/or the “Level2 Extended (L2E)” cache disclosed, by way of non-limiting example, as elements 22, 24, 26 (26a, 26b) respectively, in FIG. 1 and the accompanying text of aforementioned U.S. Pat. No. 7,685,607 and U.S. Pat. No. 7,653,912, and further details of which are disclosed, by way of non-limiting example, in FIGS. 5, 6, 7, 8, 10, 11, 12, 13, 18, 19 and the accompanying text of those two patents, the teachings of which figures and text (and others of which pertain to the instruction, data and other caches) are incorporated herein by reference, as adapted in accord with the teachings hereof, e.g., to support a novel virtual memory and memory system architecture features in which inter alia all memory is effectively managed as cache, even though off-chip memory utilizes DDR DRAM or otherwise.

The caches 12D-16D are shown as a single structure within each core of the drawing for sake of convenience. In practice, one or more of those caches may constitute one or more structures within each respective core that are logically, functionally and/or physically separate from one another and/or, as indicated by the dashed lines connecting caches 12D-16D, that are shared in whole or in part, logically, functionally and/or physically, between and/or among the cores. (As a consequence, one or more of the caches are referred to elsewhere herein as “virtual” instruction and/or data caches.) For example, as shown in FIG. 2, each core may have its own respective L1 data and L1 instruction caches, but may share L2 and L2 extended caches with other cores.

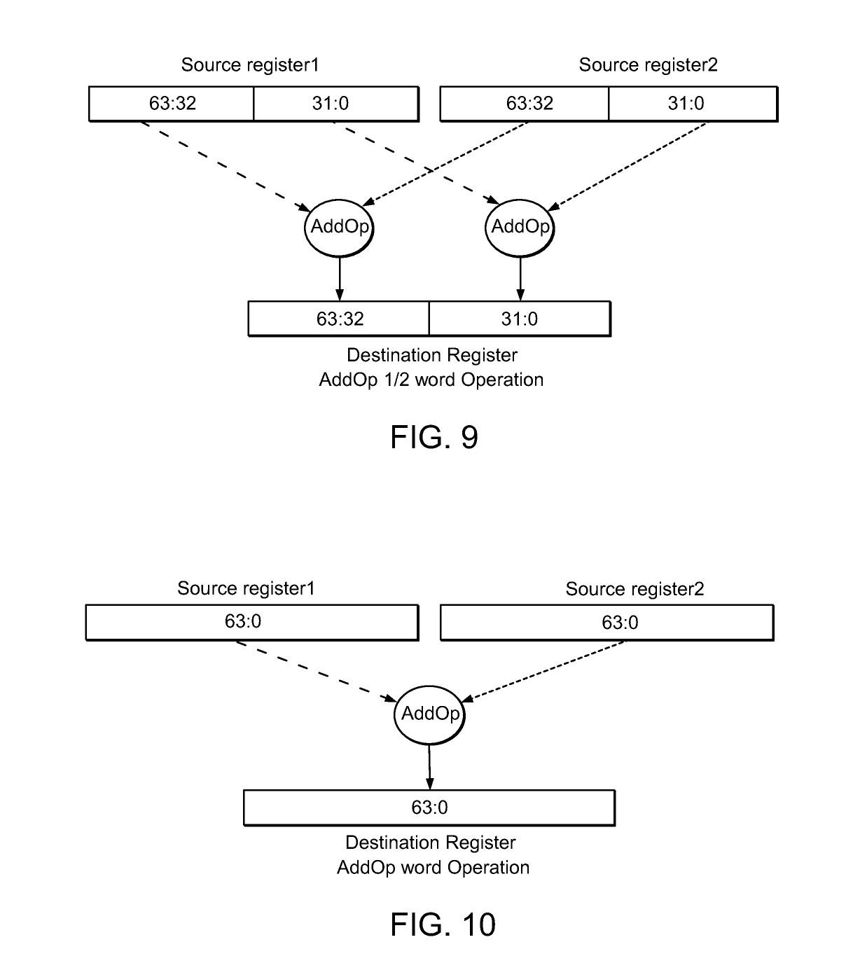

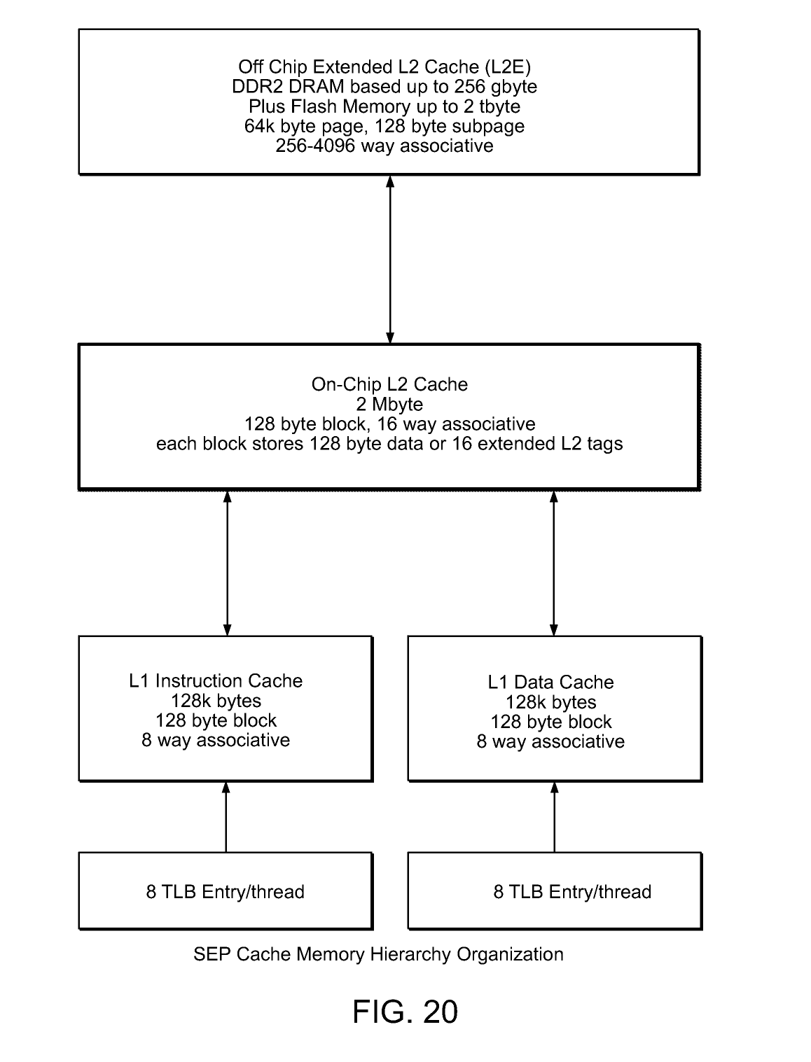

By way of still yet further example, cores 12-16 include respective registers 12E-16E that are generally constructed, operated and utilized in the manner of the general-purpose registers, predicate registers and control registers disclosed, by way of non-limiting example, in FIGS. 9 and 20 and the accompanying text of aforementioned U.S. Pat. No. 7,685,607 and U.S. Pat. No. 7,653,912, the teachings of which figures and text (and others of which pertain to registers employed in the processor modules) are incorporated herein by reference, as adapted in accord with the teachings hereof.

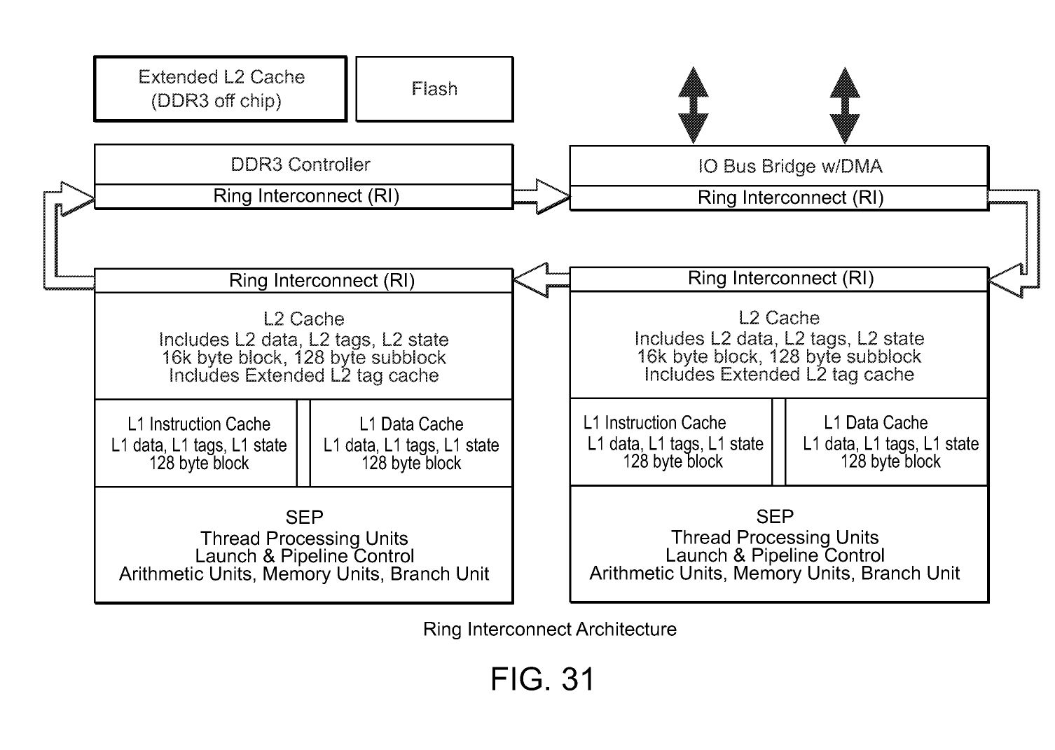

Moreover, one or more of the illustrated cores 12-16 may include on-chip DRAM or other “system memory” (as elsewhere herein), instead of or in addition to being coupled to off-chip DRAM or other such system memory—as shown, by way of non-limiting example, in the embodiment of FIG. 31 and discussed elsewhere herein. In addition, one or more of those cores may be coupled to flash memory (which may be on-chip, but is more typically off-chip), again, for example, as shown in FIG. 31, or other mounted storage (not shown). Coupling of the respective cores to such DRAM (or other system memory) and flash memory (or other mounted storage) may be effected in the conventional manner known in the art, as adapted in accord with the teachings hereof.

The illustrated elements of the respective cores, e.g., 12A-12G, 14A-14G, 16A-16G, are coupled for communication to one another directly and/or indirectly via hardware and/or software logic, as well, as with the other cores, e.g., 14, 16, as evident in the discussion below and in the other drawings. For sake of simplicity, such coupling is not shown in FIG. 1. Thus, for example, the arithmetic logic units, thread processing units, virtual event lookup table, virtual instruction and data caches of each core 12-16 may be coupled for communication and interaction with other elements of their respective cores 12-16, and with other elements of the system 10 in the manner of the “execution units” (or “functional units”), “thread processing units (TPUs),” “event-to-thread lookup table,” and “instruction cache”/“data cache,” respectively, disclosed in the aforementioned figures and text, by way of non-limiting example, of aforementioned, incorporated-by-reference U.S. Pat. No. 7,685,607 and U.S. Pat. No. 7,653,912, as adapted in accord with the teachings hereof.

Cache-Controlled Memory System—Introduction

The illustrated embodiment provides a system 10 in which the cores 12-16 utilize a cache-controlled system memory (e.g., cache-based management of all memory stores that form the system, whether as cache memory within the cache subsystems, attached physical memory such as flash memory, mounted drives or otherwise). Broadly speaking, that system can be said to include one or more nodes, here, processor modules or cores 12-16 (but, in other embodiments, other logic elements) that include or are otherwise coupled to cache memory, physical memory (e.g., attached flash drives or other mounted storage devices) or other memory collectively, “system memory”—as shown, for example, in FIG. 31 and discussed elsewhere herein. The nodes 12-16 (or, in some embodiments, at least one of them) provide a cache memory system that stores data (and, preferably, in the illustrated embodiment, instructions) recently accessed (and/or expected to be accessed) by the respective node, along with tags specifying addresses and statuses (e.g., modified, reference count, etc.) for the respective data (and/or instructions). The data (and instructions) in those caches and, more generally, in the “system memory” as a whole are preferably referenced in accord with a “system” addressing scheme that is common to one or more of the nodes and, preferably, to all of the nodes.

The caches, which are shown in FIG. 1 hereof for simplicity as unitary respective elements 12D-16D are, in the illustrated embodiment, organized in multiple hierarchical levels (e.g., a level 1 cache, a level 2 cache, and so forth)—each, for example, organized as shown in FIG. 20 hereof.

Those caches may be operated as virtual instruction and data caches that support a novel virtual memory system architecture in which inter alia all system memory (whether in the caches, physical memory or otherwise) is effectively managed as cache, even though for example, off-chip memory may utilize DDR DRAM. Thus, for example, instructions and data may be copied, updated and moved among and between the caches and other system memory (e.g., physical memory) in a manner paralleling that disclosed, by way of example, patent publications of Kendall Square Research Corporation, including, U.S. Pat. No. 5,055,999, U.S. Pat. No. 5,341,483, and U.S. Pat. No. 5,297,265, including, by way of example, FIGS. 2A, 2B, 3, 6A-7D and the accompanying text of U.S. Pat. No. 5,055,999, the teachings of which figures and text (and others of which pertain to data movement, copying and updating) are incorporated herein by reference, as adapted in accord with the teachings hereof. The foregoing is likewise true of extension tags, which can also be copied, updated and moved among and between the caches and other system memory in like manner.

The system memory of the illustrated embodiment stores additional (or “extension”) tags that can be used by the nodes, the memory system and/or the operating system like cache tags. In addition to specifying system addresses and statuses for respective data (and/or instructions), the extension tags also specify physical address of those data in system memory. As such, they facilitate translating system addresses to physical addresses, e.g., for purposes of moving data (and/or instructions) between physical (or other system) memory and the cache memory system (a/k/a the “caching subsystem,” the “cache memory subsystem,” and so forth).

Selected extension tags of the illustrated system are cached in the cache memory systems of the nodes, as well as in the memory system. These selected extension tags include, for example, those for data recently accessed (or expected to be accessed) by those nodes following cache “misses” for that data within their respective cache memory systems. Prior to accessing physical (or other system memory) for data following a local cache miss (i.e., a cache miss within its own cache memory system), such a node can signal a request for that data to the nodes, e.g., along bus, network or other media (e.g., the Ring Interconnect shown in FIG. 31 and discussed elsewhere herein) on which they are coupled. A node that updates such data or its corresponding tag can likewise signal the other nodes and/or the memory system of the update via the interconnect.

Referring back to FIG. 1, the illustrated cores 12-16 may form part of a general purpose computing system, e.g., being housed in mainframe computers, mini computers, workstations, desktop computers, laptop computers, and so forth. As well, they may be embedded in a consumer, commercial or other device (not shown), such as a television, cell phone, or personal digital assistant, by way of example, and may interact with such devices via various peripherals interfaces and/or other logic (not shown, here).

A single or multiprocessor system embodying processor and related technology according to the illustrated embodiment—which processor and/or related technology is occasionally referred to herein by the mnemonic “SEP” and/or by the name “Paneve Processor,” “Paneve SDP,” or the like—is optimized for applications with large data processing requirements, e.g., real time embedded applications which have a high degree of media processing requirements. SEP is general purpose in multiple aspects:
Software defined processing, rather than dedicated hardware for special purpose functions
   Standard languages and compilers like gcc
Standard OS like Linux, no real time OS required
High performance for a large range of media and general purpose applications.
Leverage parallelism to scale applications and performance on today's and future implementation. SEP is designed to scale single thread performance, thread parallel performance and multiprocessor performance
Gain high efficiency of software algorithms and utilization of underlying hardware capability.

The types of products and applications of SEP are limitless, but the focus of the discussion here is on mobile products for sake of simplicity and without loss of generality. Such applications are network- and Internet-aware and could include, by way of non-limiting example:
Universal Networked Display
Networked information appliance
PDA & Personal Knowledge Navigator (PKN) with voice and graphical user interface with capabilities such as real time voice recognition, camera (still, video) recorder, MP3 player, game player, navigation and broadcast digital video (MP4?). This device might not look like a PDA.
G3 mobile phone integrated with other capabilities.
Audio and video appliances including video server, video recorder and MP3 server.
Network-aware appliances in general

These exemplary target applications are, by way of non-limiting example, inherently parallel. In addition, they have or include one or more of the following:
High computational requirements
Real time application requirements
Multi-media applications
Voice and graphical user interface
Intelligence
Background tasks to aid the user (like intelligent agents)
Interactive nature
Transparent Internet, networking and Peer to Peer (P2P access)
Multiple applications executing concurrently to provide the device/user function.

A class of such target applications are multi-media and user interface-driven applications that are inherently parallel at the multi-tasking and multi-processing levels (including peer-to-peer).

Discussed in the preceding sections and below are architectural, processing and other aspects of SEP, along with structures and mechanisms in support of those features. It will be appreciated that the processors, systems and methods shown in the illustrations and discussed here are examples of the invention and that other embodiments, incorporating variations on those here, are contemplated by the invention, as well.

The illustrated SEP embodiment directly supports 64 bit address, 64/32/18/8 bit data-types, large general purpose register set and general purpose predicate register set. In preferred embodiments (such as illustrated here), instructions are predicated to enable the compiler to eliminate many conditional branches. Instruction encodings support multi-threading and dynamic distributed shared execution environment features.

SEP simultaneous multi-threading provides flexible multiple instruction issue. High utilization of execution units is achieved through simultaneous execution of multiple process or threads (collectively, “threads”) and eliminating the inefficiencies of memory misses, and memory/branch dependencies. High utilization yields high performance and lower power consumption.

Events are handled directly by the corresponding thread without OS intervention. This enables real-time capability utilizing a standard OS like Linux. Real time OS is not required.

The illustrated SEP embodiment supports a broad spectrum of parallelism to dynamically attain the right range and granularity of parallelism for a broad mix of applications, as discussed below.
Parallelism within an instruction
   Instruction set uniformly enables single 64 bit, dual 32 bit, quad 16 bit and octal 8 bit operations to support high performance image processing, video processing, audio processing, network processing and DSP applications
Multiple Instruction Execution within a single thread
   Compiler specifies the instruction grouping within a single thread that can execute during a single cycle. Instruction encoding directly supports specification of grouping. The illustrated SEP architecture enables scalable instruction level parallelism across implementations—one or more integer, floating point, compare, memory and branch classes.
Simultaneous multi-threading
   SEP implements the ability to simultaneously execute one or more instructions from multiple threads. Each cycle, the SEP schedules one or more instructions from multiple threads to optimally utilize available execution unit resources. SEP multi-threading enables multiple application and processing threads to operate and interoperate concurrently with low latency, low power consumption, high performance and reduced implementation complexity. See “Generalized Events and Multi-Threading,” hereof.
Generalized Event architecture
   SEP provides to mechanisms that enable efficient multi-threaded, multiple processor and distributed P2P environments: unified event mechanism and software transparent consumer producer memory capability.
   The largest degradation of real-time performance of standard OS, like Linux is that all interrupts and events must be handled by the kernel before being handled by the actual event or application event handler. This lowers the quality of real-time applications like audio and video. Every SEP event is transparently wakes up the appropriate thread without kernel intervention. Unified events enable all events (HW interrupts, SW events and others) to be handled directly by the user level thread, eliminating virtually all OS kernel latency. Thus the real time performance of standard OS is significantly improved.
   Synchronization overhead and programming difficulty of implemented the natural data based processing flow between threads or processors (for multiple steps of image processing for example) is very high. SEP memory instructions enable threads to wait on the availability of data and transparently wake up when another thread indicates the data is available. Software transparent consumer-producer memory operations enables higher performance fine grained thread level parallelism with an efficient data oriented, consumer-producer programming style.
Single Processor replaces multiple embedded processors
   Most embedded systems require separate special purpose processors (or dedicated hardware resources) for application, image, signal and network processing. Also, the software development complexity with multiple special purpose processors is high. In general multiple embedded processors adds to the cost and power consumption of the end product.
   The multi-threading and generalized event architecture enables a single SEP processor to handle all application image, signal and network processing for a mobile product, resulting in lower cost and power consumption.
Cache based Memory System
   In preferred embodiments (such as illustrated here), all system memory is managed as cache. This enables an efficient mechanism to manage a large sparse address and memory space across a single and multiple mobile devices. This also eliminates address translation bottleneck from first level cache and TLB miss penalty. Efficient operation of SEP across multiple devices is an integrated feature, not an afterthought.
Dynamic distributed shared execution environment (remote P2P technology)
   Generally, OS level threads and application threads cannot be transparently executed across different devices. Generalized event, consumer-producer memory, multi-threading enables seamless distributed shared execution environment across processors including: distributed shared memory/objects, distributed shared events and distributed shared execution. This enables the mobile device to automatically off load work to improve performance and lower power consumption.

The architecture supports scalability, including:
Instruction extension with additional functional units or programmable functional units
Increasing the number of functional units improves the performance of individual threads more significantly the performance of simultaneously executing threads.
Multi-processor—Adding additional processors to an SEP chip.
Increases in cache and memory size.
Improvements in semiconductor technology.

### Generalized Events and Multi-Threading

Generalized SEP event and multi-threading model are both unique and powerful. A thread is a stateful fully independent flow of control. Threads communicate through sharing memory, like a shared memory multi-processor or through events. SEP has special behavior and instructions that optimize memory performance, performance of threads interacting through memory and event signaling performance. SEP event mechanism enables device (or software) events (like interrupts) to be signaled directly to the thread that is designated to handled the event, without requiring OS interaction.

The generalized multi-thread model works seamlessly across one or more physical processors. Each processor 12, 14 implements one or more Thread Processing Units (TPU) 12B, 14B, which are bound to one thread at any given instant. Thread Processing Units behave like virtual processors and execute concurrently. As shown in the drawing, TPUs executing on a single processor usually share level1 (L1 Instruction & L1 Data) and level2 (L2) cache (which may be shared with the TPU of the other processor, as well). The fact that they share caches is software transparent, thus multiple threads can execute on a single or multiple processors in a transparent manner.

Each implementation of the SEP processor has some number (e.g., one or more) of Thread Processing Units (TPUs) and some number of execution (or functional) units. Each TPU contains the full state of each thread including general registers, predicate registers, control registers and address translation.

The foregoing may be appreciated by reference to FIG. 2, which depicts a system 10′ comprising two processor modules of the type shown in FIG. 1 and labelled, here, as 12, 14. As discussed above, these include respective functional units 12A-14A, thread processing units 12B-14B, and respective caches 12D-14D, here, arranged as separate respective Level1 instruction and data caches for each module and as shared Level2 and Level2 Extended caches, as shown. Such sharing may be effected, for example, by interface logic that is coupled, on the on hand, to the respective modules 12-14 and, more particularly, to their respective L1 cache circuitry and, on the other hand, to on-chip (in the case, e.g., of the L2 cache) and/or off-chip (in the case, e.g., of the L2E cache) memory making up the L2 and L2E caches, respectively.

The processor modules shown in FIG. 2 additionally include respective address translation functionality 12G-14G, here, shown associated with the respective thread processing units 12B-14B, that provide for address translation in a manner like that disclosed, by way of non-limiting example, in connection with TPU elements 10-20 of FIG. 1, in connection with FIG. 5 and the accompanying text, and in connection with branch unit 38 of FIG. 13 and the accompanying text, all of aforementioned U.S. Pat. No. 7,685,607 and U.S. Pat. No. 7,653,912, the teachings of which figures and text (and others of which pertain to the address translation) are incorporated herein by reference, as adapted in accord with the teachings hereof.

Those processor modules additionally include respective launch and pipeline control units 12F 14F that that are generally constructed, operated, and utilized in the manner of the “launch and pipeline control” or “pipeline control” unit disclosed, by way of non-limiting example, as elements 28 and 130 of FIGS. 1 and 13-14, respectively and the accompanying text of aforementioned U.S. Pat. No. 7,685,607 and U.S. Pat. No. 7,653,912, the teachings of which figures and text (and others of which pertain to the launch and pipeline control) are incorporated herein by reference, as adapted in accord with the teachings hereof.

During each cycle the dispatcher schedules instructions from the threads in “executing” state in the Thread Processing Units such as to optimize utilization of the execution units. In general with a small number of active threads, utilization can typically be quite high, typically >80-90%. During each cycle SEP schedules the TPUs requests for execution units (based on instructions) on a round robin bases. Each cycle the starting point of the round robin is rotated among TPUs to assure fairness. Thread priority can be adjusted on an individual thread basis to increase or decrease the priority of an individual thread to bias the relative rate that instructions are dispatched for that thread.

Across implementations the amount of instruction parallelism within a thread and across a thread can vary based on the number of execution units, TPUs and processors, all transparently to software.

Contrasting superscalar vs. SEP multithreaded architecture, in a superscalar processor, instructions from a single executing thread are dynamically scheduled to execute on available execution units based on the actual parallelism and dependencies within the program. This means that on the average most execution units are not able to be utilized during each cycle. As the number of execution units increases the percentage utilization typically goes down. Also execution units are idle during memory system and branch prediction misses/waits. In contrast, multithreaded SEP instructions from multiple threads (shown in different colors) execute simultaneously. Each cycle, the SEP schedules instructions from multiple threads to optimally utilize available execution unit resources. Thus the execution unit utilization and total performance is higher, totally transparent to software.

The underlying rationales for supporting multiple active threads (virtual processors) per processor are:
Functional capability
   Enables single multi-threaded processor to replace multiple application, media, signal processing and network processors
   Enable multiple threads corresponding to application, image, signal processing and networking to operate and interoperate concurrently with low latency and high performance. Context switch and interfacing overhead is minimized. Even within a single image processing application like MP4 decode threads can easily operate simultaneously in a pipelined manner to for example prepare data for frame n+1 while frame n is being composed.
Performance
   Increase the performance of the individual processor by better utilizing functional units and tolerating memory and other event latency. It is not unusual to gain a 3× or more performance increase for supporting up to 4-6 simultaneously executing threads. Power consumption and die size increases are negligible so that performance per unit power and price performance are improved.
   Lower the performance degradation due to branches and cache misses by having another thread execute during these events
   Eliminates most context switch overhead
   Lowers latency for real time activities
   General, high performance event model.
Implementation
   Simplification of pipeline and overall design
   No complex branch predication—another thread can run!!
   Lower cost of single processor hcip vs. multiple processor chips.
   Lower cost when other complexities are eliminated.
   Improve performance per unit power.

### Thread State

Threads are disabled and enabled by the thread enable field of the Thread State Register (discussed below, in connection with “Control Registers.”) When a thread is disabled: no thread state can change, no instructions are dispatched and no events are recognized. System software can load or unload a thread into a TPU by restoring or saving thread state, when the thread is disabled. When a thread is enabled: instructions can be dispatched, events can be recognized and thread state can change based on instruction completion and/or events.

Thread states and transitions are illustrated in FIG. 3. These include:
Executing: Thread context is loaded into a TPU and is currently executing instructions.
   A thread transitions to waiting when a memory instruction must wait for cache to complete an operation, e.g. miss or not empty/full (producer-consumer memory)
   A thread transitions to idle when a event instruction is executed.
Waiting: Thread context is loaded into a TPU, but is currently not executing instructions. Thread transitions to executing when an event it is waiting for occurs:
   Cache operation is completed that would allow the memory instruction to proceed.
Waiting_IO: Thread context is loaded into a TPU, but is currently not executing instructions. Thread transitions to executing when one of the following events occurs:
   Hardware or software event.

FIG. 4 ties together instruction execution, thread and thread state. The dispatcher dispatches instructions from threads in “executing” state. Instructions either are retired—complete and update thread state (like general purpose (gp) registers); or transition to waiting because the instruction is not able to complete yet because it is blocked. Example of an instruction blocking is a cache miss. When an instruction becomes unblocked, the thread is transitioned from waiting to executing state and the dispatcher takes over from there. Examples of other memory instructions that block are empty and full.

Next asynchronous signals, called events which can occur in idle or executing states is introduced.

### Events

Event is an asynchronous signal to a thread. SEP events are unique in that any type of event can directly signal any thread, user or system privilege, without processing by the OS. In all other systems, interrupts are signaled to the OS, which then dispatches the signal to the appropriate process or thread. This adds the latency of the OS and latency of signaling another thread to the interrupt latency. This typically requires a highly tuned real-time OS and advanced software tuning for the application. For SEP, since the event gets delivered directly to a thread, the latency is virtually zero, since the thread can responds immediately and the OS is not involved. A standard OS and no application tuning is necessary.

Two types of SEP events are shown in FIG. 5, which depicts event binding and processing in a processor module, e.g., 12-16, according to the invention. More particularly, that drawing illustrates functionality provided in the cores 12-16 of the illustrated embodiment and how they are used to process and bind device events and software events to loaded threads (e.g., within the same core and/or, in some embodiments, across cores, as discussed elsewhere herein). Each physical event or interrupt is represented as a physical event number (16 bits). The event table maps the physical event number to a virtual thread number (16 bits). If the implementation has more than one processor, the event table also includes an eight bit processor number. An Event To Thread Delivery mechanism delivers the event to the mapped thread, as disclosed, by way of non-limiting example, in connection with element 40-44 of FIG. 4 and the accompanying text of aforementioned U.S. Pat. No. 7,685,607 and U.S. Pat. No. 7,653,912, the teachings of which figures and text (and others of which pertain to event-to-thread delivery) are incorporated herein by reference, as adapted in accord with the teachings hereof. The events are then queued. Each TPU corresponds to a virtual thread number as specified in its corresponding ID register. The virtual thread number of the event is compared to that of each TPU. If there is a match the event is signaled to the corresponding TPU and thread. If there is not a match, the event is signaled to the default system thread in TPU zero.

The routing of memory events to threads by the cores 12-16 of the illustrated embodiment is handled in the manner disclosed, by way of non-limiting example, in connection with elements 44, 50 of FIG. 4 and the accompanying text of aforementioned U.S. Pat. No. 7,685,607 and U.S. Pat. No. 7,653,912, the teachings of which figures and text (and others of which pertain to memory event processing) are incorporated herein by reference, as adapted in accord with the teachings hereof.

In order to process an event, a thread takes the following actions. If the thread is in waiting state, the thread is waiting for a memory event to complete and the thread will recognize the event immediately. If the thread is in waiting_IO state, the thread is waiting for an IO device operation to complete and will recognize the event immediately. If the thread is in executing state the thread will stop dispatching instructions and recognize the event immediately.

On recognizing the event, the corresponding thread saves the current value of Instruction Pointer into System or Application Exception IP register and saves the event number and event status into System or Application Exception Status Register. System or Application registers are utilized based on the current privilege level. Privilege level is set to system and application trap enable is reset. If the previous privilege level was system, the system trap enable is also reset. The Instruction Pointer is then loaded with the exception target address (Table 8) based on the previous privilege level and execution starts from this instruction.

Operations of other threads are unaffected by an event.

Threads run at two privilege levels, System and Application. System threads can access all state of its thread and all other threads within the processor. An application thread can only access non-privileged state corresponding to it. On reset TPU 0 runs thread 0 at system privilege. Other threads can be configured for privilege level when they are created by a system privilege thread.

### Event Format for Hardware and Software Events

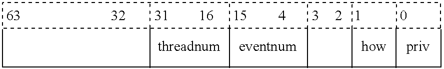

| Bit | Field | Description |
|---|---|---|
| 0 | priv | Privilege that the event will be signaled at: |
| | | 1 System privilege |
| | | 2 Application privilege |
| 1 | how | Specifies how the event is signaled if the |
| | | thread is not in idle state. If the thread |
| | | is in idle state, this field is ignored and |
| | | the event is directly signalled |
| | | 1 Wait for thread in idle state. All events |
| | | after this event in the queue wait also. |
| | | 2 Trap thread immediately |
| 15:4 | eventnum | Specifies the logical number for this event. |
| | | The value of this field is captured in |
| | | detail field of the system exception status |
| | | or application exception status register. |
| 31:16 | threadnum | Specifies the logical thread number that |
| | | this event is signaled to. |

### Example Event Operations

### Reset Event Handling

Reset event causes the following actions:
Event handling queues are cleared.
Thread State Register for each thread has reset behavior as specified. System exception status register will indicate reset. Thread 0 will start execution from virtual address 0x0. Since address translation is disabled at reset, this will also be System Address 0x0. The memcore is always configured as core 0, so 0x0 offset at memcore will address address 0x0 of flash memory. See sections “Addressing” and “Standard Device Registers” in “Virtual Memory and Memory System,” hereof.
All other threads are disabled on reset.
No configuration for flash access after reset is required. Flash memory accessed directly by processor address is not cached and placed directly into the thread instruction queue.
Cacheable address space must not be accessed until L1 instruction, L1 data and L2 caches are initialized. Only a single thread should be utilized until caches are initialized. L1 caches can be initialized through Instruction or Data Level1 Cache Tag Pointer (ICTP, DCTP) and Instruction or Data Level1 Cache Tag Entry (ICTE, DCTE) control registers. Tag format is provided in Cache organization and entry description section of “Virtual Memory and Memory System,” hereof. L2 cache can be initialized through L2 standard device registers and formats described in “Virtual Memory and Memory System,” hereof

### Thread Event Handling

Reset event handling must configure the event queue. There is a single event queue per chip, independent of the number of cores. The event queue is associated with core 0.
For each event type, an entry is placed into event queue lookup table. All events with no value in the event queue lookup table are queued to thread 0.
Each time that a thread is loaded or unloaded from a thread processing unit (hardware thread), the corresponding event queue lookup table entry should be updated. Sequence should be:
   Remove entry from event queue lookup table
   Disable thread, unload thread. Note if an event is signaled in the window between removing the entry and disabling the thread it will be presented to thread 0 for action.
   Add new entry event queue lookup table
   Load new thread into TPU.
Operation is identical for single and multiple threads and TPUs

### Dynamic Assignment of Events to Threads

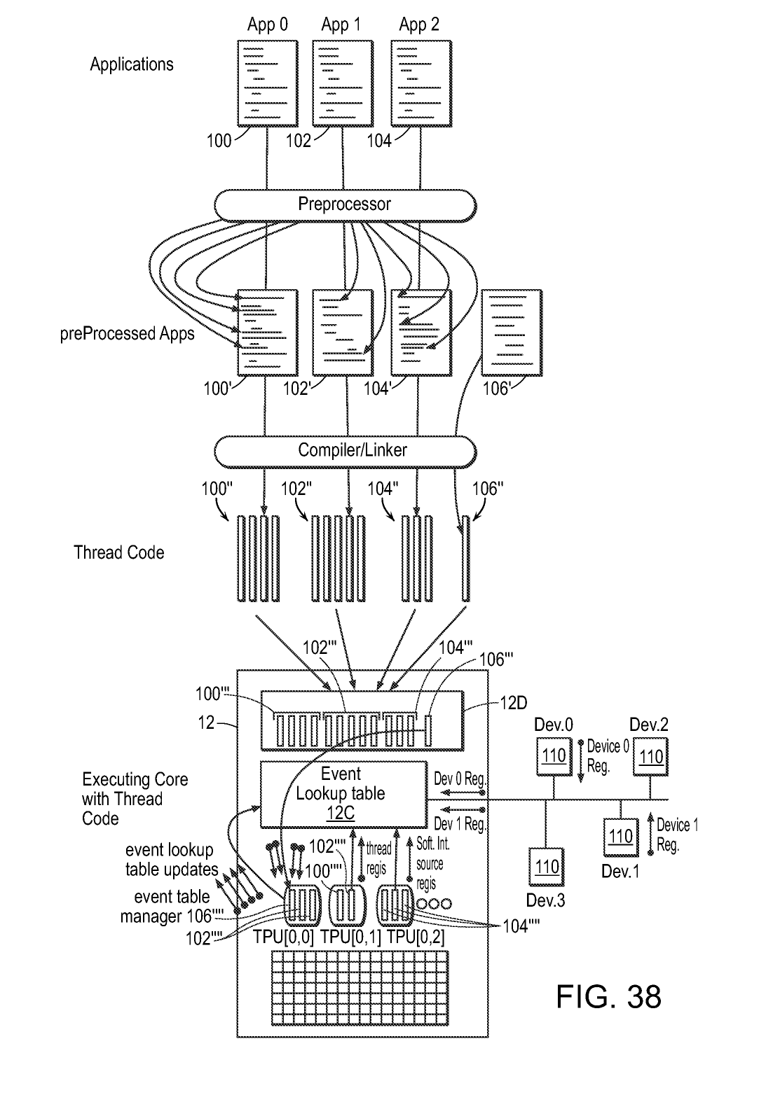

Referring to FIG. 38, an SEP processor module (e.g, 12) according to some practices of the invention permits devices and/or software (e.g., applications, processes and/or threads) to register, e.g., with a default system thread or other logic to identify event-processing services that they require and/or event-handling capabilities they provide. That thread or other logic (e.g., event table manager 106′, below) continually matches those requirements (or “needs”) to capabilities and updates the event-to-thread lookup table to reflect an optimal mapping of events to threads, based on the requirements and capabilities of the overall system 10—so that, when those events occur, the table can be used (e.g., by the event-to-thread delivery mechanism, as discussed in the section “Events,” hereof) to map and route them to respective virtual threads and to signal the TPUs that are executing them. In addition to matching to one another the needs and capabilities registered with it by the devices and/or software, the default system thread or other logic an match registered needs with other capabilities known to it (whether or not registered) and, likewise, can match registered capabilities with other needs known to it (again, whether or not registered, per se).

This can be advantageous over matching of events to threads based solely on “hardcoded” or fixed assignments. Those arrangements may be more than adequate for applications where the software and hardware environment can be reasonably predicted by the software developers. However, they might not best serve processing and throughput demands of dynamically changing systems, e.g., where processing-capable devices (e.g., those equipped with SEP processing modules or otherwise) come into and out of communications coupling with one another and with other processing-demanding software or devices). By way of non-limiting example is a SEP core-equipped phone for gaming applications. When the phone is isolated, it processes all gaming threads (as well as telephony, etc., threads) on its own. However, if the phone comes into range of another core-equipped device, it offloads appropriate software and hardware interrupt processing to that other device.

Referring to FIG. 38, a preprocessor of the type known in the art—albeit as adapted in accord with the teachings hereof—inserts into source code (or intermediate code, or otherwise) of applications, library code, drivers, etc. that will be executed by the system 10 event-to-thread lookup table management code that upon execution (e.g., upon interpretation and/or following compilation, linking, etc.) causes the executed code to register event-processing services that it will require and/or capabilities that it will provide at runtime. That event-to-thread lookup table management code can be based on directives supplied by the developer (as well, potentially, by the manufacturer, distributor, retailer, post-sale support personnel, end user or other) to reflect one or more of: the actual or expected requirements (or capabilities) of the respective source, intermediate or other code, as well as about the expected runtime environment and the devices or software potentially available within that environment with potentially matching capabilities (or requirements).

The drawing illustrates this by way of source code of three applications 100-104 which would normally be expected to require event-processing services; although, that and other software may provide event-handling capabilities, instead or in addition—e.g., as in the case of codecs, special-purpose library routines, and so forth, which may have event-handling capabilities for service events from other software (e.g., high-level applications) or of devices. As shown, the exemplary applications 100-104 are processed by the preprocessor to generate “preprocessed apps” 100′-104′, respectively, each with event-to-thread lookup table management code inserted by the preprocessor.

The preprocessor can likewise insert into device driver code or the like (e.g., source, intermediate or other code for device drivers) event-to-thread lookup table management code detailing event-processing services that their respective devices will require and/or capabilities that those devices will provide upon insertion in the system 10.

Alternatively or in addition to being based on directives supplied by the developer (manufacturer, distributor, retailer, post-sale support personnel, end user or other), event-to-thread lookup table management code can be supplied with the source, intermediate or other code by the developers (manufacturers, distributors, retailers, post-sale support personnel, end users or other) themselves—or, still further alternatively or in addition, can be generated by the preprocessor based on defaults or other assumptions/expectations of the expected runtime environment. And, although event-to-thread lookup table management code is discussed here as being inserted into source, intermediate or other code by the preprocessor, it can, instead or in addition, be inserted by any downstream interpreters, compilers, linkers, loaders, etc. into intermediate, object, executable or other output files generated by them.

Such is the case, by extension, of the event table manger code module 106′, i.e., a module that that, at runtime, updates the event-to-thread table based on the event-processing services and event-handling capabilities registered by software and/or devices at runtime. Though that module may be provided in source code format (e.g., in the manner of files 100-104), in the illustrated embodiment, it is provided as a prepackaged library or other intermediate, object or other code module compiled and/or that is linked into the executable code. Those skilled in the art will appreciate that this is by way of example and that, in other embodiments the functionality of module 106′ may be provided otherwise.

With further reference to the drawing, a compiler/linker of the type known in the art—albeit as adapted in accord with the teachings hereof—generates executable code files from the preprocessed apps 100′-104′ and module 106′ (as well as from any other software modules) suitable for loading into and execution by module 12 at runtime. Although that runtime code is likely to comprise one or more files that are stored on disk (not shown), in L2E cache or otherwise, it is depicted, here, for convenience, as threads 100″-106″ it will ultimately be broken into upon execution.

In the illustrated embodiment, that executable code is loaded into the instruction/data cache 12D at runtime and is staged for execution by the TPUs 12B (here, labelled, TPU[0,0]-TPU[0,2]) of processing module 12 as described above and elsewhere herein. The corresponding enabled (or active) threads are shown here with labels 100″″, 102″″, 104″″. That corresponding to event table manager module 106′ is shown, labelled as 106′.

Threads 100″″-104″″ that require event-processing services (e.g., for software interrupts) and/or that provide event-processing capabilities register, e.g., with event table manager module 106″″, here, by signalling that module to identify those needs and/or capabilities. Such registration/signalling can be done as each thread is instantiated and/or throughout the life of the thread (e.g., if and as its needs and/or capabilities evolve). Devices 110 can do this as well and/or can rely on interrupt handlers to do that registration (e.g., signalling) for them. Such registration (here, signalling) is indicated in the drawing by notification arrows emanating from thread 102″″ of TPU[0,1] (labelled, here, as “thread regis” for thread registration); thread 104″″ of TPU [0,2] (software interrupt source registration); device 110 Dev 0 (device 0 registration); and, device 1110 Dev 1 (device 1 registration) for routing to event table manager module 106″″. In other embodiments, the software and/or devices may register, e.g., with module 106″″, in other ways.

The module 106″″ responds to the notifications by matching the respective needs and/or capabilities of the threads and/or devices, e.g., to optimize operation of the system 10, e.g., on any of many factors including, by way of non-limiting example, load balancing among TPUs and/or cores 12-16, quality of service requirements of individual threads and/or classes of threads (e.g., data throughput requirements of voice processing threads vs. web data transmission threads in a telephony application of core 12), energy utilization (e.g., for battery operation or otherwise), actual or expected numbers of simultaneous events, actual or expected availability of TPUs and/or cores capable of processing events, and so forth, all by way of example). The module 106″″ updates the event lookup table 12C accordingly so that subsequently occurring events can be mapped to threads (e.g., by the event-to-thread delivery mechanism, as discussed in the section “Events,” hereof) in accord with that optimization.

### Location-Independent Shared Execution Environment

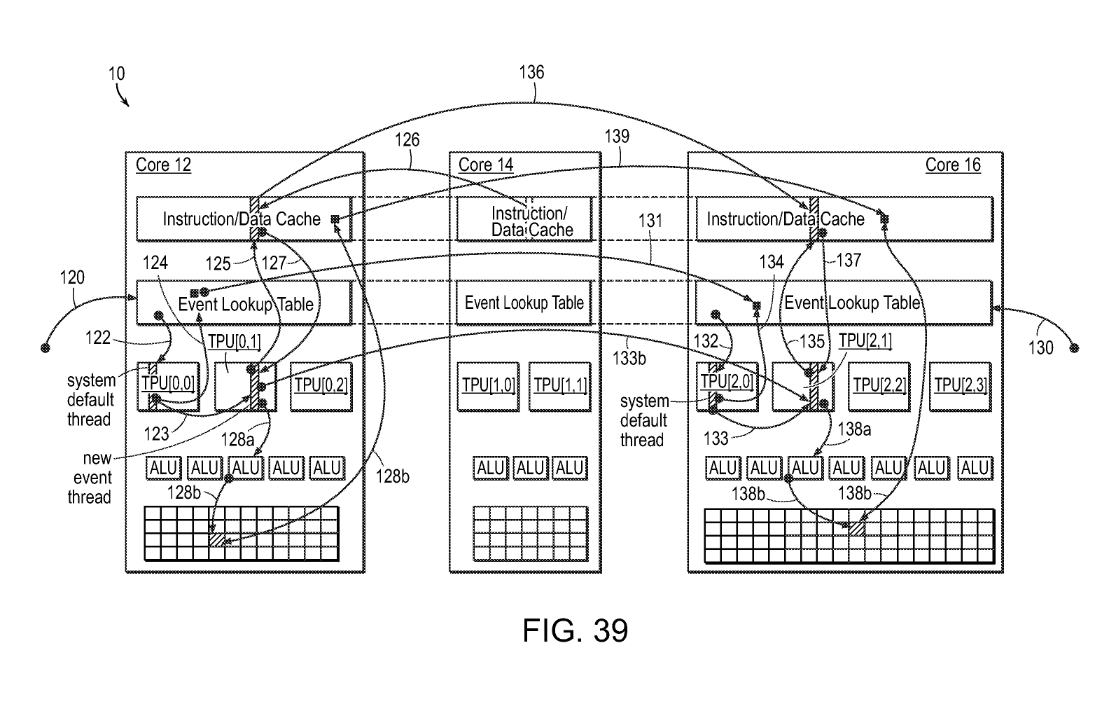

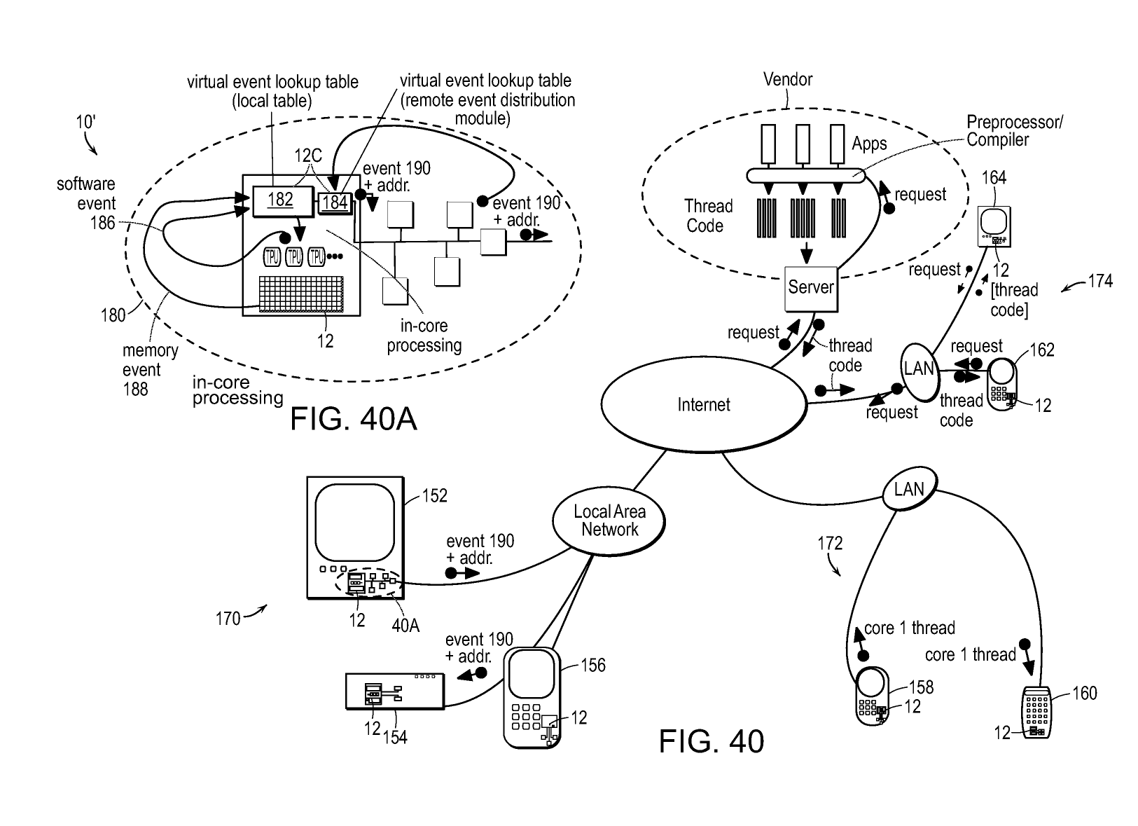

FIG. 39 depicts configuration and use of the system 10 of FIG. 1 to provide a location-independent shared execution environment and, further, depicts operation of processor modules 12-16 in connection with migration of threads across core boundaries to support such a location-independent shared execution environment. Such configurations and uses are advantageous, among other reasons, in that they facilitate optimization of operation of the system 10—e.g., to achieve load balancing among TPUs and/or cores 12-16, to meet quality of service requirements of individual threads, classes of threads, individual events and/or classes of events, to minimize energy utilization, and so forth, all by way of example—both in static configurations of the system 10 and in dynamically changing configurations, e.g., where processing-capable devices come into and out of communications coupling with one another and with other processing-demanding software or devices. By way of overview, the system 10 and, more particularly, the cores 12-16 provide for migration of threads across core boundaries by moving data, instructions and/or thread (state) between the cores, e.g., in order to bring event-processing threads to the cores (or nearer to the cores) whence those events are generated or detected, to move event-processing threads to cores (or nearer to cores) having the capacity to process them, and so forth, all by way of non-limiting example.

Operation of the illustrated processor modules in support of location-independent shared execution environment and migration of threads across processor 12-16 boundaries is illustrated in FIG. 39, in which the following steps (denoted in the drawings as numbers in dashed-line ovals) are performed. It will be appreciated that these are by way of example and that other embodiments may perform different steps and/or in different orders:

In step 120, core 12 is notified of an event. This may be a hardware or software event, and it may be signaled from a local device (i.e., one directly coupled to core 12), a locally executing thread, or otherwise. In the example, the event is one to which no thread has yet been assigned. Such notification may be effected in a manner known in the art and/or utilizing mechanisms disclosed in incorporated-by-reference U.S. Pat. No. 7,685,607 and U.S. Pat. No. 7,653,912, as adapted in accord with the teachings hereof.

In step 122, the default system thread executing on one of the TPUs local to core 12, here, TPU [0,0] is notified of the newly received event and, in step 123, that default thread can instantiate a thread to handle the incoming event and subsequent related events. This can include, for example, setting state for the new thread, identifying event handler or software sequence to process the event, e.g., from device tables, and so forth, all in the manner known in the art and/or utilizing mechanisms disclosed in incorporated-by-reference U.S. Pat. No. 7,685,607 and U.S. Pat. No. 7,653,912, as adapted in accord with the teachings hereof. (The default system thread can, in some embodiments, process the incoming event directly and schedule a new thread for handling subsequent related events.) The default system thread likewise updates the event-to-thread table to reflect assignment of the event to the newly created thread, e.g., a manner known in the art and/or utilizing mechanisms disclosed in incorporated-by-reference U.S. Pat. No. 7,685,607 and U.S. Pat. No. 7,653,912, as adapted in accord with the teachings hereof; see step 124.

In step 125, the thread that is handling the event (e.g., the newly instantiated thread or, in some embodiments, the default system thread) attempts to read the next instruction of the event-handling instruction sequence for that event from cache 12D. If that instruction is not present in the local instruction cache 12D, it (and, more typically, a block of instruction “data” including it and subsequent instructions of the same sequence) is transferred (or “migrated”) into it, e.g., in the manner described in connection with the sections entitled “Virtual Memory and Memory System,” “Cache Memory System Overview,” and “Memory System Implementation,” hereof, all by way of example; see step 126. And, in step 127, that instruction is transferred to the TPU 12B to which the event-handling thread is assigned, e.g., in accord with the discussion at “Generalized Events and Multi-Threading,” hereof, and elsewhere herein.

In step 128a, the instruction is dispatched to the execution units 12A, e.g., as discussed in “Generalized Events and Multi-Threading,” hereof, and elsewhere herein, for execution, along with the data required for such execution—which the TPU 12B and/or the assigned execution unit 12A can also load from cache 12D; see step 128b. As above, if that data is not present in the local data cache 12D, it is transferred (or “migrated”) into it, e.g., in the manner referred to above in connection with the discussion of step 126.

Steps 125-128b are repeated, e.g., while the thread is active (e.g., until processing of the event is completed) or until it is thrown into a waiting state, e.g., as discussed above in connection with “Thread State” and elsewhere herein. They can be further repeated if and when the TPU 12B on which the thread is executing is notified of further related events, e.g., received by core 12 and routed to that thread (e.g., by the event-to-thread delivery mechanism, as discussed in the section “Events,” hereof).

Steps 130-139 illustrate migration of that thread to core 16, e.g., in response to receipt of further events related to it. While such migration is not necessitated by systems according to the invention, it (migration) too can facilitate optimization of operation of the system as discussed above. The illustrated steps 130-139 parallel the steps described above, albeit steps 130-139 are executed on core 16.

Thus, for example, step 130 parallels step 120 vis-a-vis receipt of an event notification by core 16.

Step 132 parallels step 122 vis-a-vis notification of the default system thread executing on one of the TPUs local to core 16, here, TPU[2,0] of the newly received event.

Step 133 parallels step 123 vis-a-vis instantiation of a thread to handle the incoming event. However, unlike step 123 which instantiates a new thread, step 133 effects transfer (or migration) of a pre-existing thread to core 16 to handle the event—in this case, the thread instantiated in step 123 and discussed above in connection with processing of the event received in step 120. To that end, in step 133, the default system thread executing in TPU[2,0] signals and cooperates with the default system thread executing in TPU[0,0] to transfer the pre-existing thread's register state, as well as of the remainder of thread state based in memory, as discussed in “Thread (Virtual Processor) State,” hereof; see step 133b. In some embodiments, the default system thread identifies the pre-existing thread and the core on which it is (was) executing, e.g., by searching local and a remote components of the event lookup table show, e.g., in the breakout of FIG. 40, below. Alternatively, one or more of the operations discussed here, in connection with steps 133 and 133b and be handled by logic (dedicated or otherwise) that is separate and apart from the TPU's, e.g., by the event-to-thread delivery mechanism (discussed in the section “Events,” hereof) or the like.

Step 134 parallels step 124 vis-a-vis updating of the event-to-thread table of core 16 to reflect assignment of the event to the transferred thread.

Steps 135-137 parallel steps 125-127, respective, vis-a-vis reading the next instruction of the event-handling instruction sequence from the cache, here, cache 16D, migrating that instruction to that cache if not already present there, and transferring that instruction to the TPU, here, 16B, to which the event-handling thread is assigned.

Steps 138a-138b parallel steps 128a-128b vis-a-vis dispatching of the instruction for execution and loading the requisite data in connection therewith.

As above, steps 135-138b are repeated, e.g., while the thread is active (e.g., until processing of the event is completed) or until it is thrown into a waiting state, e.g., as discussed above in connection with “Thread State” and elsewhere herein. They can be further repeated if and when the TPU 16B on which the thread is executing is notified of further related events, e.g., received by core 16 and routed to that thread (e.g., by the event-to-thread delivery mechanism, as discussed in the section “Events,” hereof).

FIG. 40 depicts further systems 10′ and methods according to practice of the invention wherein the processor modules (here, all labelled 12 for simplicity) of FIG. 39 are embedded in consumer, commercial or other devices 150-164 for cooperative operation—e.g., routing and processing of events among and between modules within zones 170-174. The devices shown in the illustration are televisions 152, 164 and set top boxes 154 cell phones 158, 162, and personal digital assistants 168, remote controls 156, though, these are only by way of example. In other embodiments, the modules may be embedded in other devices instead or in addition; for example, they may be included in desktop, laptop, or other computers.

The zones 170-174 shown in the illustration are defined by local area networks, though, again, these are by way of example. Such cooperative operation may occur within or across zones that defined in other ways. Indeed, in some embodiments, cooperative operation is limited to cores 12 within a given device (e.g., within a television 152), while in other embodiments that operation extends across networks even more encompassing (e.g., wider ranging) than LANs or less encompassing.

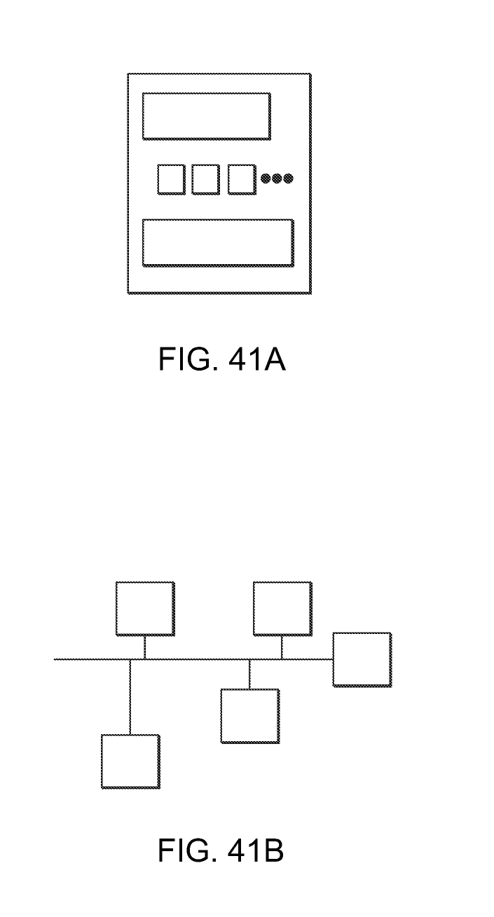

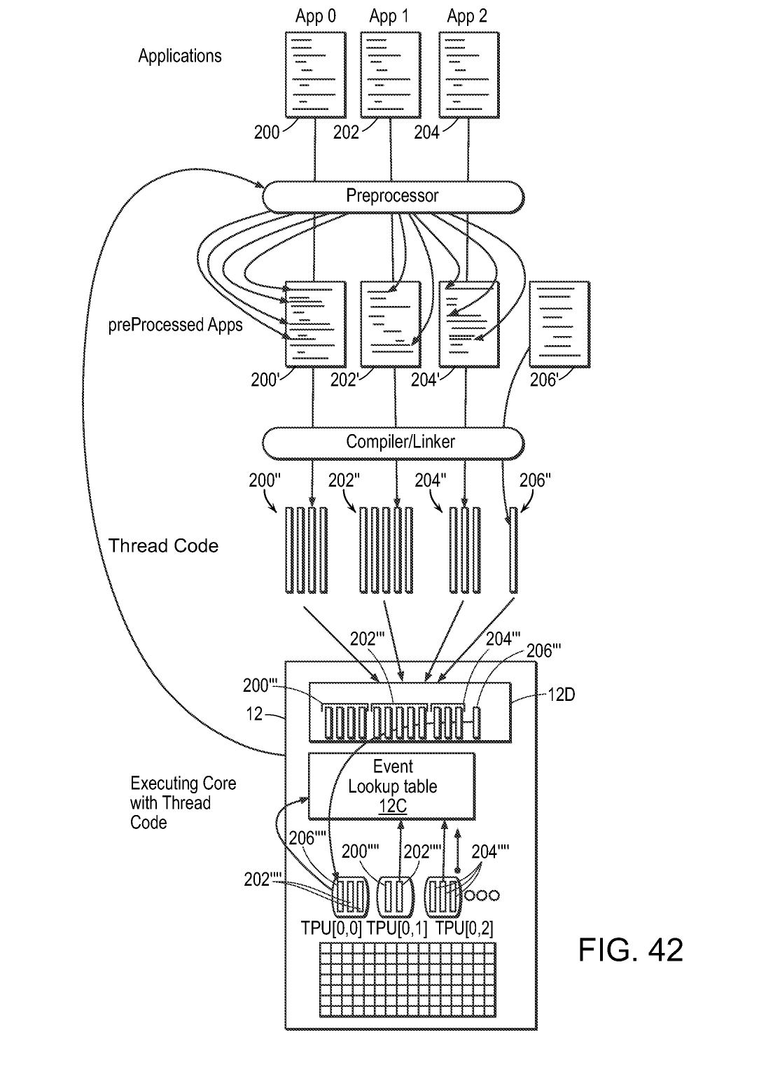

The embedded processor modules 12 are generally denoted in FIG. 40 by the graphic symbol shown in FIG. 41A. Along with those modules are symbolically depicted peripheral and/or other logic with which those modules 12 interact in their respective devices (i.e., within the respective devices within which they are embedded). The graphic symbol for those peripheral and/or other logic is provided in FIG. 41B, but the symbols are otherwise left unlabeled in FIG. 40 to avoid clutter.

A detailed breakout (indicated by dashed lines) of such a core 12 is shown in the upper left of FIG. 40. That breakout does not show caches or functional units (ALU's) of the core 12 for ease of illustration. However, it does show the event lookup table 12C of that module (which is generally constructed, operated and utilized as discussed above, e.g., in connection with FIGS. 1 and 39) as including two components: a local event table 182 to facilitate matching events to locally executing threads (i.e., threads executing on one of the TPUs 12B of the same core 12) and a remote event table 184 to facilitate matching events to remotely executing threads (i.e., threads executing on another or the cores—e.g., within the same zone 170 or within another zone 172-174, depending upon implementation. Though shown as two separate components 182, 184 in the drawings, these may comprise a greater or lesser number of components in other embodiments of the invention.

Moreover, though described here as “tables,” it will be appreciated that the event lookup tables may comprise or be coupled with other functional components—such as, for example, an event-to-thread delivery mechanism, as discussed in the section “Events,” hereof)—and that those tables and/or components may be entirely local to (i.e., disposed within) the respective core or otherwise. Thus, for example, the remote event lookup table 184 (like the local event lookup table 182) may comprise logic for effecting the lookup function. Moreover, table 184 may include and/or work cooperatively with logic resident not only in the local processor module but also in the other processor modules 14-16 for exchange of information necessary to route events to them (e.g., thread id's, module id's/addresses, event id's, and so forth). To this end, the remote event lookup “table” is also referred to in the drawing as a “remote event distribution module.”

The results of matching locally occurring events, e.g., local software event 186 and local memory event 188, against the local event table 182 are depicted in the drawing. Specifically, as indicated by arrow labelled “in-core processing” those events are routed to a TPU of the local core for processing by a pre-existing or newly created thread. This is reflected in detail in the upper left of FIG. 41.

Conversely, if a locally occurring event does not an entry in the local event table 182 but does match one in the remote event table 184 (e.g., as determined by parallel or in seratim applications of an incoming event ID against those tables), the latter can return a thread id, module id/address (collectively, “address”) of the core and thread responsible for processing that event. The event-to-thread delivery mechanism and/or the default system thread (for example) of the core in which the event is detected can utilize that address to route the event for processing by that responsible core/thread. This is reflected in FIG. 40, by way of example, by hardware event 190, which matches an entry in table 184, which returns the address of a remote core responsible for handling that event—in this case, a core 12 embedded in device 154. The event-to-thread delivery mechanism and/or the default system thread (or other logic) of the core 12 that detected the event 190 utilizes that address to route the event to that remote core, which processes the event, e.g., as described above, e.g., in connection with steps 120-128b.

While routing of events to which threads are already assigned can be based on “current” thread location, that is, on the location of the core 12 on which the assigned thread is currently resident, events can be routed to other modules instead, e.g., to achieve load balancing (as discussed above). In some embodiments, this is true for both “new” events, i.e., those to which no thread is yet assigned, as well as for events to which threads are already assigned. In the latter regard (and, indeed, in both regards), the cores can utilize thread migration (e.g., as shown in FIG. 39 and discussed above) to effect processing of the event of the module to which the event is so routed. This is illustrated, by way of non-limiting example, in the lower right-hand corner of FIG. 40, wherein device 158 and, more particularly, its respective core 12, is shown transferring a “thread” (and, more precisely, thread state, instructions, and so forth—in accord with the discussion of FIG. 39).

In some embodiments, a “master” one of the processor modules 12 within a zone 170-174 and/or within the system as a whole (depending on implementation), however, is responsible for routing events to preexisting threads and for choosing which modules/devices (including, potentially, the local module) will handle new events—e.g., in cooperation with default system threads running on the cores 12 within which those preexisting threads are executing (e.g., as discussed above in connection with FIG. 39. Master status can be conferred on an ad hoc basis or otherwise and, indeed, it can rotate (or otherwise dynamically vary) among processors within a zone. Indeed, in some embodiments distribution is effected on a peer-to-peer basis, e.g., such that each module is responsible for routing events that it receives (e.g., assuming the module does not take up processing of the event itself).

Systems constructed in accord with the invention can effect downloading of software to the illustrated embedded processor modules. As shown in FIG. 40, this can be effected from a “vendor” server to modules that are deployed “in the field” (i.e., embedded in devices that are installed in business, residences or otherwise). However, it can similarly be effected to modules pre-deployment, e.g., during manufacture, distribution and/or at retail. Moreover, it need be effected by a server but, rather, can be carried out by other functionality suitable for transmitting and/or installing requisite software on the modules. Regardless, as shown in the upper-right corner of FIG. 40, the software can be configured and downloaded, e.g., in response to requests from the modules, their operators, installers, retailers, distributers, manufacturers, or otherwise, that specify requirements of applications necessary (and/or desired) on each such module and the resources available on that module (and/or within the respective zone) to process those applications. This can include, not only the processing capabilities of the processor module to which the code will be downloaded, but also those of other processor modules with which it cooperates in the respective zone, e.g., to offload and/or share processing tasks.

General Purpose Embedded Processor with Provision of Quality of Service Through Thread Instantiation, Maintenance and Optimization

In some embodiments, threads are instantiated and assigned to TPUs on an as-needed basis. Thus, for example, events (including, for example, memory events, software interrupts and hardware interrupts) received or generated by the cores are mapped to threads and the respective TPUs are notified for event processing, e.g., as described in the section “Events,” hereof. If no thread has been assigned to a particular event, the default system thread is notified, and it instantiates a thread to handle the incoming event and subsequent related events. As noted above, such instantiation can include, for example, setting state for the new thread, identifying event handler or software sequence to process the event, e.g., from device tables, and so forth, all in the manner known in the art and/or utilizing mechanisms disclosed in incorporated-by-reference U.S. Pat. No. 7,685,607 and U.S. Pat. No. 7,653,912, as adapted in accord with the teachings hereof.

Such as-needed instantiation and assignment of events to threads is more than adequate for many applications. However, in an overly burdened system with one or more cores 12-16, the overhead required for setting up a thread and/or the reliance on a single critical service-providing thread may starve operations necessary to achieve a desired quality of service. By way of example is use of an embedded core 12 to support picture-in-a-picture display on a television. While a single JPEG 2000 decoding thread may be adequate for most uses, it may be best to instantiate multiple such threads if the user requests an unduly large number of embedded pictures—lest one or more of the displays appears jagged in the face of substantial on-screen motion. Another example might be a lower-power core 12 that is employed as the primary processor in a cell phone and that is called upon to provide an occasional support processing role when the phone is networked with a television (or other device) that is executing an intensive gaming application on a like (though, potentially more powerful, core). If the phone's processor is too busy in its support role, the user who is initiating a call may notice degradation in phone responsiveness.

To this end, an SEP processor module (e.g., 12) according to some practices of the invention, utilizes a preprocessor of the type known in the art albeit as adapted in accord with the teachings hereof—to insert into source code (or intermediate code, or otherwise) of applications, library code, drivers, or otherwise that will be executed by the system 10 thread management code that, upon execution, causes the default system thread (or other functionality within system 10) to optimize thread instantiation, maintenance and thread assignment at runtime. This can facilitate instantiation of an appropriate number of threads at an appropriate time, e.g., to meet quality of service requirements of individual threads, classes of threads, individual events and/or classes of events with respect to one or more of the factors identified above, among others, and including, by way of non-limiting example
data processing requirements of voice processing events, applications and/or threads,
data throughput requirements of web data transmission events, applications and/or threads,
data processing and display requirements of gaming events, applications and/or threads,
data processing and display requirements of telepresence events, applications and/or threads,
decoding, scaler & noise reduction, color correction, frame rate control and other processing and display requirements of audiovisual (e.g., television or video) events, applications and/or threads,
energy utilization requirements of the system 5, as well as of events, applications and/or threads processed thereon, and/or
processing of actual or expected numbers of simultaneous events by individual threads, classes of threads, individual events and/or classes of events
prioritization of the processing of threads, classes of threads, events and/or classes of events over other threads, classes of threads, events and/or classes of events

Referring to FIG. 42, this is illustrated by way of source code modules of applications 200-204, the functions performed by which, during execution, have respective quality-of-service requirements. Paralleling the discussion above in connection with FIG. 38, as shown in FIG. 42, the applications 200-204 are processed by preprocessor of the type known in the art albeit as adapted in accord with the teachings hereof—to generate “preprocessed apps” 200′-204′, respectively, into which preprocessor inserts thread management code based on directives supplied by the developer, manufacturer, distributor, retailer, post-sale support personnel, end user or other about one or more of: quality-of-service requirements of functions provided by the respective applications 200-204, the frequency and duration with which those functions are expected to be invoked at runtime (e.g., in response to actions by the end user or otherwise), the expected processing or throughput load (e.g., in MIPS or other suitable terms) that those functions and/or the applications themselves are expected to exert on the system 10 at runtime, the processing resources required by those applications, the relative prioritization of those functions as to each other and to others provided within the executing system, and so forth.

Alternatively or in addition to being based on directives, event management code can be supplied with the application 200-204 source or other code itself—or, still further alternatively or in addition, can be generated by the preprocessor based on defaults or other assumptions/expectations about one or more of the foregoing, e.g., quality-of-service requirements of the applications functions, frequency and duration of their use at runtime, and so forth. And, although event management code is discussed here as being inserted into source, intermediate or other code by the preprocessor, it can, instead or in addition, be inserted by any downstream interpreters, compilers, linkers, loaders, etc. into intermediate, object, executable or other output files generated by them.

Such is the case, by extension, of the thread management code module 206′, i.e., a module that that, at runtime, supplements the default system thread, event management code inserted into preprocessed applications 200′-204′, and/or other functionality within system 10 to facilitate thread creation, assignment and maintenance so as to meet the quality-of-service requirements of functions of the respective applications 200-204 in view of the other factors identified above (frequency and duration of their use at runtime, and so forth) and in view of other demands on the system 10, as well, as its capabilities. Though that module may be provided in source code format (e.g., in the manner of files 200-204), in the illustrated embodiment, it is provided as a prepackaged library or other intermediate, object or other code module compiled and/or that is linked into the executable code. Those skilled in the art will appreciate that this is by way of example and that, in other embodiments, the functionality of module 206′ may be provided otherwise.

With further reference to the drawing, a compiler/linker of the type known in the art albeit as adapted in accord with the teachings hereof—generates executable code files from the preprocessed applications 200′-204′ and module 206′ (as well as from any other software modules) suitable for loading into and execution by module 12 at runtime. Although that runtime code is likely to comprise one or more files that are stored on disk (not shown), in L2E cache or otherwise, it is depicted, here, for convenience, as threads 200″-206″ it will ultimately be broken into upon execution.

In the illustrated embodiment, that executable code is loaded into the instruction/data cache 12D at runtime and is staged for execution by the TPUs 12B (here, labelled, TPU[0,0]-TPU[0,2]) of processing module 12 as described above and elsewhere herein. The corresponding enabled (or active) threads are shown here with labels 200″″-204″″. That corresponding to thread management code 206′ is shown, labelled as 206″″.

Upon loading of the executable, thread instantiation and/or throughout their lives, threads 200″″-204″″ cooperate with thread management code 206″″ (whether operating as a thread independent of the default system thread or otherwise) to insure that the quality-of-service requirements of functions provided by those threads 200″″-204″″ is met. This can be done a number of ways, e.g., depending on the factors identified above (e.g., frequency and duration of their use at runtime, and so forth), on system implementation, demands on and capabilities of the system 10, and so forth.

For example, in some instances, upon loading of the executable code, thread management code 206′″ will generate a software interrupt or otherwise invoke threads 200″″-204″″—potentially, long before their underlying functionality is demanded in the normal course, e.g., as a result of user action, software or hardware interrupts or so forth—hence, insuring that when such demand occurs, the threads will be more immediately ready to service it.

By way of further example, one or more of the threads 200′″-204″′ may, upon invocation by module 206″″ or otherwise, signal the default system thread (e.g., working with the thread management code 206″″ or otherwise) to instantiate multiple instances of that same thread, mapping each to different respective upcoming events expected occur, e.g., in the near future. This can help insure more immediate servicing of events that typically occur in batches and for which dedication of additional resources is appropriate, given the quality-of-service demands of those events. C.f, the example above regarding use of JPEG 2000 decoding threads for support of picture-in-a-picture display.

By way of still further example, the thread management code 206′″ can periodically, sporadically, episodically, randomly or otherwise or generate software interrupts or otherwise invoke one or more of threads 200″″-204″″ to prevent them from going inactive, even after apparent termination of their normal processing following servicing of normal events incurred as a result of user action, software or hardware interrupts or so forth again, insuring that when such events occurs, the threads will be more immediately ready to service it.

### Programming Model

### Addressing Model and Data Organization

The illustrated SEP architecture utilizes a single flat address space. The SEP supports both big-endian and little-endian addresses spaces and are configured through a privileged bit in the processor configuration register. All memory data types can be aligned at any byte boundary, but performance is greater if a memory data type is aligned on a natural boundary.

TABLE 1
Address Space

| Memory Format | Address space |
|---|---|
| Signed and unsigned Integer Byte (8 bits) | 2⁶⁴ bytes |
| Signed and unsigned Integer ¼ Word | 2⁶³¼ words |
| (16 bits) | |
| Signed and unsigned Integer ½ Word (32 bits) | 2⁶²½ words |
| Signed and unsigned Integer Word (64 bits) | 2⁶¹ words |
| IEEE single precision floating | 2⁶²½ words |
| point format (32 bits) | |
| IEEE double precision floating | 2⁶¹ words |
| point format (64 bits) | |
| Instruction Doubleword | 2⁶⁰ doublewords |
| Compressed instructions - Huffman | 2⁶⁴ bytes |
| encoded Byte stream in Memory | (not implemented) |

In the illustrated embodiment, all data addresses are byte address format; all data types must be aligned by natural size and addresses by natural size; and, all instruction addresses are instruction doublewords. Other embodiments may vary in one or more of these regards.

### Thread (Virtual Processor) State

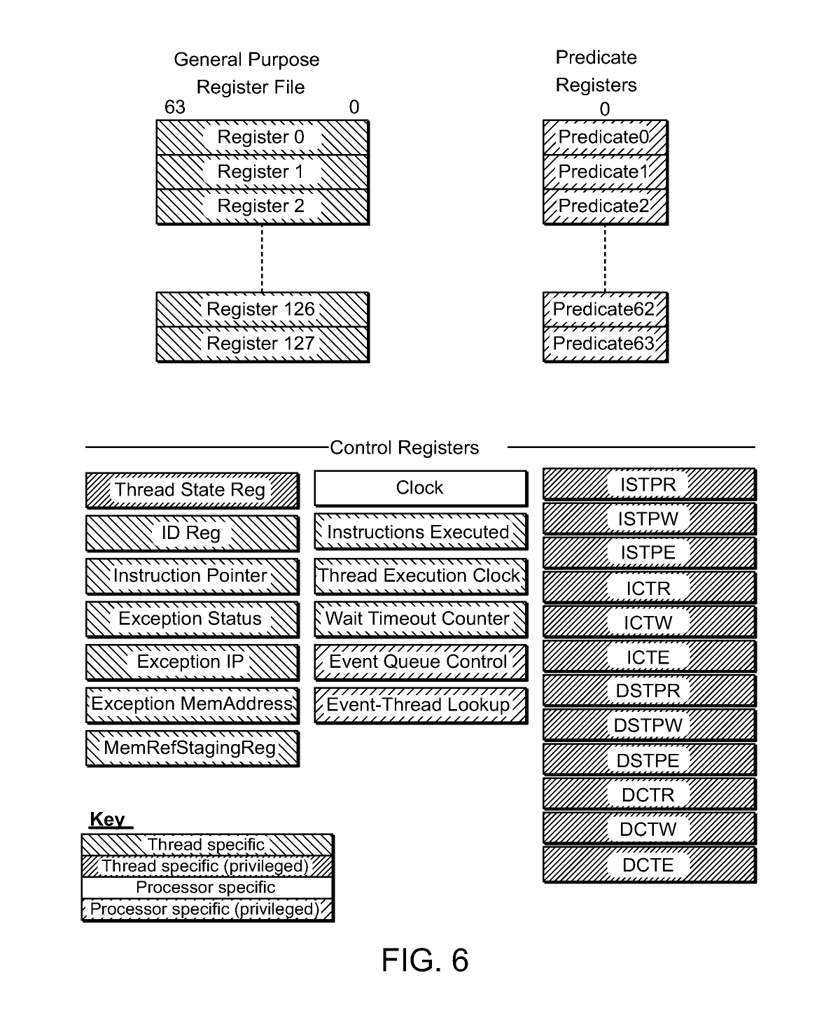

Each application thread includes the register state shown in FIG. 6. This state in turn provides pointers to the remainder of thread state based in memory. Threads at both system and application privilege levels contain identical state, although some thread state is only visible when at system privilege level.

### Register Sizing Implementation Note:

| | Architecture | Min | Desired |
|---|---|---|---|
| Architectural Resource | Size | Goal | Goal |
| Thread General Purpose Registers | 128 | 48 | 64 |
| Predicate Registers | 64 | 24 | 32 |
| Number active threads | 256 | 6 | 8 |
| Pending memory event table | 512 | 16 | 16 |
| Pending memory events/thread | | 2 | |
| Event Queue | | | 256 |
| Event to Thread lookup table | 256 | 16 | 32 |

### General Purpose Registers

Each thread has up to 128 general purpose registers depending on the implementation. General Purpose registers 3-0 (GP[3:0]) are visible only at system privilege level and can be utilized for event stack pointer and working registers during early stages of event processing.

GP registers are organized and normally accessed as a single or adjacent pair of registers analogous to a matrix row. Some instructions have a Transpose (T) option to write the destination as a ¼ word column of 4 adjacent registers or a byte column of 8 adjacent registers. This option can be useful for accelerated matrix transpose and related types of operations.

### Predication Registers

The predicate registers are part of the general purpose illustrated SEP predication mechanism. The execution of each instruction is conditional based on the value of the reference predicate register.

The illustrated SEP provides up to 64 one bit predicate registers as part of thread state. Each predicate register holds what is called a predicate, which is set to 1 (true) or reset to 0 (false) based on the result of executing a compare instruction. Predicate registers 3-1 (PR[3:1]) are visible at system privilege level and can be utilized for working predicates during early stages of event processing. Predicate register 0 is read only and always reads as 1, true. It is by instructions to make their execution unconditional.

### Control Registers

### Thread State Register

| 63 | 23 | | | | | | | | | 7 | | | | | |
|---|---|---|---|---|---|---|---|---|---|---|---|---|---|---|---|
| 24 | 16 | 15 | 14 | 13 | 12 | 11 | 10 | 9 | 8 | 6 | 5 4 | 3 | 2 | 1 | 0 |
| | mod | | dbg | see | daddr | iaddr | align | endian | mem | Thread | Thread | priv | tenable | atrapen | strapen |
| | | | | | | | | | step 1 | bias | state | | | | |

| Bit | Field | Description | | Privilege | Per | Design Useage |
|---|---|---|---|---|---|---|
| 0 | strapen | System trap enable. On reset | | system _rw | Thread | Branch |
| | | cleared. Signalling of system trap | | | | |
| | | resets this bit and atrapen until it | | | | |
| | | is set again by software when it is once | | | | |
| | | again re-entrant. | | | | |
| | | 1 System traps disabled | | | | |
| | | 2 Events enabled | | | | |
| 1 | atrapen | Application trap enable. On reset | | app_rw | Thread | |
| | | cleared. Signalling of application | | | | |
| | | trap resets this bit until it is set again | | | | |
| | | by software when it is once again | | | | |
| | | reentrant. Application trap is cause by | | | | |
| | | an event that is marked as application | | | | |
| | | level when the privilege level is also | | | | |
| | | application level | | | | |
| | | 1 Events disabled (events are | | | | |
| | | disabled on event delivery to thread) | | | | |
| | | 2 Events enabled | | | | |
| 2 | tenable | Thread Enable. On reset set for | | System_rw | Thread | Branch |
| | | thread 0, cleared for all other threads | | | | |
| | | Thread operation is disabled. | | | | |
| | | System thread can load or store | | | | |
| | | thread state. | | | | |
| | | Thread operation is enabled. | | | | |
| 3 | priv | Privilege level. On reset cleared. | | System_rw | Thread | Branch |
| | | 1 System privilege | | App_r | | |
| | | 2 Application privilege | | | | |
| 5:4 | state | Thread State. On reset set to | | System_rw | Thread | Branch |
| | | “executing” for thread0, set to “idle” | | | | |
| | | for all other threads. | | | | |
| | | 1 Idle | | | | |
| | | 2 reserved | | | | |
| | | 3 Waiting | | | | |
| | | 4 Executing | | | | |
| 7:6 | bias | Thread execution bias. Higher value | | System_rw | Thread | Pipe |
| | | gives a bias to the corresponding | | | | |
| | | thread for dispatching instructions. | | | | |
| | | A high bias guarantees a higher | | | | |
| | | dispatch rate, but the exact rate is | | | | |
| | | determined by bias of other active threads | | | | |
| 8 | Memstep1 | Memory step 1- Unaligned memory | | App_rw | Thread | Mem |
| | | reference instructions which cross Ll | | | | |
| | | cache block boundry require two Ll | | | | |
| | | cache cycles to complete. Indicates | | | | |
| | | the first step of a load or store | | | | |
| | | memory reference instruction has | | | | |
| | | completed. For IO space reads, | | | | |
| | | indicates that the data is available. | | | | |
| | | Memory Reference Staging Register | | | | |
| | | (MRSR) contains the special state | | | | |
| | | when Memstepl is set. | | | | |
| 9 | endian | Endian Mode- On reset cleared. | | System_rw | Proc | Mem |
| | | 1 little endian | | App_r | | |
| | | 2 big endian | | | | |
| 10 | align | Alignment check - When clear, | | System_rw | Proc | Mem |
| | | unaligned memory references are | | App_r | | |
| | | allowed. When set, all un-aligned | | | | |
| | | memory references result in unaligned | | | | |
| | | data reference fault. On | | | | |
| | | reset cleared. | | | | |
| 11 | iaddr | Instruction address translation | | System_rw | Proc | Branch |
| | | enable. Onreset cleared. | | App_r | | |
| | | 1 disabled | | | | |
| | | 2 enabled | | | | |
| 12 | daddr | Data address translation enable. On | | System_rw | Proc | Mem |
| | | reset cleared. | | App_r | | |
| | | 1 disabled | | | | |
| | | 2 enabled | | | | |
| 13 | see | Enable Software event enqueue for | | System_rw | Thread | Branch |
| | | application privilege for | | App_r | | |
| | | corresponding thread. When | | | | |
| | | executing at system privilege sw | | | | |
| | | events are always enabled. | | | | |
| | | 1 Disabled- Corresonding thread, | | | | |
| | | when executing at application | | | | |
| | | privilege can not directly enqueue sw | | | | |
| | | events. | | | | |
| | | 2 Enabled - Corresponding | | | | |
| | | thread, when executing at application | | | | |
| | | privilege can directly enqueue sw events | | | | |
| | | control register | | | | |
| 14 | dbg | Debug enable. On reset cleared. | | System_rw | Proc | Branch |
| | | 0- Disabled- debug mode disabled | | | | |
| | | 1- Enabled- debug mode enabled | | | | |
| 15 | | Reserved | | | | |
| 23:16 | mod[7:0] | GP Registers Modified. | | App_rw | Thread | Pipe |
| | | Cleared on reset. | | | | |
| | | bit | modified for registers | | | |
| | | 8 | registers 0-15 | | | |
| | | 9 | registers 16-31 | | | |
| | | 10 | registers 32-47 | | | |
| | | 11 | registers 48-63 | | | |
| | | 12 | registers 63-79 | | | |
| | | 13 | registers 80-95 | | | |
| | | 14 | registers 96-111 | | | |
| | | 15 | registers 112-127 | | | |

### ID Register

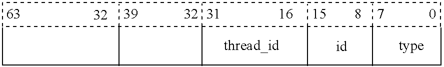

| Bit | Field | Description | Privilege | Per |
|---|---|---|---|---|
| 7:0 | type | Processor type and | read only | Proc |
| | | revision[7:0] | | |
| 15:8 | id | Processor ID[7:0] - Virtual | read only | Thread |
| | | processor number | | |
| 31:16 | thread_id | Virtual Thread Number[15:0] | System _rw | Thread |
| | | | App_ro | |

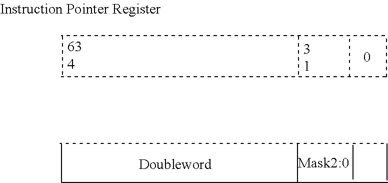

Specifies the 64 bit virtual address of the next instruction to be executed.

| Bit | Field | Description | Privilege | Per |
|---|---|---|---|---|
| 63:4 | Doubleword | Doubleword address of | app | thread |
| | | instruction doubleword | | |
| 4:1 | Mask 2:0 | Indicates which instructions | app | thread |
| | | within instruction | | |
| | | doubleword remain to be | | |
| | | executed. | | |
| | | •Bit0 - first instruction | | |
| | | doubleword 0, bit[0:00] | | |
| | | •Bit1- second instruction | | |
| | | doubleword 0, bit[81:41] | | |
| | | •Bit2- third instruction | | |
| | | doubleword 0, bit[22:82] | | |
| 0 | reserved | | | |

### System Exception Status Register

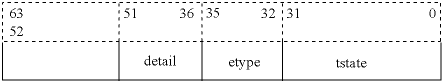

| Bit | Field | Description | Privilege | Per |
|---|---|---|---|---|
| 31:0 | tstate | Thread State register at | read | Thread |
| | | time of exception | only | |
| 35:32 | etype | Exception Type | read | Thread |
| | | 1 none | only | |
| | | 2 event | | |
| | | 3 timer event | | |
| | | 4 SW event | | |
| | | 5 reset | | |
| | | 6 SystemCall | | |
| | | 7 Single Step | | |
| | | 8 Protection Fault | | |
| | | 9 Protection Fault, system call | | |
| | | 10 Memory reference Fault | | |
| | | 11 HW fault | | |
| | | 12 others | | |
| 51:36 | detail | Fault details - Valid for the | | |
| | | following exception types: | | |
| | | •Memory reference fault | | |
| | | details (type 5) | | |
| | | 1 None | | |
| | | 2 page fault | | |
| | | 3 waiting for fill | | |
| | | 4 waiting for empty | | |
| | | 5 waiting for completion of | | |
| | | cache miss | | |
| | | 6 memory reference error | | |
| | | •event (type 1) - Specifies the 16 bit | | |
| | | event number | | |

### Application Exception Status Register

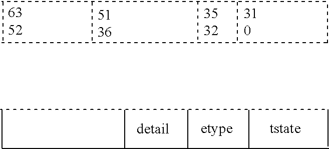

| Bit | Field | Description | Privilege | Per |
|---|---|---|---|---|
| 31:0 | tstate | Thread State register at time | read only | Thread |
| | | of exception | | |
| 35:32 | etype | Exception Type | read only | Thread |
| | | 1 none | | |
| | | 2 event | | |
| | | 3 timer event | | |
| | | 4 SW event | | |
| | | 5 Others | | |
| 51:36 | detail | Protection Fault details-Valid | | |
| | | for the following exception | | |
| | | types: | | |
| | | •event (type 1) - Specifies | | |
| | | the 16 bit event number | | |

### System Exception IP

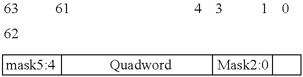

Address of instruction corresponding to signaled exception to system privilege.

| Bit | Field | Description | Privilege | Per |
|---|---|---|---|---|
| 61:5 | Doubleword | Quadwork address of instruction | system | thread |
| | | doubleword with address[63:62] | | |
| | | equal zero. | | |
| 3:1 | Mask 2:0 | Indicates which instructions | system | thread |
| | | within instruction doubleword | | |
| | | remain to be executed. | | |
| | | •Bit0- first instruction double- | | |
| | | word 0, bit[40:00] | | |
| | | •Bit1 - second instruction double- | | |
| | | word 0, bit[81:41] | | |
| | | •Bit2 - third instruction double- | | |
| | | word 0, | | |
| 0 | reserved | bit[122:82] | | |

Address of instruction corresponding to signaled exception.

### Application Exception IP

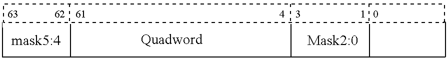

Address of instruction corresponding to signaled exception to application privilege.

| Bit | Field | Description | Privilege | Per |
|---|---|---|---|---|
| 61:5 | Doubleword | Quadwork address of instruction | system | thread |
| | | doubleword with | | |
| | | address[63:62] equal zero. | | |
| 3:1 | Mask 2:0 | Indicates which instructions | system | thread |
| | | within instruction doubleword | | |
| | | remain to be executed. | | |
| | | •Bit 0- first instruction | | |
| | | doubleword 0, bit[40:00] | | |
| | | •Bit l- second instruction | | |
| | | doubleword 0, bit[81:41] | | |
| | | •Bit 2- third instruction | | |
| | | doubleword 0, bit[122:82] | | |
| 0 | reserved | | | |

### Exception Mem Address

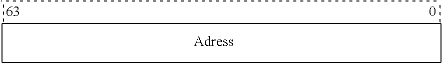

Address of memory reference that signaled exception. Valid only for memory faults. Holds the address of the pending memory operation when the Exception Status register indicates memory reference fault, waiting for fill or waiting for empty.

Instruction Seg Table Pointer (ISTP), Data Seg Table Pointer (DSTP)

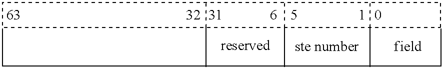

Utilized by ISTE and ISTE registers to specify the step and field that is read or written.

| Bit | Field | Description | Privilege | Per |
|---|---|---|---|---|
| 0 | field | Specifies the low (0) or high (1) | system | thread |
| | | portion of Segment Table Entry | | |
| 5:1 | ste number | Specifies the STE number that is read | system | thread |
| | | into STE Data Register. | | |

Instruction Segment Table Entry (ISTE), Data Segment Table Entry (DSTE)

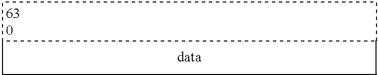

When read the STE specified by ISTE register is placed in the destination general register. When written, the STE specified by ISTE or DSTE is written from the general purpose source register. The format of segment table entry is specified in “Virtual Memory and Memory System,” hereof, section titled Translation Table organization and entry description.

Instruction or Data Level1 Cache Tag Pointer (ICTP, DCTP)

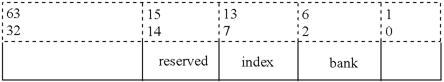

Specifies the Instruction Cache Tag entry that is read or written by the ICTE or DCTE.

| Bit | Field | Description | Privilege | Per |
|---|---|---|---|---|
| 6:2 | bank | Specifies the bank that is read | system | thread |
| | | from Level1 Cache Tag Entry. | | |
| | | The first implementation | | |
| | | has valid banks 0x0-f. | | |
| 13:7 | index | Specifies the index address | System | thread |
| | | within a bank that is read from | | |
| | | Level1 Cache Tag Entry | | |

Instruction or Data Level1 Cache Tag Entry (ICTE, DCTE)

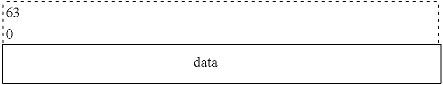

When read the Cache Tag specified by ICTP or DCTP register is placed in the destination general register. When written, the Cache Tag specified by ICTP or DCTP is written from the general purpose source register. The format of cache tag entry is specified in “Virtual Memory and Memory System,” hereof, section titled Translation Table organization and entry description.

Memory Reference Staging Register (MRSR0, MRSR1)

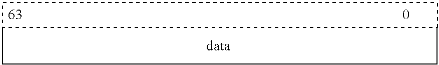

Memory Reference Staging Registers provide a 128 bit staging register for some memory operations. MRSR0 corresponds to low 64 bits.

| Instruction | Condition | Usage |
|---|---|---|
| Load, | Aligned access or | Not used |
| LoadPair, | aligned access which | |
| Store, StorePair | does not cross a level1 | |
| | cache block | |
| Load, LoadPair | Unaligned access which | Holds the portion of the load from |
| | crosses a level1 cache | the lower addressed cache |
| | block | block which the upper address |
| | | cache block is accessed |
| Store, StorePair | Unaligned access which | Not used |
| | crosses a level1 cache | |
| | block | |
| Load, LoadPair | IO Space | Holds the value of IO space read |

Enqueue SW Event Register

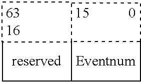

Writing to the enqueue SW Event register en-queues an event onto the Event Queue to be handled by a thread.

| Bit | Field | Description | Privilege | Per |
|---|---|---|---|---|
| 15:0 | Eventnum | Number of clock cycles since | See ese | proc |
| | | processor reset | | |
| 63:16 | reserved | Reserved for expansion of | See ese | proc |
| | | event number | | |

### Timers and Performance Monitor

All timer and performance monitor registers are accessible at application privilege.

Clock

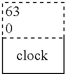

| Bit | Field | Description | Privilege | Per |
|---|---|---|---|---|
| 63:0 | clock | Number of clock cycles | app | proc |
| | | since processor reset | | |

Instructions Executed

| 63 32 | 31 0 |
|---|---|
| | count |

| | | | Privi- | |
|---|---|---|---|---|
| Bit | Field | Description | lege | Per |
| 31:0 | count | Saturating count of the number of | app | thread |
| | | instruction executed. Cleared on read. | | |
| | | Value of all 1's indicates that the count has | | |
| | | overflowed. | | |

Thread Execution Clock

| 63 | 31 |
|---|---|
| 32 | 0 |
| | active |

| | | | Privi- | |
|---|---|---|---|---|
| Bit | Field | Description | lege | Per |
| 31:0 | active | Saturating count of the number of cycles | app | thread |
| | | the thread is in active-executing state. | | |
| | | Cleared on read. Value of all 1's indicates | | |
| | | that the count has overflowed. | | |

Wait Timeout Counter

| 63 | 31 |
|---|---|
| 32 | 0 |
| | timeout |

| Bit | Field | Description | Privilege | Per |
|---|---|---|---|---|
| 31:0 | timeout | Count of the number of cycles remaining | app | thread |
| | | until a timeout event is signaled to thread. | | |
| | | Decrements by one, each clock cycle. | | |

### Instruction Set Overview

### Overall Concepts

### Thread is Basic Control Flow of Instruction Execution

The thread is the basic unit of control flow for illustrated SEP embodiment. It can execute multi-threads concurrently in a software transparent manner. Threads can communicate through shared memory, producer-consumer memory operations or events independent of whether they are executing on the same physical processor and/or active at that instant. The natural method of building SEP applications is through communicating threads. This is also a very natural style for Unix and Linux. See “Generalized Events and Multi-Threading,” hereof, and/or the discussions of individual instructions for more information.

### Instruction Grouping and Ordering

The SEP architecture requires the compiler to specify what instructions can be executed within a single cycle for a thread. The instructions that can be executed within a single cycle for a single thread are called an instruction group. An instruction group is delimited by setting the stop bit, which is present in each instruction. The SEP can execute the entire group in a single cycle or can break that group up into multiple cycles if necessary because of resource constraints, simultaneous multi-thread or event recognition. There is no limit to the number of instructions that can be specified within an instruction group. Instruction groups do not have any alignment requirements with respect to instruction doublewords.

In the illustrated embodiment, branch targets must be the beginning of an instruction doubleword; other embodiments may vary in this regard.

### Result Delay

Instruction result delay is visible to instructions and thus the compiler. Most instructions have no result delay, but some instructions have 1 or 2 cycle result delay. If an instruction has a zero result delay, the result can be used during the next instruction grouping. If an instruction has a result delay of one, the result of the instruction can be first utilized after one instruction grouping. In the rare occurrence that no instruction that can be scheduled within an instruction grouping, a one instruction grouping consisting of a NOP (with stop bit set to delineate end of group) can be used. The NOP instruction does not utilize any processor execution resources.

### Predication

In addition to general purpose register file, SEP contains a predicate register file. In the illustrated embodiment, each predicate register is a single bit (though, other embodiments may vary in this regard). Predicate registers are set by compare and test instructions. In the illustrated embodiment, every SEP instruction specifies a predicate register number within its encoding (and, again, other embodiments may vary in this regard). If the value of the specified predicate register is true the instruction is executed, otherwise the instruction is not executed. The SEP compiler utilizes predicates as a method of conditional instruction execution to eliminate many branches and allow more instructions to be executed in parallel than might otherwise be possible.

### Operand Size and Elements

Most SEP instructions operate uniformly across a single word, two ½ words, four ¼ words and eight bytes. An element is a chuck of the 64 bit register that is specified by the operand size.

### Low Power Instruction Set

The instruction set is organized to minimize power consumption—accomplishing maximal work per cycle rather than minimal functionality to enable maximum clock rate.

### Exceptions

Exceptions are all handled through the generalized event architecture. Depending on how event recognition is set up, a thread can handle it own events or a designated system thread can handle an events. This event recognition can be set up on an individual event basis.

### Just in Time Compilation Parallelism

The SEP architecture and instruction set is a powerful general purpose 64 bit instruction set. When couple with the generalized event structure, high performance virtual environments can be set up to execute Java or ARM for example.

### Instruction Classes

This section will be expanded to overview the instruction classes

### Memory Access

| Instruction | Description |
|---|---|
| Load | Load memory operand into general purpose register |
| Store | Store memory operand from general purpose |
| | register |
| Load Pair | Load two word memory operand into two general |
| | purpose registers |
| Store Pair | Store two word memory operand from two general |
| | purpose registers |
| Prefetch | Hint to memory system that memory address will be |
| | required soon |
| Translation probe | Indicates whether a specified System Address has |
| | access privilege in this thread in a specific thread |
| | context (privileged) |
| Load predicate | Loads the predicate registers from memory |
| Store predicate | Stores the predicate registers to memory |
| Empty | Usually executed by the consumer of a memory |
| | object to indicate that object at the corresponding |
| | address has been consumed |
| Fill | Usually executed by the producer of a memory |
| | object to indicate that the object at the |
| | corresponding address has been consumed. |
| Cache Allocate | Software based cache allocation. |

### Compare and Test

Parallel compares eliminates the artificial delay in evaluating complex conditional relationships.

| Instruction | Description |
|---|---|
| CMP | Compare integer word and set predicate registers |
| CMPMS | Compare multiple integer elements and set predicate |
| | register based on summary of compares |
| CMPM | Compare multiple integer elements and set general |
| | purpose register with the result of compares |
| FCMP | Compare floating point element and set predicate |
| | registers |
| FCMPM | Compare multiple floating point elements and set |
| | general purpose register with the result of compares |
| FCLASS | Classify floating point elements and set predicate |
| | registers based on result |
| FCLASSM | Classify multiple floating point elements and set |
| | general purpose register based on result. |
| TESTB | Test specified bit and set predicate registers based on |
| | result |
| TESTBM | Test specified bit of each element and set general |
| | purpose register based on result. |

### Operate and Immediate

| Instruction | Description |
|---|---|
| ADD | Add integer elements |
| LOGIC | Logical and, or, xor or andc between integer |
| | elements |
| SHIFTBYTE | Shift integer elements the specified number of bytes |
| SHIFT | Shift integer elements the specified number of bits. |
| PACK | Two registers are concatenated and elements packed |
| | into a single destination register |
| UNPACK | Each element of source is unpacked to the next |
| | larger size. |
| EXTRACT | A field is extract from each element and right |
| | justified in each element of destination |
| DEPOSIT | Bit field for each element of 2^{nd} source is merged |
| | with first source |
| SPLAT | Contents a source element are extended and placed |
| | in each element of destination. |
| POP | Count the number of bits set to value 1. |
| FINDF | For each element find the first chunk that match |
| | criterion. |
| MUL | Multiply integer elements |
| MULSEL | Multiply integer elements and select result field for |
| | each element |
| MIN/MAX | integer minimum and maximum for each element |
| AVE | Add the elements from two sources and calculate |
| | average for each element |
| FMIN/FMAX | Floating point minimum and maximum |
| FROUND | Round floating point elements |
| CONVERT | Convert to or from floating point elements to integer |
| | elements |
| EST | Floating point estimate functions including |
| | reciprocal, reciprocal square root, log and power. |
| FADD | Floating point addition. |
| FMULADD | Multiply and add floating point elements |
| MULADD | Multiply and add integer elements |
| MULSUM | Multiply and sum integer elements |
| SUM | Sum integer elements |
| MOVI | Integer and floating point move immediate, 21 or 64 |
| | bits |
| Control field | Modifies specific control register fields |
| MOVECTL | Move to or from control register and general register. |

### Branch, SW Events

| Instruction | Description |
|---|---|
| BR | Branch instruction |
| Event | Poll the event queue |
| SWEVENT | Initiate a software event |

### Instruction Set

### Memory Access Instructions

### Load Register Load

| 42 | 37 | | 34 | | 25 | | | | 20 | 13 | 6 | |
|---|---|---|---|---|---|---|---|---|---|---|---|---|
| 38 | 36 | 35 | 28 | 27 26 | 24 | 23 | 22 | 21 | 14 | 7 | 1 | 0 |
| 00000 | lsize | 0 | dreg | * | cache | ls2 | u | 0 | ireg | breg | ps | stop |
| 00000 | lsize | 1 | dreg | disp[9:8] | cache | ls2 | u | disp[7:0] | | breg | ps | stop |
| 00001 | cache | 0 | dreg | * | 01 | 0 | u | 0 | ireg | breg | ps | stop |

| | | | | | | | | | | | |
|---|---|---|---|---|---|---|---|---|---|---|---|
| 00001 | cache | 1 | dreg | disp[9:8] | 01 | 0 | u | disp[7:0] | breg | ps | stop |

### Format:

| | |
|---|---|
| ps LOAD.lsize.cache dreg, breg.u, ireg {,stop} | register index form |
| ps LOAD.lsize.cache dreg, breg.u, disp, {,stop} | displacement form |
| ps LOAD.splat32.cache dreg, breg.u, ireg {,stop} | splat32 register index |
| | form |
| ps LOAD.splat32.cache dreg, breg.u, disp, {,stop} | splat32 displacement |
| | form |

### Description:

A value consisting of lsize is read from memory starting at the effective address.
The lsize value is then sign or zero extended to word size and placed in dreg (destination register). Splat32 form loads a ½ word into both the low and high ½ words of dreg.
For the register index form, the effective address is calculated by adding breg (base register) and ireg (index register). For the displacement form, the effective address is calculated by adding breg (base register) and disp (displacement) shifted by lsize:

byte: EA=breg[63:0]+disp[9:0]

¼ word: EA=breg[63:0]+(disp[9:0]<1)

½ word: EA=breg[63:0]+(disp[9:0]<2)

word: EA=breg[63:0]+(disp[9:0]<3)

Double-word: EA=breg[63:0]+(disp[9:0]<4)
Both aligned and unaligned effective address are supported. Aligned and unaligned access which does not cross an L1 cache block boundary execute in a single cycle. Unaligned access requires a second cycle to access the second cache block. Aligned effective address is recommended where possible, but unaligned effective addressing is statistically high performance.

| | Offset with respect to | | Probability within L1 | |
|---|---|---|---|---|
| | L1 block | | block | |
| lsize | within | across | random | sequential |
| | | | access | access |
| Byte | 0-127 | none | 100% | 100% |
| ¼ word | 0-126 | 127 | 99% | 98% |
| ½ word | 0-124 | 125-127 | 98% | 96% |
| word | 0-120 | 121-127 | 95% | 94% |
| double | 0-112 | 113-127 | 88% | 88% |
| word | | | | |

### Operands and Fields:

ps The predicate source register that specifies whether the instruction is executed. If true the instruction is executed, else if false the instruction is not executed (no side effects).
stop
   0 Specifies that an instruction group is not delineated by this instruction.
   1 Specifies that an instruction group is delineated by this instruction.
cache
   0 read only with reuse cache hint
   1 read/write with reuse cache hint
   2 read only with no-reuse cache hint
   3 read/write with no-reuse cache hint
u
   0 Base register (breg) is not modified
   1 Write base register (breg) with base plus index register (or displacement) address calculation.
lsize[2:0]
   0 Load byte and sign extend to word size
   1 Load ¼ word and sign extend to word size
   2 Load ½ word and sign extend to word size
   3 Load word
   4 Load byte and zero extend to word size
   5 Load ¼ word and zero extend to word size
   6 Load ½ word and zero extend to word size
   7 Load pair into (dreg[6:1],0) and (dreg[6:1],1)
ireg Specifies the index register of the instruction.
breg Specifies the base register of the instruction.
disp[9:0] Specifies the two-s complement displacement constant (10 bits) for memory reference instructions.
dreg Specifies the destination register of the instruction.
Exceptions:
   TLB faults
   Page not present fault

### Store to Memory Store

| 42 | 37 | | 34 | 27 | | | | | | 20 | 13 | 6 | |
|---|---|---|---|---|---|---|---|---|---|---|---|---|---|
| 38 | 36 | 35 | 28 | 26 | 25 | 24 | 23 | 22 | 21 | 14 | 7 | 1 | 0 |
| 00001 | size | 0 | s1reg | * | ru | 0 | sz2 | u | 0 | ireg | breg | predicate | stop |

| | | | | | | | | | | | | |
|---|---|---|---|---|---|---|---|---|---|---|---|---|
| 00001 | size | 1 | s1reg | disp[9:8] | ru | 0 | sz2 | u | disp[7:0] | breg | predicate | stop |

Format:

| | |
|---|---|
| ps STORE.size.ru slreg, breg.u, ireg {,stop} | register index |
| | form |
| ps STORE.size.ru dreg reg, breg.u, disp,{,stop} | displacement |
| | form |

Description: A value consisting of least significant ssize bits of the value in s1reg is written to memory starting at the effective address. For the register index form, the effective address is calculated by adding breg (base register) and ireg (index register). For the displacement form, the effective address is calculated by adding breg (base register) and disp (displacement) shifted by lsize:

byte: EA=breg[63:0]+disp[9:0]

¼ word: EA=breg[63:0]+(disp[9:0]<1)

½ word: EA=breg[63:0]+(disp[9:0]<2)

word: EA=breg[63:0]+(disp[9:0]<3)

Double-word: EA=breg[63:0]+(disp[9:0]<4)
Both aligned and unaligned effective address are supported. Aligned and unaligned access which does not cross an L1 cache block boundary execute in a single cycle. Unaligned access requires a second cycle to access the second cache block. Aligned effective address is recommended where possible, but unaligned effective addressing is statistically high performance.

| | Offset with respect to | | Probability within L1 | |
|---|---|---|---|---|
| | L1 block | | block | |
| lsize | within | across | random | sequential |
| | | | access | access |
| Byte | 0-127 | none | 100% | 100% |
| ¼ word | 0-126 | 127 | 99% | 98% |
| ½ word | 0-124 | 125-127 | 98% | 96% |
| word | 0-120 | 121-127 | 95% | 94% |
| double | 0-112 | 113-127 | 88% | 88% |
| word | | | | |

### Operands and Fields:

ps The predicate source register that specifies whether the instruction is executed. If true the instruction is executed, else if false the instruction is not executed (no side effects).
stop
   0 Specifies that an instruction group is not delineated by this instruction.
   1 Specifies that an instruction group is delineated by this instruction.
ru
   0 resuse cache hint
   1 no-reuse cache hint
u
   0 Base register (breg) is not modified
   1 Write base register (breg) with base plus index register (or displacement) address calculation.
size[2:0]
   Store byte
   1 Store ¼ word
   2 Store ½ word
   3 Store word
   4-6 reserved
   7 Store register pair (dreg[6:1],0) and (dreg[6:1],1) into memory
ireg Specifies the index register of the instruction.
breg Specifies the base register of the instruction.
disp Specifies the two-s complement displacement constant (10 bits) for memory reference instructions
s1reg Specifies the register that contains the first operand of the instruction.
Exceptions:
   TLB faults
   Page not present fault

### Cache Operation CacheOp

| 42 | | | | | | | | | | |
|---|---|---|---|---|---|---|---|---|---|---|
| 38 | 37 35 | 34 28 | 27 24 | 23 | 22 | 22 | 20 14 | 13 7 | 6 1 | 0 |
| 00001 | 010 | dreg | 1*** | * | 0 | 1 | * | breg | ps | stop |
| 00001 | 010 | dreg | 1*** | * | 1 | 1 | s1reg | breg | ps | stop |

Format:

| | |
|---|---|
| ps.CacheOp.pr dreg = breg {,stop} | address form |
| ps.CacheOp.pr dreg = breg,s1reg {,stop} | address-source form |

Description: Instructs the local level2 and level2 extended cache to perform an operation on behalf of the issuing thread. On multiprocessor systems these operations can span to non-local level2 and level2 extended caches. Breg specifies the operation and address corresponding to the operation. The optional s1reg specifies an additional source operand which depends on the operation. The return value specified by the issued CacheOp is placed into dreg. CacheOp always causes he corresponding thread to transition from executing to wait state.

TABLE 2
CacheOp breg format

| | 63 | 13 |
|---|---|---|
| | 14 | 0 |
| Cache Allocate | Page address | 0x0000 |
| reserved | * | 0x0001-0x3fff |

TABLE 3
CacheOp operand description

| | Address | Source | | |
|---|---|---|---|---|
| | form | form | | |
| | privilege | privilege | sreg | dreg |
| Cache Allocate | system | reserved | reserved | See Table 4 |
| reserved | reserved | reserved | reserved | |

TABLE 4
Cache Allocate dreg description

| | 63 | 29 | 13 |
|---|---|---|---|
| | 30 | 14 | 0 |
| Success | reserved | L2E page number | 0x0000 |
| Already | Reserved | L2E page number | 0x0001 |
| allocated | | | |
| No space | * | * | 0x0002 |
| available | | | |
| reserved | * | * | 0x0003-0x3fff |

### Operands and Fields:

ps The predicate source register that specifies whether the instruction is executed. If true the instruction is executed, else if false the instruction is not executed (no side effects).
stop
   0 Specifies that an instruction group is not delineated by this instruction.
   1 Specifies that an instruction group is delineated by this instruction.
s1reg Specifies the source register for the address-source version of CacheOp instruction.
dreg Specifies the destination register for the CacheOp instruction.

### Exceptions:

Privilege exception when accessing system control field at application privilege level.

### Operate Instructions

Most operate instructions are very symmetrical, except for the operation performed.

### Add Integer Operations ADD, SUB, ADDSATU, ADDSAT, SUBSATU, SUBSAT, RSUBSATU, RSUBSAT, RSUB

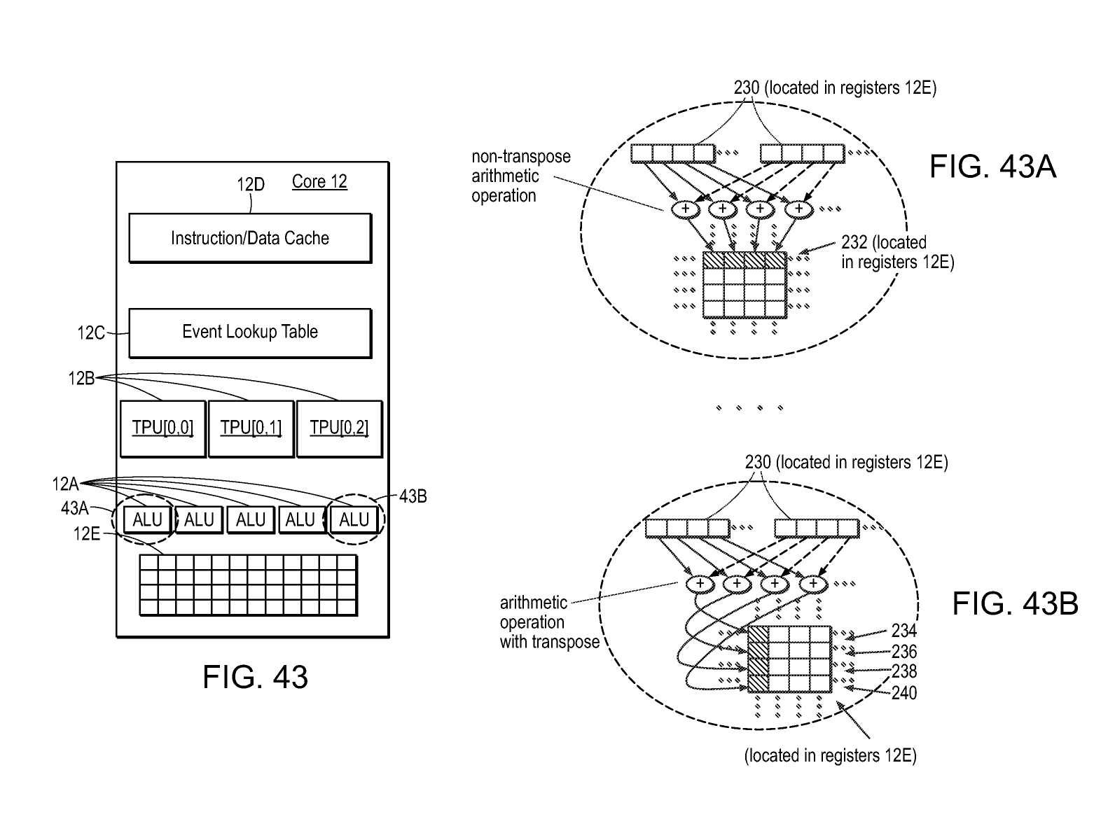

FIG. 43 depicts a core 12 constructed and operated as discussed elsewhere herein in which the functional units 12A, here, referred to as ALUs (arithmetic logic units), execute selected arithmetic operations concurrently with transposes.

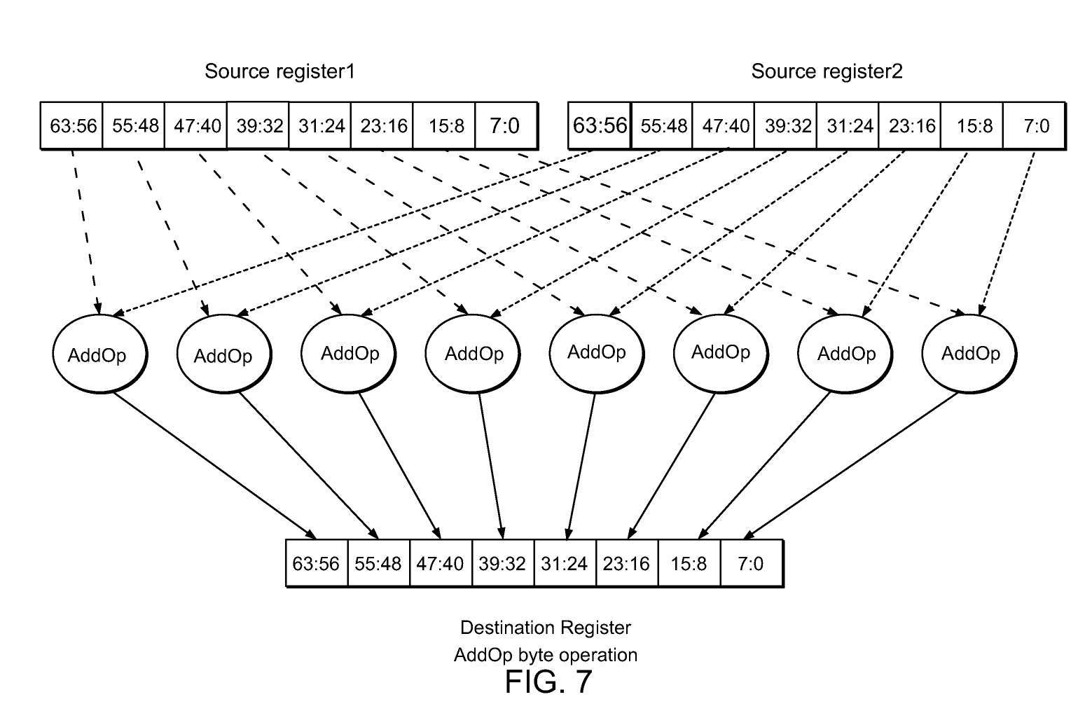

In operation, arithmetic logic units 12A of the illustrated core 12 execute conventional arithmetic instructions, including unary and binary arithmetic instructions which specify one or more operands 230 (e.g., longwords, words or bytes) contained in respective registers by storing results of the designated operations in in a single register 232, e.g., typically in the same format as one or more of the operands (e.g., longwords, words or bytes). An example of this is shown in the upper right of FIG. 43 and more examples are shown in FIGS. 7-10.

The illustrated ALUs, however, execute such arithmetic instructions that include a transpose (T) parameter (e.g., as specified, here, by a second bit contained in the addop field—but, in other embodiments, as specified elsewhere and elsewise) by transposing the results and storing them across multiple specified registers. Thus, as noted below, when the value of the T bit of the addop field is 0 (meaning no transpose), the result is stored in normal (i.e., non-transposed) register format, which is logically equivalent to a matrix row. However, when that bit is 1 (meaning transpose), the result is stored in transpose format, i.e., across multiple registers 234-240, which is logically equivalent to storing the result in a matrix column—as further discussed below. In this regard, the ALUs apportion results of the specified operations across multiple specified registers, e.g., at a common word, byte, bit or other starting point. Thus, for example, an ALU may execute an ADD (with transpose) operation that write the results, for example, as a one-quarter word column of four adjacent registers or, by way of further example, a byte column of eight adjacent registers. The ALUs similarly execute other arithmetic operations—binary, unary or otherwise—with such concurrent transposes.

Logic gates, timing, and the other structural and operational aspects of operation of the ALUs 12E of the illustrated embodiment effecting arithmetic operations with optional transpose in response to the aforesaid instructions may be implemented in the conventional manner of known in the art as adapted in accord with the teachings hereof.

| 42 | 37 | | 34 | | 26 | | | 13 | 6 | |
|---|---|---|---|---|---|---|---|---|---|---|
| 38 | 36 | 35 | 28 | 27 | 22 | 21 | 20 14 | 7 | 1 | 0 |
| 01010 | osize | 0 | dreg | 0 | addop | 0 | s2reg | s1reg | predicate | stop |

| | | | | | | | | | |
|---|---|---|---|---|---|---|---|---|---|
| 01010 | osize | 1 | dreg | 0 | addop | immediate8 | s1reg | predicate | stop |

| | | | | | | | |
|---|---|---|---|---|---|---|---|
| 00010 | osize | 0 | dreg | immediate14 | s1reg | predicate | stop |

Format:

| | |
|---|---|
| ps.addop.T.osize. dreg = s1reg, s2reg {,stop} | register form |
| ps.addop.T.osize dreg = s1reg, immediate8, {,stop} | immediate form |
| ps.add.T.osize dreg = s1reg, immediate14 {,stop} | long immediate |
| | form |

Description: The two operands are operated on as specified by addop and osize fields and the result placed in destination register dreg. The add instruction processes a full 64 bit word as a single operation or as multiple independent operations based on the natural size boundaries as specified in the osize field and illustrated in FIGS. 7-10.

### Operands and Fields:

addop

| addop | | | |
|---|---|---|---|
| [5:0] | Mnemonic | Description | Register usage |
| 0T000 | ADD | signed add | dreg = s1reg + s2reg |
| | | | dreg = s1reg + immediate8 |
| 0T001 | | reserved | |
| 0T010 | ADDSAT | signed saturated add | dreg = s1reg + s2reg |
| | | | dreg = s1reg + immediate |
| 0T011 | ADDSATU | unsigned saturated | dreg = s1reg + s2reg |
| | | add | dreg = s1reg + immediate |
| 0T100 | SUB | signed subtract | dreg = s1reg − s2reg |
| | | | dreg = s1reg − immediate |
| 0T101 | | reserved | |
| 0T110 | SUBSAT | signed saturated | dreg = s1reg − s2reg |
| | | subtract | dreg = s1reg − immediate |
| 0T111 | SUBSATU | unsigned saturated | dreg = s1reg − s2reg |
| | | subtract | dreg = s1reg − immediate |
| 10000 | RSUB | reverse signed | dreg = s2reg − s1reg |
| | | subtract | dreg = immediate − s1reg |
| 10001 | | reserved | |
| 10010 | RSUBSAT | reverse signed | dreg = s2reg − s1reg |
| | | saturated subtract | dreg = immediate − s1reg |
| 10011 | RSUBSAU | reverse unsigned | dreg = s2reg − s1reg |
| | | saturated subtract | dreg = immediate − s1reg |
| 10100 | Addhigh | Take the carry out of | dreg = carry(s1reg + s2reg) |
| | | unsigned addition and | dreg = carry(s1reg + |
| | | place it into result | immediate) |
| | | register | |
| 10101 | Subhigh | Take the carry out of | dreg = carry(s1reg − s2reg) |
| | | unsigned subtract and | dreg = carry(s1reg − |
| | | place it into result | immediate) |
| | | register | |
| 10110 | | Logic instructions | |
| 11111 | | reserved for other | |
| | | instructions | |

ps The predicate source register that specifies whether the instruction is executed. If true the instruction is executed, else if false the instruction is not executed (no side effects).
stop
   0 Specifies that an instruction group is not delineated by this instruction.
   1 Specifies that an instruction group is delineated by this instruction.
osize
   0 Eight independent byte operations
   1 Four independent ¼ word operations
   2 Two independent ½ word operations
   3 Single word operation
immediate8 Specifies the immediate8 constant which is zero extended to operation size for unsigned operations and sign extended to operation size for signed operations. Applied independently to each sub operation.
Immediate 14 Specifies the immediate 14 constant which is sign extended to operation size. Applied independently to each sub operation.
s1reg Specifies the register that contains the first source operand of the instruction.
s2reg Specifies the register that contains the second source operand of the instruction.
dreg Specifies the destination register of the instruction.
T (transpose)

| Transpose[0] | Mnemonic | Description |
|---|---|---|
| 0 | nt | Default. Store result in normal register |
| | | format, which would be logically equivalent |
| | | to a matrix row. |
| 1 | t | Store result in transpose format. Transpose |
| | | format is logically equivalent to storing the |
| | | result in a matrix column. Valid for osize |
| | | equal 0 (byte operations) or 1 (¼ word |
| | | operations). |
| | | For byte operations, the destination for each |
| | | byte is specified by [dreg[6:3],byte[2:0]], |
| | | where byte[2:0] is the corresponding byte in |
| | | the destination. Thus only one byte in 8 |
| | | contingous registers is updated. |
| | | For ¼ word operations, the destination for |
| | | each ¼ word is specified by |
| | | [dreg[6:2],qw[1:0]], where qw[1:0] is the |
| | | corresponding ¼ word in the destination. |
| | | Thus only one ¼ word in 4 contigous |
| | | registers is updated. |

### Transpose Bits TRAN

| 42 | 37 | | 34 | 27 | | | 20 | 13 | 6 | |
|---|---|---|---|---|---|---|---|---|---|---|
| 38 | 36 | 35 | 28 | 23 | 22 | 21 | 14 | 7 | 1 | 0 |
| 01010 | mode | 0 | dreg | 11000 | mode | 1 | s2reg | s1reg | predicate | stop |

| | | | | | | | | |
|---|---|---|---|---|---|---|---|---|
| 01101 | 01 | qw | dreg | s3reg | s2reg | s1reg | predicate | stop |

Format:

| | |
|---|---|
| ps.tran.mode dreg = s1reg, s2reg {,stop} | fixed form |
| ps.tran.qw dreg = s1reg, s2reg, s3reg {,stop} | variable form |

Description: For the fixed form, bits within each ¼ word (QW) or byte element are bit transposed based on mode to the dreg register. For the variable form, bits within each ¼ word (QW) or byte element are are bit transposed based on qw and s3reg bit positions to the dreg register.

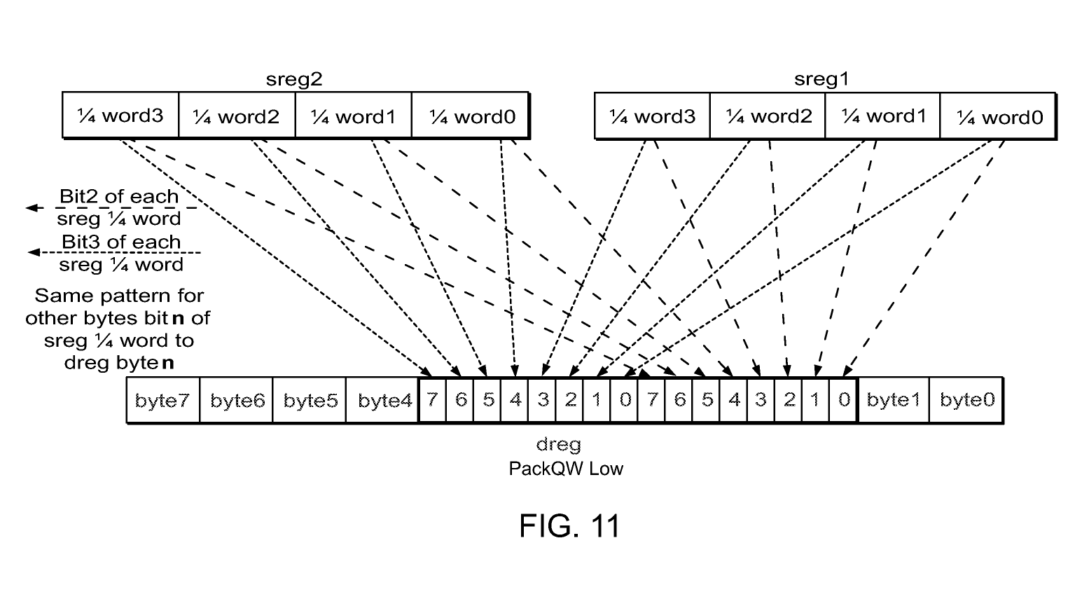

### See FIGS. 11-16

mode

| mode[2:0] | Mnemonic | Description |
|---|---|---|
| 100 | PackB | Within for the n^{th} bit in the m^{th} byte |
| | | element: |
| | | For bit dreg[(n*8) + m] = |
| | | s1reg[(m*8) + n] |
| 101 | reserved | |
| 110 | VPackB | S2reg specifies the bit position within |
| | | each byte of sreg for each byte within |
| | | dreg. |
| | | Within for the n^{th} bit in the m^{th} ¼ |
| | | word element: |
| | | For bit dreg[(n*8) + m] = |
| | | s1reg[(m*8) + s2reg[(m*8) + 2:(m*8)]] |
| 111 | reserved | |
| 000 | PackQW_Low | Within for the n^{th} bit in the m^{th} ¼ |
| | | word element: |
| | | For bit dreg[(n*16) + m] = |
| | | s1reg[(m*16) + n] |
| 010 | UnPackQW_Low | Within for the n^{th} bit in the m^{th} ¼ |
| | | word element: |
| | | For bit dreg[(m*16) + n] = |
| | | s1reg[(n*16) + m] |
| 001 | PackQW_High | Within for the n^{th} bit in the m^{th} ¼ |
| | | word element: |
| | | For bit dreg [(n*16) + m] = |
| | | s1reg[(m*16) + n + 8] |
| 011 | UnPackQW_High | Within for the n^{th} bit in the m^{th} ¼ |
| | | word element: |
| | | For bit dreg [(m*16) + n] = |
| | | s1reg[(n*16) + m + 8] |

qw

| Qw[0] | Mnemonic | Description |
|---|---|---|
| 0 | VPackQW | Let sreg[127:0] = |
| | | (s2reg[63:0],s1reg[63:0]) |
| | | S3reg specifies the bit position within |
| | | each QW of sreg for each byte within |
| | | dreg. |
| | | Within for the n^{th} bit in the m^{th} ¼ word |
| | | element: |
| | | For bit dreg[(n*8) + m] = |
| | | sreg[(m*16) + s3reg [(m*8) + 3:(m*8)]] |
| 1 | VUnPackQW | Let sreg[127:0] = |
| | | (s2reg[63:0],s1reg[63:0]) |
| | | S3reg specifies which ½ byte goes into |
| | | each bit postion of each QW of dreg. |
| | | Within for the n^{th} bit in the m^{th} byte |
| | | element: |
| | | For bit dreg[(m*16) + n] = |
| | | sreg[sreg3[(n*8) + 3:(n*8)] + m] |

stop
0 Specifies that an instruction group is not delineated by this instruction.
1 Specifies that an instruction group is delineated by this instruction.
   s1reg Specifies the register that contains the first source operand of the instruction.
   s2reg Specifies the register that contains the second source operand of the instruction.
   s3reg Specifies the register that contains the third source operand of the instruction.
   dreg Specifies the destination register of the instruction.

### Binary Arithmetic Coder Lookup BAC

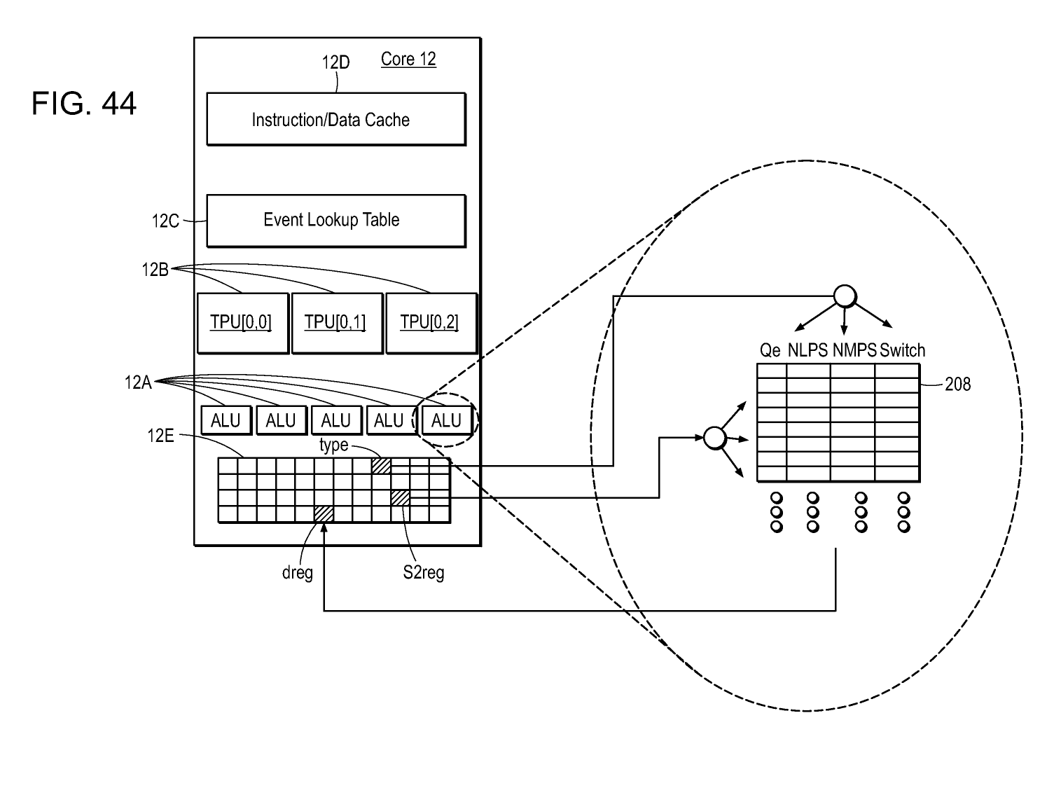

FIG. 44 depicts a core 12 constructed and operated as discussed elsewhere herein in which the functional units 12A, here, referred to as ALUs (arithmetic logic units), execute processor-level instructions (here, referred to as BAC instructions) by storing to register(s) 12E value(s) from a JPEG2000 binary arithmetic coder lookup table.

More particularly, referring to the drawing, the ALUs 12A of the illustrated core 12 execute processor-level instructions, including JPEG2000 binary arithmetic coder table lookup instructions (BAC instructions) that facilitate JPEG2000 encoding and decoding. Such instructions include, in the illustrated embodiment, parameters specifying one or more function values to lookup in such a table 208, as well as values upon which such lookup is based. The ALU responds to such an instruction by loading into a register in 12E (FIG. 44) a value from a JPEG2000 binary arithmetic coder Qe-value and probability estimation lookup table.

In the illustrated embodiment, the lookup table is as specified in Table 7.7 of Tinku Acharya & Ping-Sing Tsai, “JPEG2000 Standard for Image Compression: Concepts, Algorithms and VLSI Architectures”, Wiley, 2005, reprinted in Appendix C hereof. Moreover, the functions are the Qe-value, NMPS, NLPS and SWITCH function values specified in that table. Other embodiments may utilize variants of this table and/or may provide lesser (or additional) functions. A further appreciation of the aforesaid functions may be appreciated by reference to the cited text, the teachings of which are incorporated herein by reference.

The table 208, whether from the cited text or otherwise, may be hardcoded and/or may, itself, be stored in registers. Alternatively or in addition, return values generated by the ALUs on execution of the instruction may be from an algorithmic approximation of such a table.

Logic gates, timing, and the other structural and operational aspects of operation of the ALUs 12E of the illustrated embodiment effecting storage of value(s) from a JPEG2000 binary arithmetic coder lookup table in response to the aforesaid instructions implement the lookup table specified in Table 7.7 of Tinku Acharya & Ping-Sing Tsai, “JPEG2000 Standard for Image Compression: Concepts, Algorithms and VLSI Architectures”, Wiley, 2005, which table is incorporated herein by reference and a copy of which is attached Exhibit D hereto. The ALUs of other embodiments may employ logic gates, timing, and other structural and operational aspects that implement other algorithmic such tables.

A more complete understanding of an instruction for effecting storage of value(s) from a JPEG2000 binary arithmetic coder lookup table according to the illustrated embodiment may be attained by reference to the following specification of instruction syntax and effect:

| 42 | | | | 34 | 27 | 23 | | 20 | 13 | 6 | |
|---|---|---|---|---|---|---|---|---|---|---|---|
| 38 | 37 | 36 | 35 | 28 | 24 | 22 | 21 | 14 | 7 | 1 | 0 |
| 01010 | * | * | 0 | dreg | 1001 | type | 1 | s2reg | 0000100 | predicate | stop |

Format:

| | |
|---|---|
| ps.bac.fs dreg = s2reg {,stop} | register form |

Description: A table lookup, as specified by type, of the value range 0-46 in s2reg is placed into corresponding element of dreg. Returned values for s2reg outside the value range are undefined.

### Operands and Fields:

type

| type | Mnemonic | Description |
|---|---|---|
| 00 | bac.qe | MQ-coder binary arithmetic coder probability function. |
| | | Returns a 16 bit value. See table 7.7 of Tinku Acharya |
| | | & Ping-Sing Tsai, “JPEG2000 Standard for Image |
| | | Compression: Concepts, Algorithms and VLSI |
| | | Architectures”, Wiley, 2005 |
| 01 | bac.nmps | NMPS function. (See Acharya, et al, supra). Returns a |
| | | value between 0-46. |
| 10 | bac.nlps | NLPS function. (See Acharya, et al, supra). Returns a |
| | | value between 0-46. |
| 11 | bac.switch | SWITCH function. (See Acharya, et al, supra). Returns |
| | | 0x0 or 0x1. |

ps The predicate source register in element 12E that specifies whether the instruction is executed. If true the instruction is executed, else if false the instruction is not executed (no side effects).
stop
   0 Specifies that an instruction group is not delineated by this instruction.
   1 Specifies that an instruction group is delineated by this instruction.
S2reg Specifies the register in element 12E that contains the second source operand of the instruction.
dreg Specifies the destination register in element 12E of the instruction.

### Bit Plane Stripe Column Code BPSCCODE

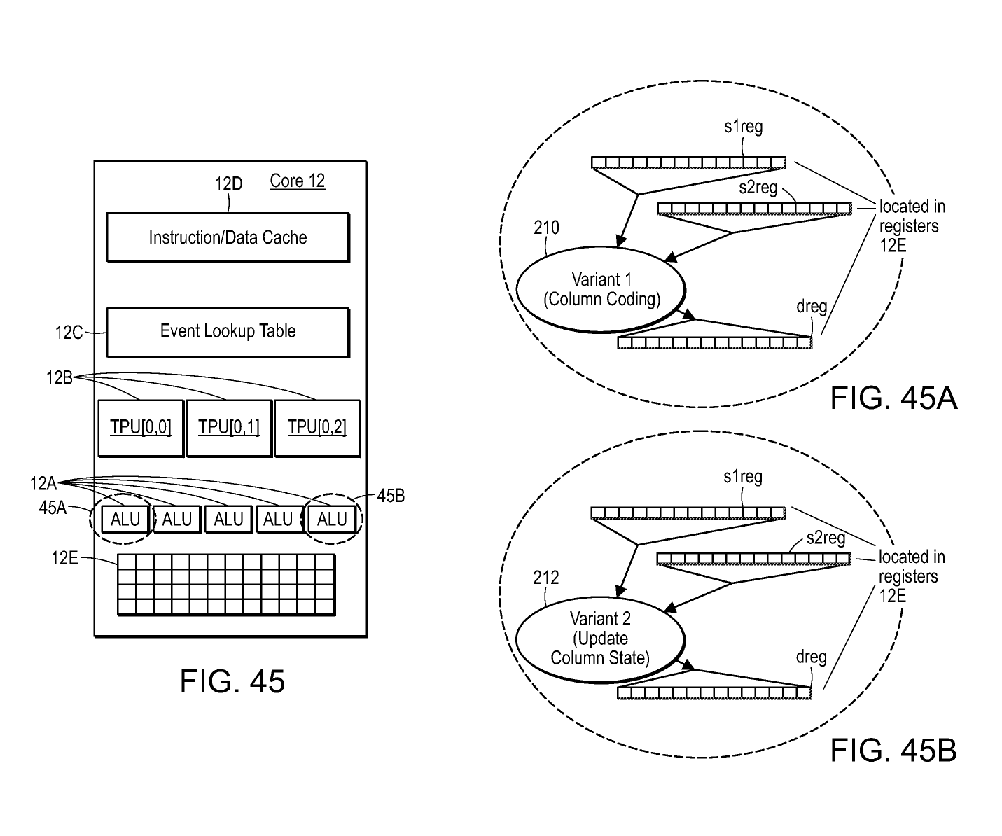

FIG. 45 depicts a core 12 constructed and operated as discussed elsewhere herein in which the functional units 12A, here, referred to as ALUs (arithmetic logic units), execute processor-level instructions (here, referred to as BPSCCODE instructions) by encoding a stripe column of values in registers 12E for bit plane coding within JPEG2000 EBCOT (or, put another way, bit plane coding in accord with the EBCOT scheme). EBCOT stands for “Embedded Block Coding with Optimal Truncation.” Those instructions specify, in the illustrated embodiment, four bits of the column to be coded and the bits immediately adjacent to each of those bits. The instructions further specify the current coding state (here, in three bits) for each of the four column bits to be encoded.

As reflected by element 210 of the drawing, according to one variant of the instruction (as determined by a so-called “cs” parameter), the ALUs 12E of the illustrated embodiment respond to such instructions by generating and storing to a specified register the column coding specified by a “pass” parameter of the instruction. That parameter, which can have values specifying significance propagation pass (SP), a magnitude refinement pass (MR), a cleanup pass, and a combined MR and CP pass, determines the stage of encoding performed by the ALUs 12E in response to the instruction.

As reflected by element 212 of the drawing, according to another variant of the instruction (again, as determined by the “cs” parameter), the ALUs 12E of the illustrated embodiment respond to an instruction as above by alternatively (or in addition) generating and storing to a register updated values of the coding state, e.g., following execution of a specified pass.

Logic gates, timing, and other structural and operational aspects of ALUs 12E of the illustrated embodiment for effecting the encoding of stripe columns in response to the aforesaid instructions implement an algorithmic/methodological approach disclosed in Amit Gupta, Saeid Nooshabadi & David Taubman, “Concurrent Symbol Processing Capable VLSI Architecture for Bit Plane Coder of JPEG2000”, IEICE Trans. Inf. & System, Vol. E88-D, No. 8, August 2005, the teachings of which are incorporated herein by reference, and a copy of which is attached Exhibit D hereto. The ALUs of other embodiments may employ logic gates, timing, and other structural and operational aspects that implement other algorithmic and/or methodological approaches.

A more complete understanding of an instruction for encoding a stripe column for bit plane coding within JPEG2000 EBCOT according to the illustrated embodiment may be attained by reference to the following specification of instruction syntax and effect:

| 42 | 37 | | 34 | 27 | | | 20 | 13 | 6 | |
|---|---|---|---|---|---|---|---|---|---|---|
| 38 | 36 | 35 | 28 | 23 | 22 | 21 | 14 | 7 | 1 | 0 |
| 01010 | pass | 0 | dreg | 11010 | cs | 1 | s2reg | s1reg | predicate | stop |

Format:

| | |
|---|---|
| ps.bpsccode.pass.cs dreg = s1reg, s2reg {,stop} | register form |

Description: Used to encode a 4 bit stripe column for bit plane coding within JPEG2000 EBCOT (Embedded Block Coding with Optimized Truncation). (See Amit Gupta, Saeid Nooshabadi & David Taubman, “Concurrent Symbol Processing Capable VLSI Architecture for Bit Plane Coder of JPEG2000”, IEICE Trans. Inf. & System, Vol. E88-D, No. 8, August 2005). S1reg specifies the 4 bits of the column from registers 12E (FIG. 45) to be coded and the bits immediately adjacent to each of these bits. S2reg specifies the current coding state (3 bits) for each the 4 column bits. Column coding as specified by pass and cs is returned in dreg, a destination in registers 12E.

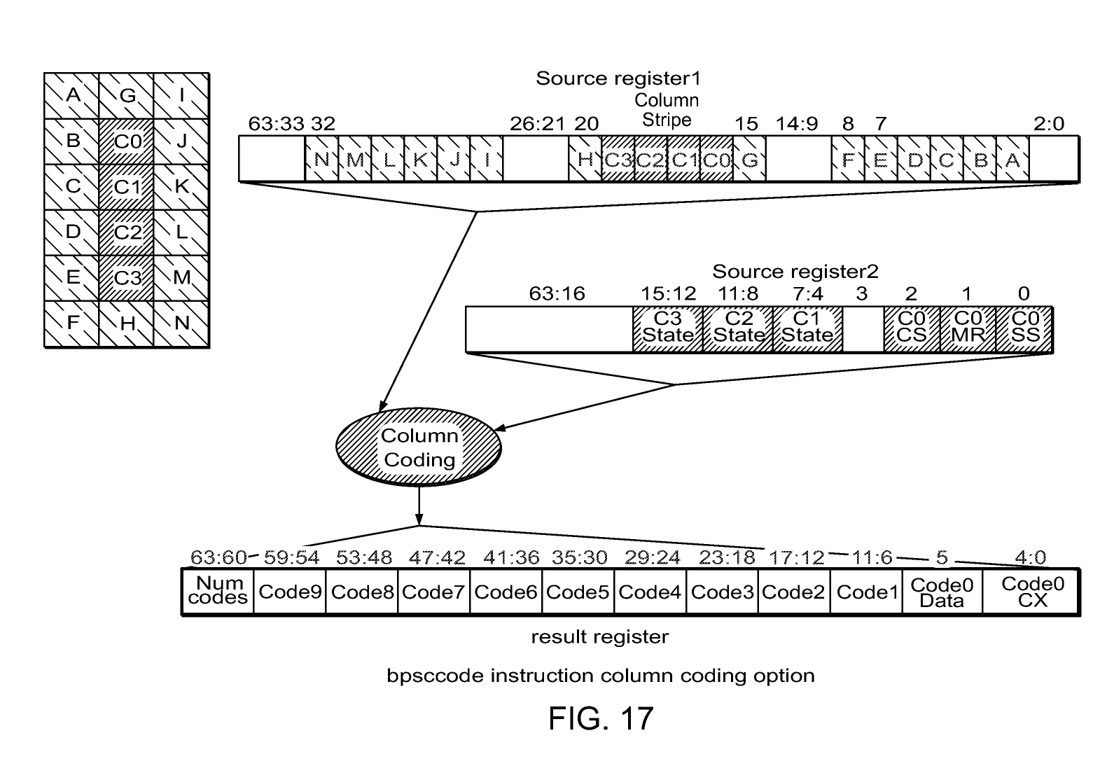

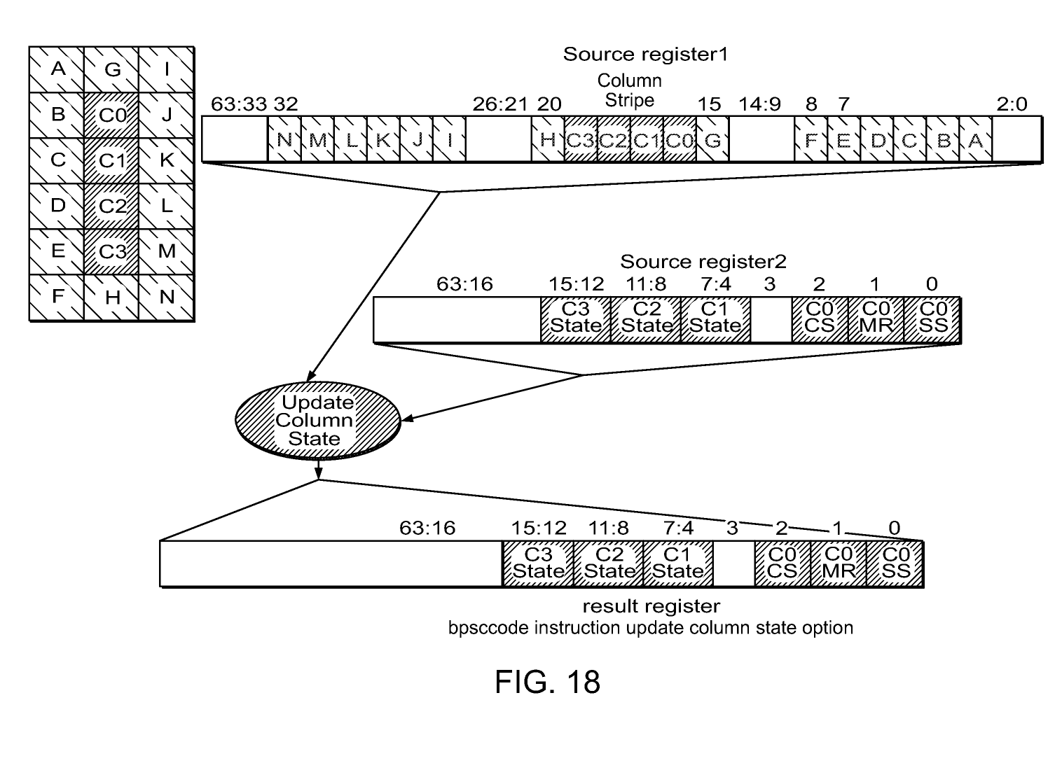

### See FIGS. 17-18

### Operands and Fields:

ps The predicate source register that specifies whether the instruction is executed. If true the instruction is executed, else if false the instruction is not executed (no side effects).
pass
   0 Significance propagation pass (SP)
   1 Magnitude refinement pass (MR)
   2 Cleanup pass (CP)
   3 combined MR and CP
cs
   0 Dreg contains column coding, CS, D pairs.
   1 Dreg contains new value of state bits for column.
stop
   0 Specifies that an instruction group is not delineated by this instruction.
   1 Specifies that an instruction group is delineated by this instruction.
s1reg Specifies the register in element 12E (FIG. 45) in that contains the first source operand of the instruction.
S2reg Specifies the register in element 12E that contains the first source operand of the instruction.
dreg Specifies the destination register in element 12E of the instruction.

### Virtual Memory and Memory System

SEP utilizes a novel Virtual Memory and Memory System architecture to enable high performance, ease of programming, low power and low implementation cost. Aspects include:
64 bit Virtual Address (VA)
64 bit System Address (SA). As we shall see this address has different characteristics than a standard physical address.
Segment model of Virtual Address to System Address translation with a sparsely fill VA or SA.
The VA to SA translation is on a segment basis. The System addresses are then cached in the memory system. So a SA that is present in the memory system has an entry in one of the levels of cache. An SA that is not present in any cache (and the memory system) is then not present in the memory system. Thus the memory system is filled sparsely at the page (and subpage) granularity in a way that is natural to software and OS, without the overhead of page tables on the processor.
All memory is effectively managed as cache, even thought off chip memory utilizes DDR DRAM. The memory system includes two logical levels. The level1 cache, which is divided into separate data and instruction caches for optimal latency and bandwidth. The level2 cache includes an on chip portion and off chip portion referred to as level2 extended. As a whole the level2 cache is the memory system for the individual SEP processor(s) and contributes to a distributed all cache memory system for multiple SEP processors. The multiple processors do not have to be physically sharing the same memory system, chips or buses and could be connected over a network.

Some additional benefits of this architecture are:
Directly supports Distributed Shared:
Memory (DSM)
Files (DSF)
Objects (DSO)
Peer to Peer (DSP2P)
   Scalable cache and memory system architecture
   Segments can easily be shared between threads
   Fast level 1 cache since lookup is in parallel with tag access, no complete virtual to physical address translation or complexity of virtual cache.

### Virtual Memory Overview

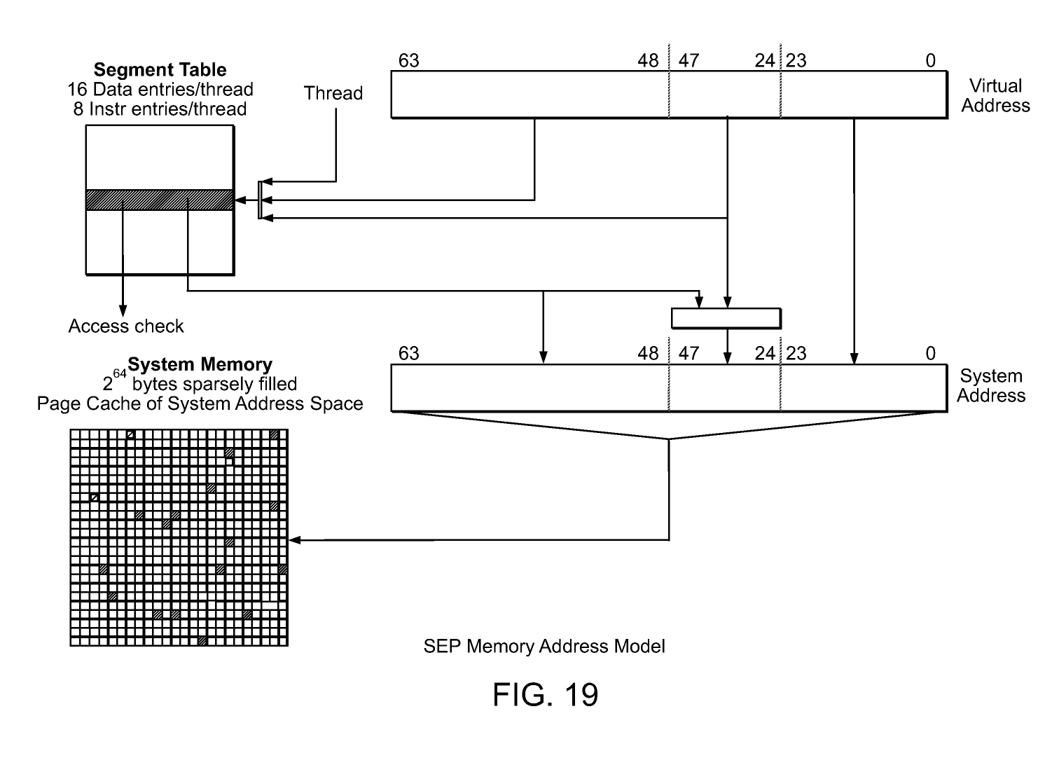

Referring to FIG. 19, virtual address is the 64 bit address constructed by memory reference and branch instructions. The virtual address is translated on a per segment basis to a system address which is used to access all system memory and IO devices. Table 6 specifies system address assignments. Each segment can vary in size from 2²⁴ to 2⁴⁸ bytes.

The virtual address is used to match an entry in the segment table. The matched entry specifies the corresponding system address, segment size and privilege. System memory is a page level cache of the System Address space. Page level control is provided in the cache memory system, rather at address translation time at the processor. The operating system virtual memory subsystem controls System memory on a page basis through L2 Extended Cache (L2E Cache) descriptors. The advantage of this approach is that the performance overhead of processor page tables and page level TLB is avoided.

When the address translation is disabled, the segment table is bypassed and all addresses are truncated to the low 32 bits and require system privilege.

### Cache Memory System Overview

Introduction

With reference to FIG. 20, the data and instruction caches of cores 12-16 the illustrated embodiment are organized as shown. L1 data and instruction caches are both 8-way associative. Each 128 byte block has a corresponding entry. This entry describes the system address of the block, the current l1 cache state, whether the block has been modified with respect to the l2 cache and whether the block has been referenced. The modified bit is set on each store to the block. The referenced bit is set by each memory reference to the block, unless the reuse hint indicates no reuse. The no-reuse hint allows the program to access memory locations once, without them displacing other cache blocks that will be reused. The referenced bit is periodically cleared by the L2 cache controller to implement a level 1 cache working set algorithm. The modified bit is clear when the L2 cache control updates its data with the modified data in the block.

The level2 cache consists of an on-chip and off chip extended L2 Cache (L2E). The on-chip L2 cache, which may be self-contained on respective core, distributed among multiple cores, and/or contained (in whole or in part) on DDRAM on a “gateway” (or “IO bridge”) interconnects to other processors (e.g., of types other than those shown and discussed here) and/or systems, consists of the tag and data portions. Each 128 byte data block is described by a corresponding descriptor within the tag portion. The descriptor keeps track of cache state, whether the block has been modified with respect to L2E, whether the block is present in L1 cache, an LRU count to keep how often the block is being used by L1 and tag mode.

The off-chip DDR dram memory is called L2E Cache because it acts as an extension to the L2 cache. The L2E Cache may contained within a single device (e.g., a memory board with an integral controller (e.g., a DDR3 controller) or distributed among multiple devices associated with the respective cores or otherwise. Storage within the L2E cache is allocated on a page basis and data is transferred between L2 and L2E on a block basis. The mapping of System Address to a particular L2E page is specified by an L2E descriptor. These descriptors are stored within fixed locations in the System Address space and in external ddr2 dram. The L2E descriptor specifies the location with system memory or physical memory (e.g., an attached flash drive or other mounted storage device) that the corresponding page is stored. The operating system is responsible for initializing and maintaining these descriptors as part of the virtual memory subsystem of the OS. As a whole, the L2E descriptors specify the sparse pages of System Address space that are present (cached) in physical memory. If a page and corresponding L2E descriptor is not present in, then a page fault exception is signaled.

The L2 cache references the L2E descriptors to search for a specific system address, to satisfy a L2 miss. Utilizing the organization of L2E descriptors the L2 cache is required to access 3 blocks to access the referenced block, 2 blocks to traverse the descriptor tree and 1 block for the actual data. In order to optimize performance the L2 cache, caches the most recently used descriptors. Thus the L2E descriptor can most likely be referenced by the L2 directly and only a single L2E reference is required to load the corresponding block.

L2E descriptors are stored within the data portion of a L2 block as shown in FIG. 85. The tag-mode bit within an L2 descriptor within the tag indicates that the data portion consists of 16 tags for Extended L2 Cache. The portion of the L2 cache which is used to cache L2E descriptors is set by OS and is normally set to one cache group, or 256 blocks for a 0.5 m L2 Cache. This configuration results descriptors corresponding to 212 L2E pages being cached, this is equivalent to 256 Mbytes.

Although shown in use in connection with like processor modules (e.g., of the type detailed elsewhere herein), it will be appreciated that caching structures, systems and/or mechanisms according to the invention practiced with other processor modules, memory systems and/or storage systems, e.g., as illustrated FIG. 31.

Advantages of embodiments utilizing caching of the type described herein are
Caching of in memory directory
Eliminating translation lookahead buffer (TLB) & TLB overhead at processor
Single sparse address space enables single level store
Encompassing dram, flash & cache as single optimized memory system
Providing distributed coherence & working set management
Affording Transparent state management
Accelerating performance and lowing power by dynamically keeping data close to where it is needed and being able to utilize lower cost denser storage technologies.

Cache Memory System Continued

Level 1 caches are organized as separate level 1 instruction cache and level 1 data cache to maximize instruction and data bandwidth. Both level1 caches are proper subsets of level2 cache. The overall SEP memory organization is shown in FIG. 20. This organization is parameterized within the implementation and is scalable in future designs.

The L1 data and instruction caches are both 8 way associative. Each 128 byte block has a corresponding entry. This entry describes the system address of the block, the current L1 cache state, whether the block has been modified with respect to the L2 cache and whether the block has been referenced. The modified bit is set on each store to the block. The referenced bit is set by each memory reference to the block, unless the reuse hint indicates no reuse. The no-reuse hint allows the program to access memory locations once, without them displacing other cache blocks that will be reused. The referenced bit is periodically cleared by the L2 cache controller to implement a level 1 cache working set algorithm. The modified bit is clear when the L2 cache control updates its data with the modified data in the block.

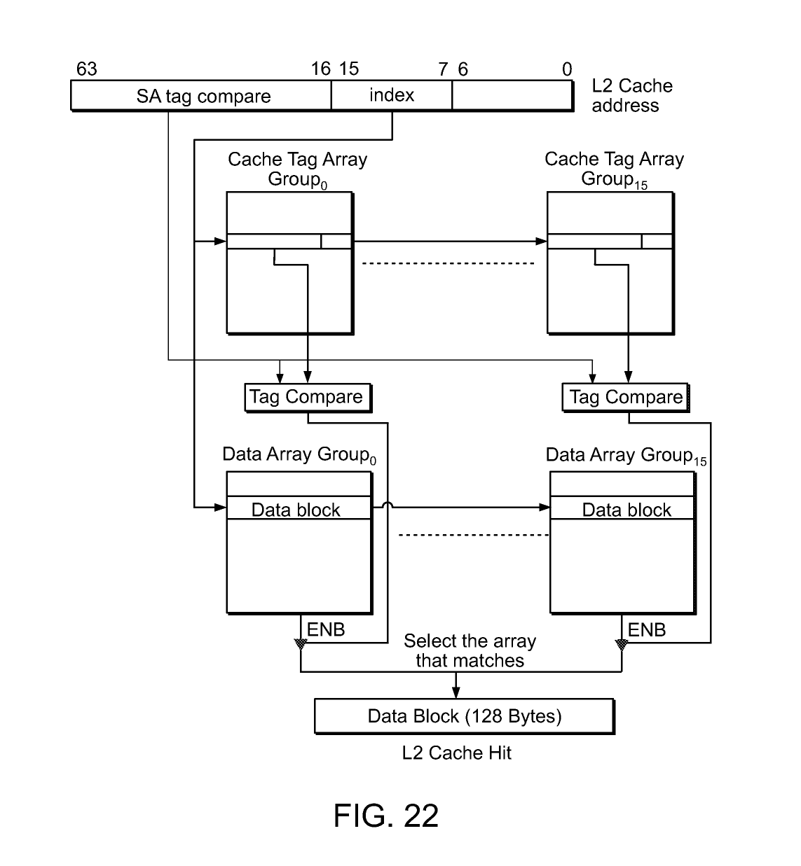

The level2 cache includes an on-chip and off chip extended L2 Cache (L2E). The on-chip L2 cache includes the tag and data portions. Each 128 byte data block is described by a corresponding descriptor within the tag portion. The descriptor keeps track of cache state, whether the block has been modified with respect to L2E, whether the block is present in L1 cache, an LRU count to keep how often the block is being used by L1 and tag mode. The organization of the L2 cache is shown in FIG. 22.

The off chip DDR DRAM memory is called L2E Cache because it acts as an extension to the L2 cache. Storage within the L2E cache is allocated on a page basis and data is transferred between L2 and L2E on a block basis. The mapping of System Address to a particular L2E page is specified by an L2E descriptor. These descriptors are stored within fixed locations in the System Address space and in external ddr2 dram. The L2E descriptor specifies the location within offchip L2E DDR DRAM that the corresponding page is stored. The operating system is responsible for initializing and maintaining these descriptors as part of the virtual memory subsystem of the OS. As a whole, the L2E descriptors specify the sparse pages of System Address space that are present (cached) in physical memory. If a page and corresponding L2E descriptor is not present in, then a page fault exception is signaled.

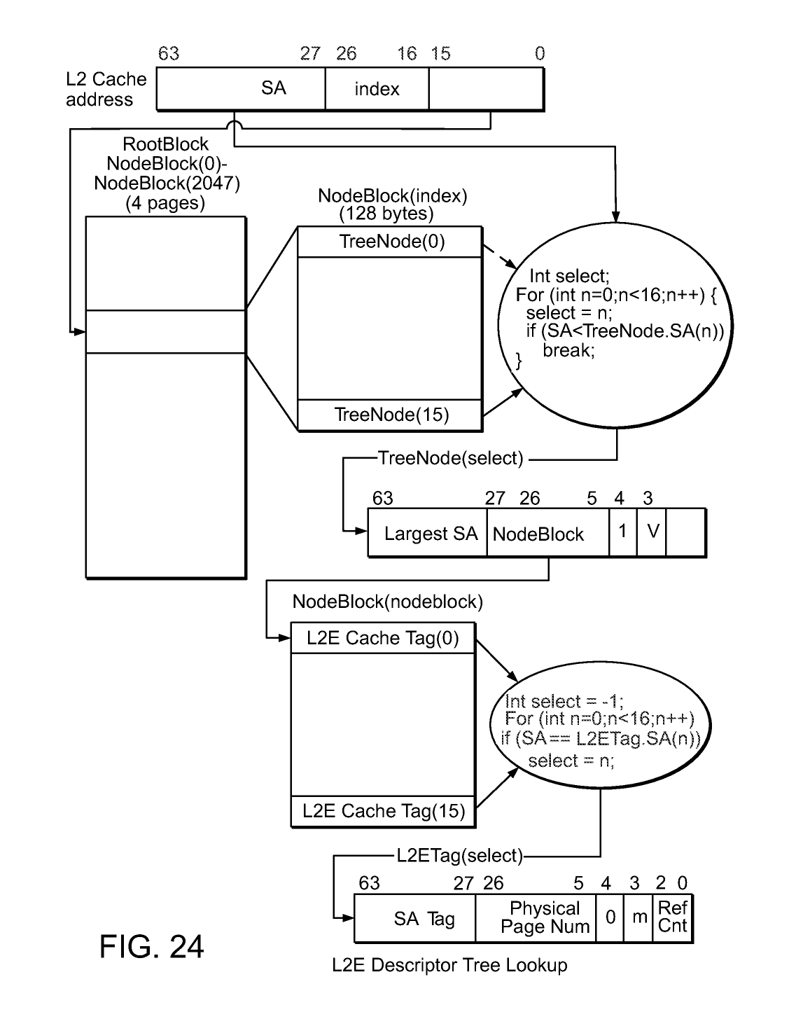

L2E descriptors are organized as a tree as shown in FIG. 24.

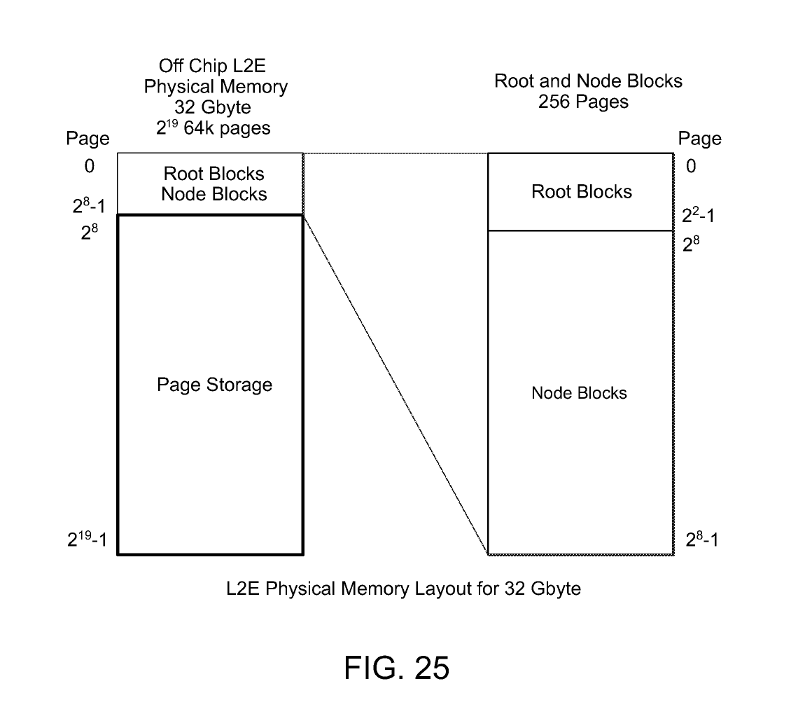

FIG. 25 depicts an L2E physical memory layout in a system according to the invention; The L2 cache references the L2E descriptors to search for a specific system address, to satisfy a L2 miss. Utilizing the organization of L2E descriptors the L2 cache is required to access 3 blocks to access the referenced block, 2 blocks to traverse the descriptor tree and 1 block for the actual data. In order to optimize performance the L2 cache, caches the most recently used descriptors. Thus the L2E descriptor can most likely be referenced by the L2 directly and only a single L2E reference is required to load the corresponding block.

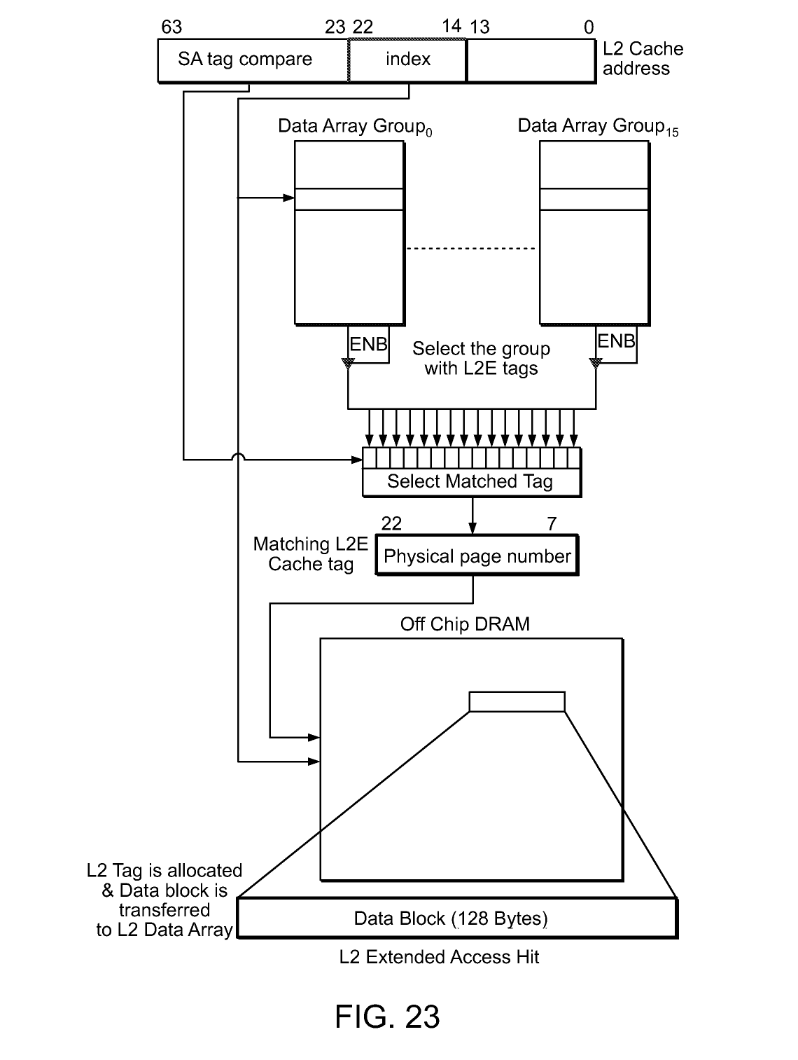

L2E descriptors are stored within the data portion of a L2 block as shown in FIG. 23. The tag-mode bit within an L2 descriptor within the tag indicates that the data portion includes 16 tags for Extended L2 Cache. The portion of the L2 cache which is used to cache L2E descriptors is set by OS and is normally set to one cache group (SEP implementations are not required to support caching L2E descriptors in all cache groups. A minimum of 1 cache group is required), or 256 blocks for a 0.5 m L2 Cache. This configuration results descriptors corresponding to 2¹² L2E pages being cached, this is equivalent to 256 Mbytes.

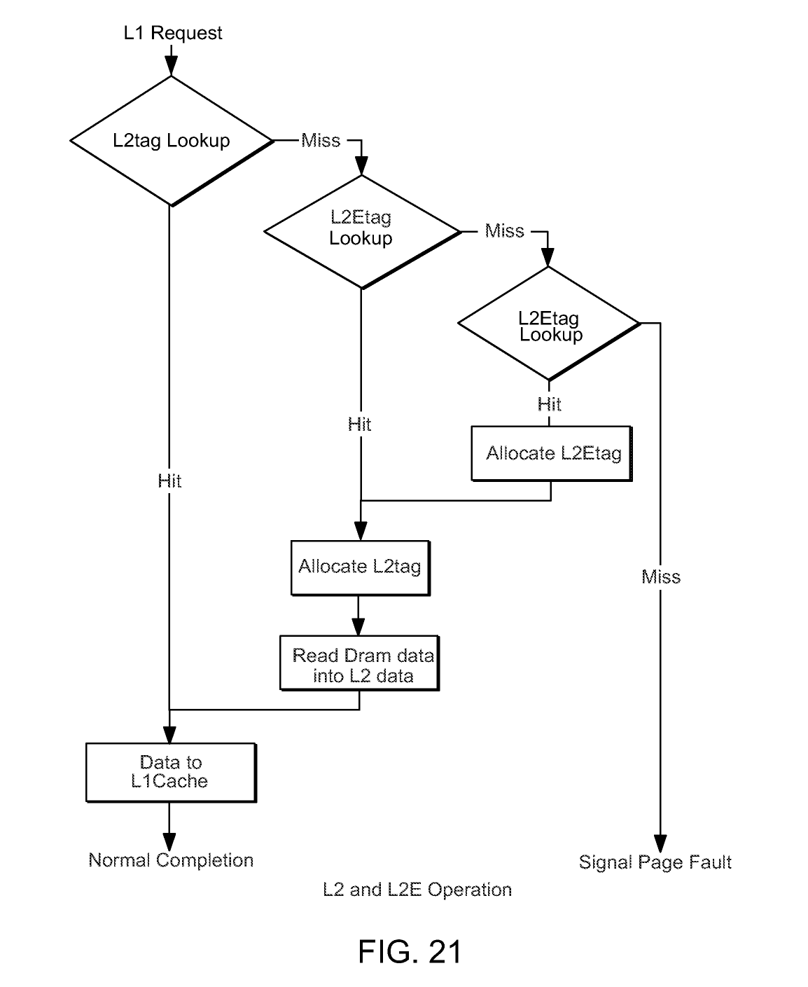

FIG. 21 illustrates overall flow of L2 and L2E operation. Psuedo-code summary of L2 and L2E cache operation:

```
L2_tag_lookup;
if (L2_tag_miss) {
        L2E_tag_lookup;
        if (L2E_tag_miss) {
            L2E_descriptor_tree_lookup;
            if (descriptor_not_present) {
                signal_page_fault;
                break;
            } else allocate_L2E_tag;
        }
        allocate_L2_tag;
        load_dram_data_into_l2
}
respond_data_to_l1_cache;
```

### Translation Table Organization and Entry Description

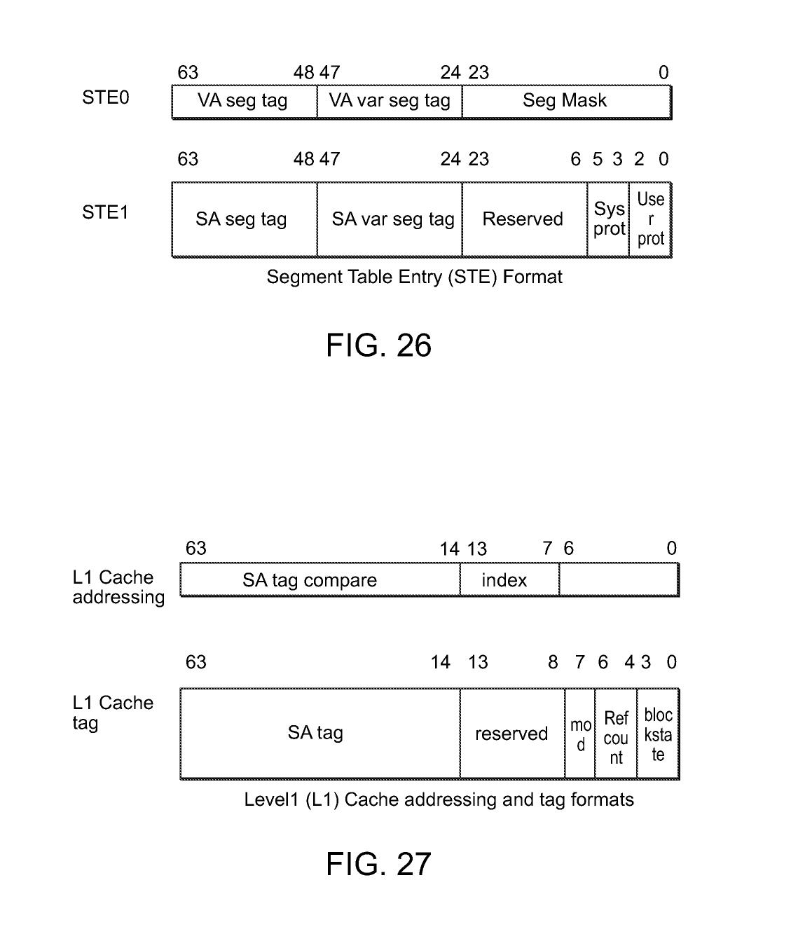

FIG. 26 depicts a segment table entry format in an SEP system according to one practice of the invention.

### Cache Organization and Entry Description

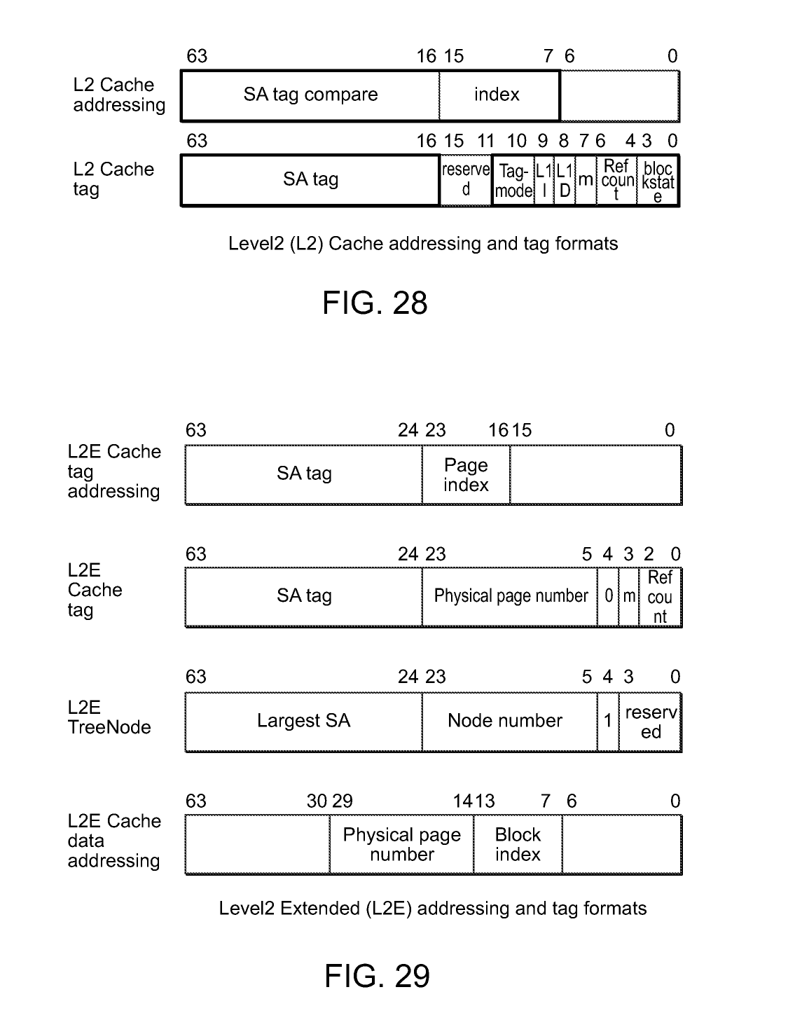

FIGS. 27-29 depict, respectively, L1, L2 and L2E Cache addressing and tag formats in an SEP system according to one practice of the invention.

The Ref (Referenced) count field is utilized to keep track of how often an L2 block is referenced by the L1 cache (and processor). The count is incremented when a block is move into L1. It can be used likewise in the L2E cache (vis-a-vis movement to the L2 cache) and the L1 cache (vis-a-vis references by the functional units of the local core or of a remote core).

In the illustrated embodiment, the functional or execution units, e.g., 12A-16A within the cores, e.g., 12-16, execute memory reference instructions that influence the setting of reference counts within the cache and which, thereby, influence cache management including replacement and modified block writeback. Thus, for example, the reference count set in connection with a typical or normal memory access by an execution unit is set to a middle value (e.g., in the example below, the value 3) when the corresponding entry (e.g., data or instruction) is brought into cache. As each entry in the cache is referenced, the reference count is incremented. In the background the cache scans and decrements reference counts on a periodic basis. As new data/instructions are brought into cache, the cache subsystem determines which of the already-cached entries to remove based on their corresponding reference counts (i.e., entries with lower reference counts are removed first).

The functional or execution units, e.g., 12A, of the illustrated cores, e.g., 12, can selectively force the reference counts of newly accessed data/instructions to be purposely set to low values, thereby, insuring that the corresponding cache entries will be the next ones to be replaced and will not supplant other cache entries needed longer term. To this end, the illustrated cores, e.g., 12, support an instruction set in which at least some of the memory access instructions include parameters (e.g., the “no-reuse cache hint”) for influencing the reference counts accordingly.

In the illustrated embodiment, the setting and adjusting of reference counts—which, themselves, are maintained along with descriptors of the respective data in the so-called tag portions (as opposed to the so-called data portions) or the respective caches—is automatically carried out by logic within the cache subsystem, thus, freeing the functional units, e.g., 12A-16A, from having to set or adjust those counts themselves. Put another way, in the illustrated embodiment, execution of memory reference instructions (e.g., with or without the no-reuse hint) by the functional or execution units, e.g., 12A-16A, causes the caches (and, particularly, for example, the local L2 and L2E caches) to perform operations (e.g., the setting and adjustment of reference counts in accord with the teachings hereof) on behalf of the issuing thread. On multicore systems these operations can span to non-local level2 and level2 extended caches.

The aforementioned mechanisms can also be utilized, in whole or part, to facilitate cache-initiated performance optimization, e.g., independently of memory access instructions executed by the processor. Thus, for example, the reference counts for data newly brought into the respective caches can be set (or, if already set, subsequently adjusted) in accord with (a) the access rights of the acquiring cache, and (b) the nature of utilization of such data by the processor modules—local or remote.

By way of example, where a read-only datum brought into a cache is expected to be frequently updated on a remote cache (e.g., by a processing node with write rights), the acquiring cache can set the reference count low, thereby, insuring that (unless that datum is access frequently by the acquiring cache) the corresponding cache entry will be replaced, obviating the need for needless updates from the remote cache. Such setting of the reference count can be effected via memory access instructions parameters (as above) and/or “cache initiated” via automatic operation of the caching subsystems (and/or cooperating mechanisms in the operation system).

By way of further example, where a write-only datum maintained in a cache is not shared on a read-only (or other) basis in any other cache, the caching subsystems (and/or cooperating mechanisms in the operation system) can delay or suspend entirely signalling to the other caches or memory system of updates to that datum, at least, until the processor associated with the maintaining cache has stopped using the datum.

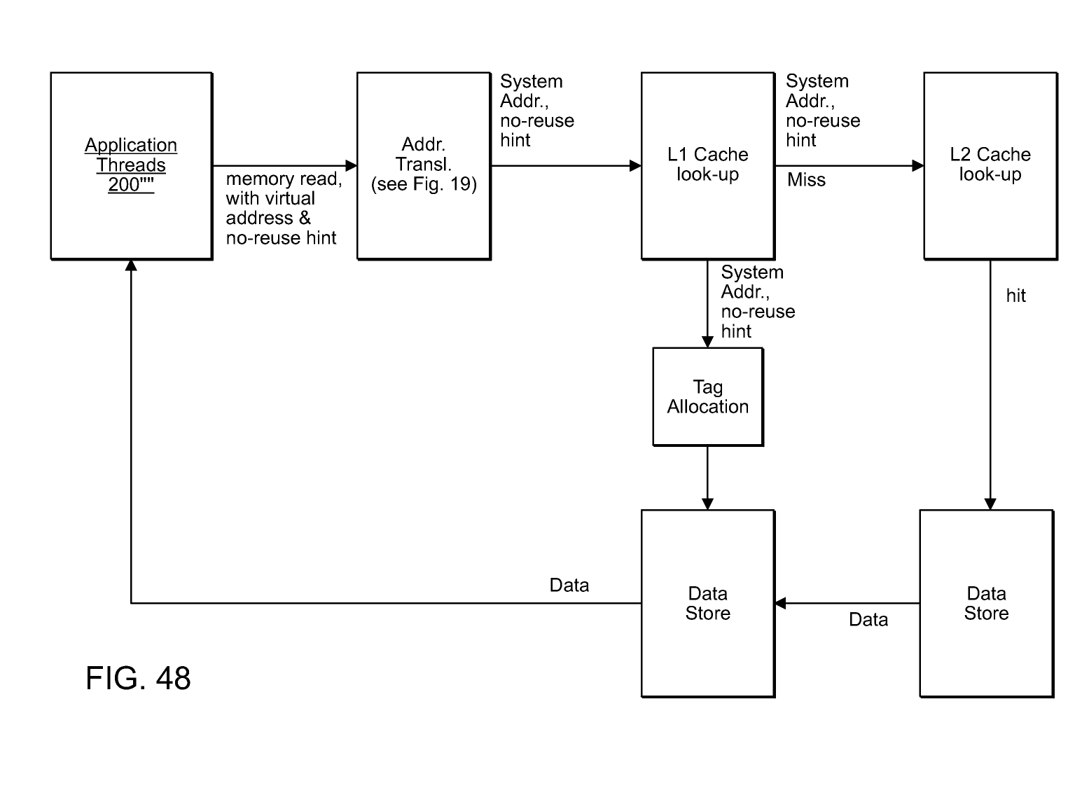

The foregoing can be further appreciated with reference to FIG. 47, showing the effect on the L1 data cache, by way of non-limiting example, of execution of a memory “read” operation sans the no-reuse hint (or, put another way, with the re-use parameter set to “true”) by application, e.g., 200 (and, more precisely, threads thereof, labelled 200″″) on core 12. Particularly, the virtual address of the data being read, as specified by the thread 200″″, is converted to a system address, e.g., in the manner shown in FIG. 19, by way of non-limiting example, and discussed elsewhere herein.

If the requested datum is in the L1 Data cache, an L1 Cache lookup and, more specifically, a lookup comparing that system address against the tag portion of the L1 data cache (e.g., in the manner paralleling that shown in FIG. 22 vis-a-vis the L2 Data cache) results in a hit that returns the requested block, page, etc. (depending on implementation) to the requesting thread. As shown in the right-hand corner of FIG. 47, the reference count maintained in the descriptor of the found data is incremented in connection with the read operation.

On a periodic basis the reference count is decremented if it is still present in L1 (e.g., assuming it has not been accessed by another memory access operation). The blocks with the highest reference counts have the highest current temporal locality within L2 cache. The blocks with the lowest reference counts have been accessed the least in the near past and are targeted as replacement blocks to service L2 misses, i.e., the bringing in of new blocks from L2E cache. In the illustrated embodiment, the ref count for a block is normally initialized to a middling value of 3 (by way of non-limiting example), when the block is brought in from L2E cache. Of course, other embodiments may vary not only as to the start values of these counts, but also in the amount and timing of increases and decreases to them.

As noted above, setting of the referenced bit can be influenced programmatically, e.g., by application 200″″, e.g., when it uses memory access instructions that have a no-reuse hint that indicates “no reuse” (or, put another way, a reuse parameter set to “false”), i.e., that the referenced data block will not be reused (e.g., in the near term) by the thread. For example, in the illustrated embodiment, if the block is brought into a cache (e.g., the L1 or L2 caches) by a memory reference instruction that specifies no-reuse, the ref count is initialized to a value of 2 (instead of 3 per the normal case discussed above)—and, by way of further example, if that block is already in cache, its reference count is not incremented as a result of execution of the instruction (or, indeed, can be reduced to, say, that start value of 2 as a result of such execution). Again, of course, other embodiments may vary in regard to these start values and/or in setting or timing of changes in the reference count as a result of execution of a memory access instruction with the no-reuse hint.

This can be further appreciated with reference to FIG. 48, which parallels FIG. 47 insofar as it, too, shows the effect on the data caches (here, the L1 and L2 caches), by way of non-limiting example, of execution of a memory “read” operation that includes a no-reuse hint by application thread 200″″ on core 12. As above, the virtual address of the data requested, as specified by the thread 200″″, is converted to a system address, e.g., in the manner shown in FIG. 19, by way of non-limiting example, and discussed elsewhere herein.

If the requested datum is in the L1 Data cache (which is not the case shown here), it is returned to the requesting program 200″″, but the reference count for its descriptor is not updated in the cache (because of the no-reuse hint)—and, indeed, in some embodiments, if it is greater than the default initialization value for a no-reuse request, it may be set to that value, here, 2).

If the requested datum is not in the L1 Data cache (as shown here), that cache signals a miss and passes the request to the L2 Data cache. If the requested datum is in the L2 Data cache, an L2 Cache lookup and, more specifically, a lookup comparing that system address against the tag portion of the L2 data cache (e.g., in the manner shown in FIG. 22) results in a hit that returns the requested block, page, etc. (depending on implementation) to the L1 Data cache, which allocates a descriptor for that data and which (because of the no-reuse hint) sets its reference count to the default initialization value for a no-reuse request, it may be set to that value, here, 2). The L1 Data cache can, in turn, pass the requested datum back to the requesting thread.

It will be appreciated that the operations shown in FIGS. 47 and 48, though, shown and discussed here for simplicity with respect to read operations involving two levels of cache (L1 and L2) can likewise be extended to additional levels of cache (e.g., L2E) and to other memory operations, as well, e.g., write operations. In the illustrated embodiment, other such operations can include, by way of non-limiting example, the following memory access instructions (and their respective reuse/no-reuse cache hints), e.g., among others: LOAD (Load Register), STORE (Store to Memory), LOADPAIR (Load Register Pair), STOREPAIR (Store Pair to Memory), PREFETCH (Prefetch Memory), LOADPRED (Load Predicate Register), STOREPRED (Store Predicate Register), EMPTY (Empty Memory), and FILL (Fill Memory) instructions. Other embodiments may provide other instructions, instead or instead or in addition, that utilize such parameters or that otherwise provide for influencing reference counts, e.g., in accord with the principles hereof.

TABLE 5
Level2 (L2) and Level2 Extended (L2E) block state

| Nmeumonic | Value | Description |
|---|---|---|
| Invalid | 000 | Invalid |
| reserved | 001 | reserved |
| c_empty_ro | 010 | Copy, Empty, read only |
| c_full_ro | 011 | Copy, Full, read only |
| o_empty_ro | 100 | Owner, Empty, Read Only |
| o_empty_rw | 101 | Owner, Empty, Read/Write |
| o_full_ro | 110 | Owner, Full, Read Only |
| o_full_rw | 111 | Owner Full, Read/Write |

Level2 Extended (L2E) Cache tags are addressed in a indexed, set associative manner. L2E data can be placed at arbitrary locations in off-chip memory.

### Addressing

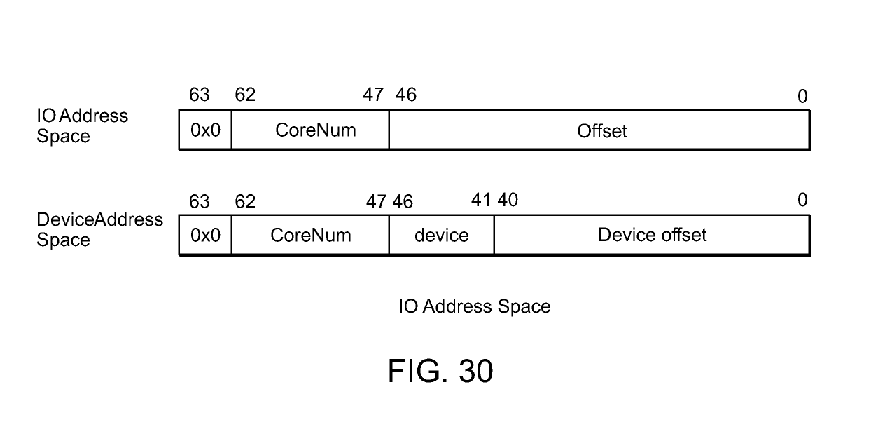

FIG. 30 depicts an IO address space format in an SEP system according to one practice of the invention.

TABLE 6
System Address Ranges

| Range | Description |
|---|---|
| 0x0000000000000000-0x0fffffffffffffff | IO Devices |
| 0x1000000000000000-0xffffffffffffffff | Cache Memory |

TABLE 7
IO Address Space Ranges

| Device (SA[46:41]) | Description |
|---|---|
| 0x00 | Flash memory |
| 0x01-0x3f | IO Device 1-63 |

TABLE 8
Exception target address

| Address | Description |
|---|---|
| 0x0000000000000000 | System privilege exception address |
| 0x0000000001000000 | Application privilege exception |
| | address |

### Standard Device Registers

IO devices include standard device registers and device specific registers. Standard device registers are described in the next sections.

### Device Type Register

| 63 | 31 | 15 |
|---|---|---|
| 16 | 16 | 0 |
| device specific | revision | device type |

Identifies the type of device. Enables devices to be dynamically configured by software reading the type register first. Cores provide a device type of 0x0000 for all null devices.

| Bit | Field | Description | type |
|---|---|---|---|
| 15:0 | device type | Value indentifies the type of device. | read-only |
| | | Value Description | |
| | | 0x0000Null device | |
| | | 0x0001L2 and L2E memory controller | |
| | | 0x0002Event Table | |
| | | 0x0003DRAM Memory | |
| | | 0x0004DMA Controller | |
| | | 0x0005FPGA-Ethernet | |
| | | 0x0006FPGA-DVI | |
| | | 0x0007HDMI | |
| | | 0x0008LCD Interface | |
| | | 0x0009PCI | |
| | | 0x000aATA | |
| | | 0x000b USB2 | |
| | | 0x000c 1394 | |
| | | 0x000d Ethernet | |
| | | 0x000eFlash memory | |
| | | 0x000f Audio out | |
| | | 0x0010Power Management | |
| | | 0x0011-0xffff Reserved | |
| 31:16 | revision | Value indentifies device revision | read-only |
| 63:32 | device | Additional device specific information | read-only |
| | specific | | |

### IO Devices

For each IO device the functionality, address map and detailed register description are provided.

### Event Table

TABLE 9
Event Table Addressing

| Device Offset | Register |
|---|---|
| 0x00000000-0x0000ffff | Device type register |
| 0x00010000-0x0001ffff | Event Queue Register |
| 0x00020000-0x0002ffff | Event Queue Operation Register |
| 0x00030000-0x0003ffff | Event-Thread Lookup Register |
| 0x00040000-0xffffffff | Reserved |

Event Queue Register

| 63 | 15 |
|---|---|
| 16 | 0 |
| reserved | event |

The Event Queue Register (EQR) enables read and write access to the event queue. The Event Queue location is specified by bits[15:0] of the device offset of IO address. First implementation contains 16 locations.

| Bit | Field | Description | Privilege | Per |
|---|---|---|---|---|
| 15:0 | event | For writes specifies the virtual event | system | proc |
| | | number written or pushed onto the | | |
| | | queue. For read operations contains | | |
| | | the event number read from the queue | | |
| 63:1 | Reserved | Reserved for future expansion | System | proc |
| 6 | | of virtual event number | | |

Event Queue Operation Register

| 63 | | |
|---|---|---|
| 17 | 16 | 15 0 |
| | empty | event |

The Event Queue Operation Register (EQR) enables an event to be pushed onto or popped from the event queue. Store to EQR is used for push and load from EQR is used for pop.

| Bit | Field | Description | Privilege | Per |
|---|---|---|---|---|
| 15:0 | event | For writes specifies the event | system | proc |
| | | number written or pushed onto | | |
| | | the queue. For read operations | | |
| | | contains the event number | | |
| | | read from the queue | | |
| 16 | empty | For pop operation indicates | proc | |
| | | whether the system queue | | |
| | | was empty prior to the current | | |
| | | operation. If the queue was | | |
| | | empty for pop operation, the event | | |
| | | field is undefined. For push | | |
| | | operation indicates whether the | | |
| | | queue was full prior to the push | | |
| | | operation. If the queue was full | | |
| | | for the push operation, the | | |
| | | push operation is not completed. | | |

Event-Thread Lookup Table Register

| 63 | | |
|---|---|---|
| 41 | 31 16 | 15 0 |
| | thread | event |

The Event to Thread lookup table establishes a mapping between an event number presented by a hardware device or event instruction and the preferred thread to signal the event to. Each entry in the table specifies an event number and a corresponding virtual thread number that the event is mapped to. In the case where the virtual thread number is not loaded into a TPU, or the event mapping is not present, the event is then signaled to the default system thread. See “Generalized Events and Multi-Threading,” hereof, for further description.

The Event-Thread Lookup location is specified by bits[15:0] of the device offset of IO address. First implementation contains 16 locations.

| Bit | Field | Description | Privilege | Per |
|---|---|---|---|---|
| 15:0 | event | For writes specifies the event number | system | proc |
| | | written at the specified table address. For | | |
| | | read operations contains the event number | | |
| | | at the specified table address | | |
| 31:1 | thread | Specifies virual thread number | System | proc |
| 6 | | corresponding to event | | |

### L2 and L2E Memory Controller

TABLE 10
L2 and L2E Memory Controller

| Device Offset | Register |
|---|---|
| 0x00000000-0x0000ffff | Device type register |
| 0x00010000-0x00ffffff | Reserved |
| 0x01000000-0x01ffffff | L2 Tag |
| 0x02000000-0x02ffffff | L2E Tag and Data |
| 0x03000000-0xffffffff | Reserved |

### Power Management

SEP utilizes several types of power management:
SEP processor instruction scheduler puts units that are not required during a given cycle in a low power state.
IO controllers can be disabled if not being used
Overall Power Management includes the following states
   Off—All chip voltages are zero
   Full on—A chip voltages and subsystems are enabled
   Idle—Processor enters a low power state when all threads are in WAITING_IO state
   Sleep—Clock timer, some other misc registers and auto-dram refresh are enabled. All other subsystems are in a low power state.

### Example Memory System Operations

### Adding the Removing Segments

SEP utilizes variable size segments to provide address translation (and privilege) from the Virtual to System address spaces. Specification of a segment does not in itself allocate system memory within the System Address space. Allocation and deallocation of system memory is on a page basis as described in the next section.

Segments can be viewed as mapped memory space for code, heap, files, etc.

Segments are defined on a per-thread basis. Segments are added enabling an instruction or data segment table entry for the corresponding process. These are managed explicitly by software running at system privilege. The segment table entry defines the access rights for the corresponding thread for the segment. Virtual to System address mapping for the segment can be defined arbitrary at the size boundry.

A segment is removed by disabling the corresponding segment table entry.

### Allocating and Deallocating Pages

Pages are allocated on a system wide basis. Access privilege to a page is defined by the segment table entry corresponding to the page system address. By managing pages on a system shared basis, coherency is automatically maintained by the memory system for page descriptors and page contents. Since SEP manages all memory and corresponding pages as cache, pages are allocated and deallocated at the shared memory system, rather than per thread.

Valid pages and the location where they are stored in memory are described by the in memory hash table shown in FIG. 86, L2E Descriptor Tree Lookup. For a specific index the descriptor tree can be 1, 2 or 3 levels. The root block starts are 0 offset. System software can create a segment that maps virtual to system at 0x0 and create page descriptors that directly map to the address space so that this memory is within the kernel address space.

Pages are allocated by setting up the corresponding NodeBlock, TreeNode and L2E Cache Tage. The TreeNode describes the largest SA within the NodeBlocks that it points to. The TreeNodes are arranged within a NodeBlock in increasing SA order. The physical page number specifies the storage location in dram for the page. This is effectively a b-tree organization.

Pages are deallocated by marking the entries invalid.

### Memory System Implementation

Referring to FIG. 31, the memory system implementation of the illustrated SEP architecture enables an all-cache memory system which is transparently scalable across cores and threads. The memory system implementation includes:
Ring Interconnect (RI) provides packet transport for cache memory system operations. Each device includes a RI port. Such a ring interconnect can be constructed, operated, and utilized in the manner of the “cell interconnect” disclosed, by way of non-limiting example, as elements 10-13, in FIG. 1 and the accompanying text of U.S. Pat. No. 5,119,481, entitled “Register Bus Multiprocessor System with Shift,” and further details of which are disclosed, by way of non-limiting example, in FIGS. 3-8 and the accompanying text of that patent, the teachings of which are incorporated herein by reference, and a copy of which is filed herewith by example as Appendix B, as adapted in accord with the teachings hereof.
External Memory Cache Controller provides interface between the RI and external DDR3 dram and flash memory.
Level2 Cache Controller provides interface between the RI and processor core.
IO Bridge provides a DMA and programmed IO interface between the RI and IO busses and devices.

The illustrated memory system is advantageous, e.g., in that it can serve to combine high bandwidth technology with bandwidth efficiency, and in that it scales across cores and/or other processing modules (and/or respective SOCs or systems in which they may respectively be embodied) and external memory (DRAM & flash)

### Ring Interconnect (Ri) General Operation

RI provides a classic layered communication approach:
Caching protocol—provides integrated coherency for all-cache memory system including support for events
Packet contents—Payload consisting of data, address, command, state and signalling
Physical transport—Mapping to signals. Implementations can have different levels of parallelism and bandwidth

### Packet Contents

Packet includes the following fields:
SystemAddress [63:7]—Block address corresponding the data transfer or request. All transfers are in units of a single 128 byte block.
RequestorID [31:0]—RI interface number of requestor. ReqID [2:0] implemented in first implementation, remainder reserved. The value of each RI is hardwired as part of the RI interface implementation.
Command

| | | State | |
|---|---|---|---|
| Value | Command | Field | Data |
| 0x0 | Nop | Invalid | invalid |
| 0x1 | Read only request | Invalid | invalid |
| 0x2 | Writable read request | Invalid | invalid |
| 0x3 | Exclusive read request | Invalid | invalid |
| 0x4 | Invalidate | Invalid | invalid |
| 0x5 | Update | Invalid | valid |
| 0x6 | Response ro request | Valid | valid |
| 0x7 | Response writeable request | Valid | Valid |
| 0x8 | Response exclusive request | Valid | valid |
| 0x9 | Read IO request | Invalid | invalid |
| 0xa | Response IO | Invalid | valid |
| 0xb | Write IO | Invalid | valid |
| 0xc-0xf | reserved | | |

State—Cache state associated with the command.

| Value | State & Description |
|---|---|
| 0x0 | Invalid |
| 0xl | Reserved |
| 0x2 | C_EMPTY_RO-Read only copy, empty |
| 0x3 | C_FULL_RO-Read only copy, full |
| 0x4 | O_EMPTY_RW-Owner, writeable, empty |
| 0x5 | O_EMPTY_RWE-Owner, writeable, no other copies |
| 0x6 | O_FULL_RW-Owner, writeable, full |
| 0x7 | O_FULL-RWE-Owner, writeable, no other copies |

Early Valid—Boolean that indicates that the corresponding packet slot contains a valid command. Bit is present early in the packet. Both early and late valid Booleans must be true for packet to be valid.
Early Busy—Boolean that indicates that the command could not be processed by RI interface. The command must be re-tried by initiator. The packet is considered busy if either early busy or late busy is set.
Late Valid—Boolean that indicated that the corresponding packet slot contains a valid command. Bit is present late in the packet. Both early and late valid Booleans must be true for packet to be valid. When an RI interface is passing a packet through it should attempt clear early valid if late valid is false.
Late Busy—Boolean that indicates that the command could not be processed by RI interface. The command must be re-tried by the initiator. The packet is considered busy if either early busy or late busy is set. When an RI interface is passing a packet through it should attempt to set early busy if late busy is true.

### Physical Transport

The Ring Interconnect bandwidth is scalable to meet the needs of scalable implementations beyond 2-core. The RI can be scaled hierarchically to provide virtually unlimited scalability.

The Ring Interconnect physical transport is effectively a rotating shift register. The first implementation utilizes 4 stages per RI interface. A single bit specifies the first cycle of each packet (corresponding to cycle 1 in table below) and is initialized on reset.

For a two-core SEP implementation, example, there can be a 32 byte wide data payload path and a 57 bit address path that also multiplexes command, state, flow control and packet signaling.

| | Data payload path | Address payload path |
|---|---|---|
| Cycle | (32 bytes wide) | (57 bits) |
| 1 | Previous packet . . . | SystemAddress[63:7] |
| 2 | Databytes[31:0] | Command, ReqID[31:0]], State, |
| | | EarlyValid, EarlyBusy |
| 3 | Databytes[63:32] | Not used |
| 4 | Databytes[95:64] | LateValid, LateBusy |
| 5 | Databytes[127:96] | Next packet . . . |

### Instruction Set Expandability

Provides a capability to define programmable instructions, which are dedicated to a specific application and/or algorithm. These instructions can be add in two ways:
Dedicated functional unit—Fixed instruction capability. This can be an additional functional unit or an addition to an existing unit.
Programmable functional unit—Limited FPGA type functionality to tailor the hardware unit to the specifics of the algorithm. This capability is loaded from a privileged control register and is available to all threads.

### ADVANTAGES AND FURTHER EMBODIMENTS

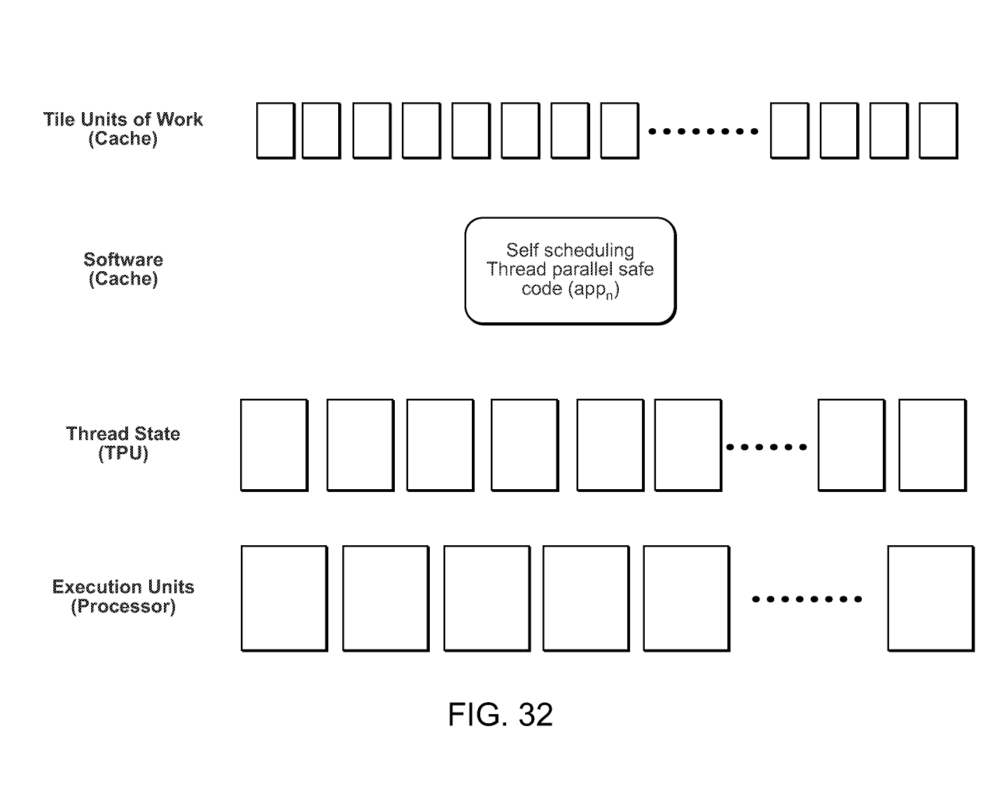

Systems constructed in accord with then invention can be employed to provide a runtime environment for executing tiles, e.g., as illustrated in FIG. 32 (sans graphical details identifying separate processor or core boundaries):

Those tiles can be created, e.g., applications, attendant software libraries, etc., and assigned to threads in the conventional manner known in the art, e.g., as discussed in U.S. Pat. No. 5,535,393 (“System for Parallel Processing That Compiles a [Tiled] Sequence of Instructions Within an Iteration Space”), the teachings of which are incorporated herein by reference. Such tiles can beneficially utilize memory access instructions discussed herein, as well those disclosed, by way of non-limiting example, in FIGS. 24A-24B and the accompanying text (e.g., in the section entitled “CONSUMER-PRODUCER MEMORY”) of incorporated-by-reference U.S. Pat. No. 7,685,607 and U.S. Pat. No. 7,653,912, the teachings of which figures and text (and others of which pertain memory access instructions and particularly, for example, the Empty and Fill instructions) are incorporated herein by reference, as adapted in accord with the teachings hereof.

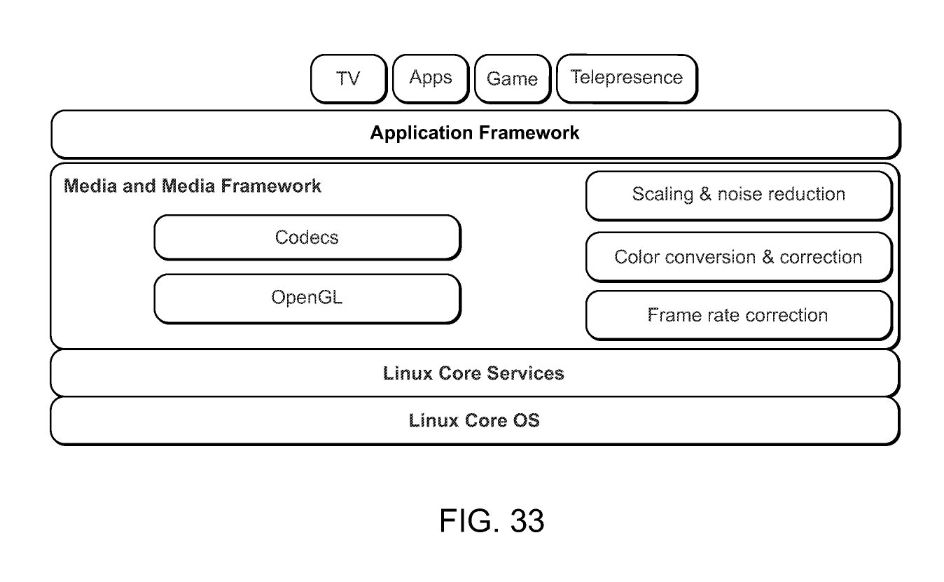

A exemplary, non-limiting software architecture utilizing a runtime environment of the sort provided by systems according to the invention is shown in FIG. 33, to with, a TV/set-top application providing simultaneously running one or more of television, telepresence, gaming and other applications (apps) by way of example, that (a) execute over a common applications framework of the type known in the art as adapted in accord with the teachings hereof and that, in turn (b) executes on media (e.g., video streams, etc.) of the type known in the art utilizing a media framework (e.g., codecs, OpenGL, scaling and noise reduction functionality, color conversion & correction functionality, and frame rate correction functionality, all by way of example) of the type known in the art (e.g., Linux core services) as adapted in accord with the teachings hereof and that, in turn, (c) executes on core services of the type known in the art as adapted in accord with the teachings hereof and that, in turn, (d) executes on a core operating system (e.g., Linux) of the type known in the art as adapted in accord with the teachings hereof.

Processor modules, systems and methods of the illustrated embodiment are well suited for executing digital cinema, integrated telepresence, virtual hologram based gaming, hologram-based medical imaging, video intensive applications, face recognition, user-defined 3D presence, software applications, all by way of non-limiting example, utilizing a software architecture of the type shown in FIG. 33.

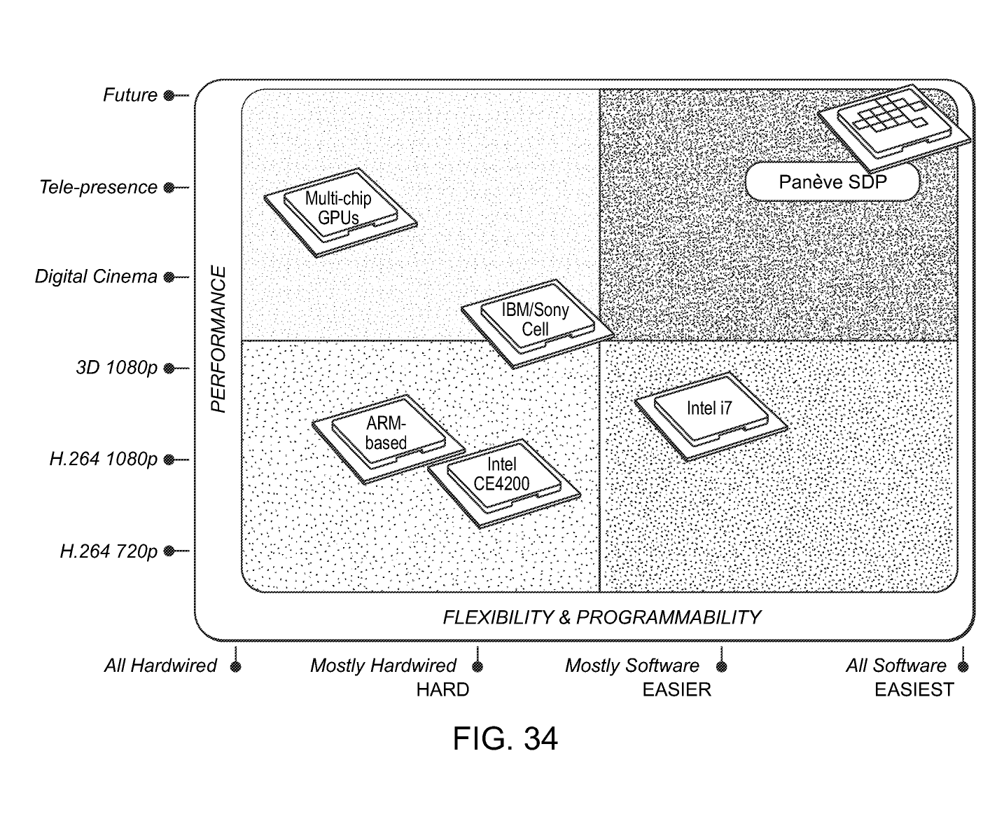

Advantages of processor modules and systems according to the invention are that, among other things, they provide the flexibility & programmability of “all software” logic solutions combined with the performance equal or better to that of “all hardware” logic solutions, as depicted in FIG. 34.

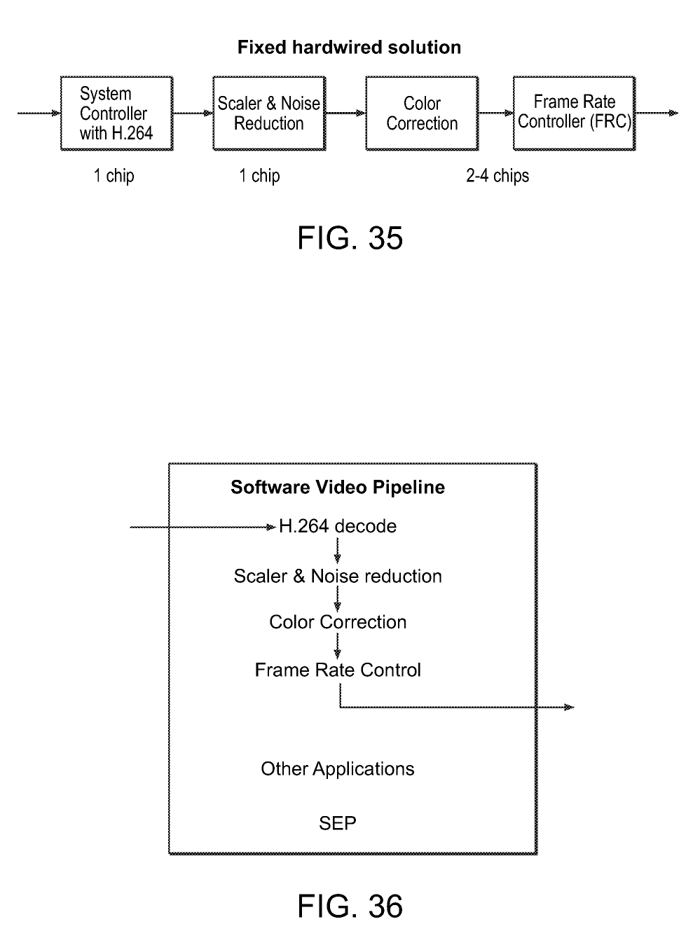

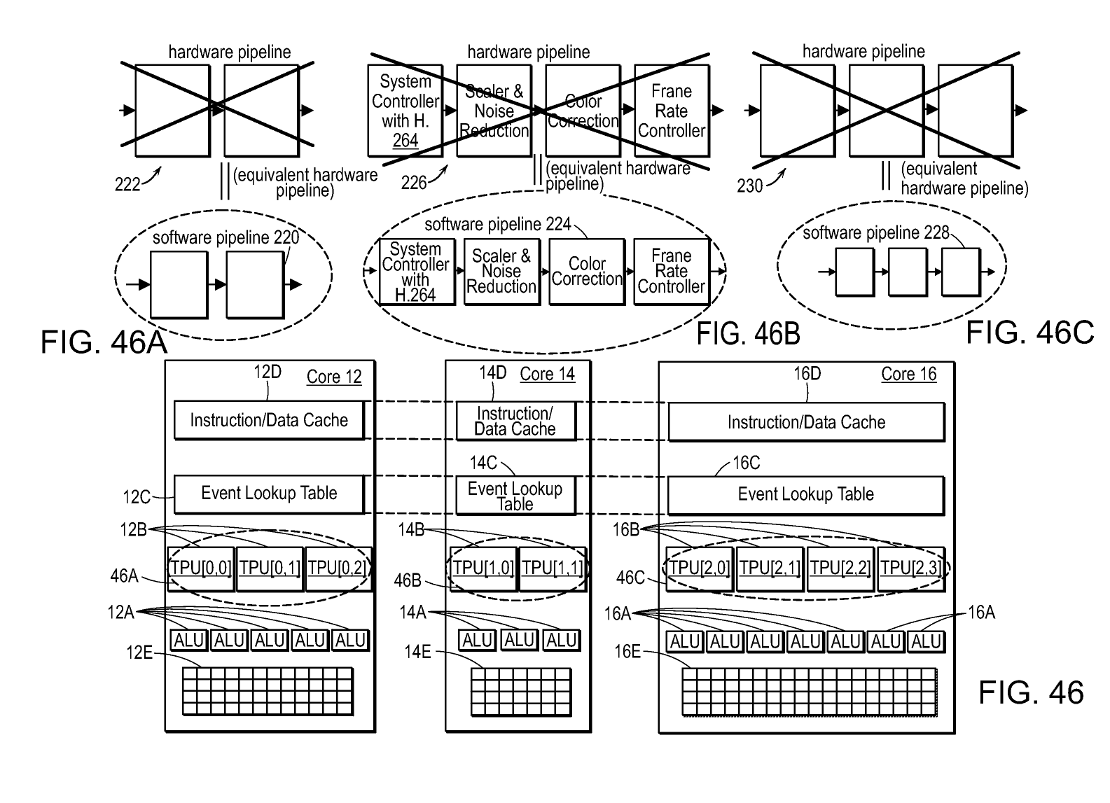

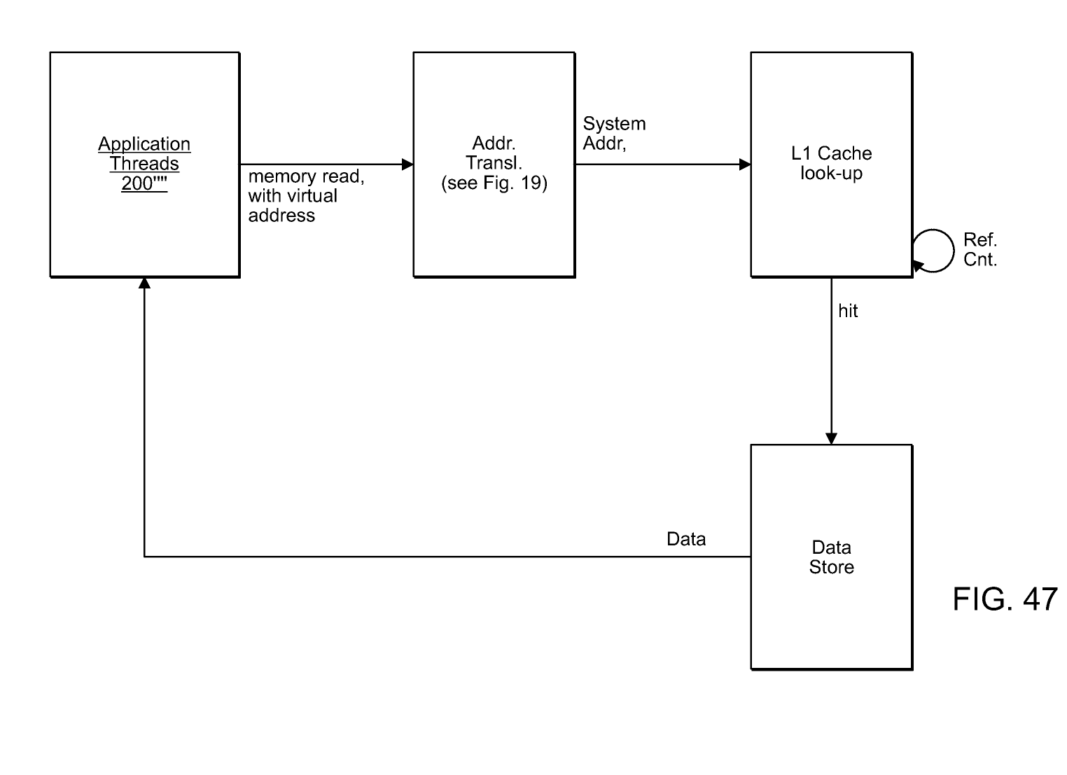

A typical implementation of a consumer (or other) device for video processing using a prior art processor is shown in FIG. 35. Generally speaking, such implementations demand that new hardware (e.g., additional hardware processor logic) be added for each new function in the device. By comparison, there is shown in FIG. 36 a corresponding implementation using a processor module of the illustrated embodiment. As evident from comparing the drawings, what has typically required a fixed hardwired solution in prior art implementations can be effected by a software pipeline in solutions in accord with the illustrated embodiment. This is also shown in FIG. 46, wherein a pipeline of instructions executing on each or cores 12-16 serve as software equivalents of corresponding hardware pipelines of the type traditionally practiced in the prior art. Thus, for example, a pipeline of instructions 220 executing on the TPUs 12B of core 12 perform the same functionality as and take place of a hardware pipeline 222; software pipeline 224 executing on TPUs 14B of core 14 take perform the same functionality as and take place of a hardware pipeline 226; and, software pipeline 228 executing on TPUs 14B of core 14 take perform the same functionality as and take place of a hardware pipeline 230, all by way of non-limiting example.

In addition to executing software pipelines that perform the same functionality as and take place of corresponding hardware pipelines, new functions can be added to these cores 12-16 without the addition of new hardware as those functions can often be accommodated via the software pipeline.

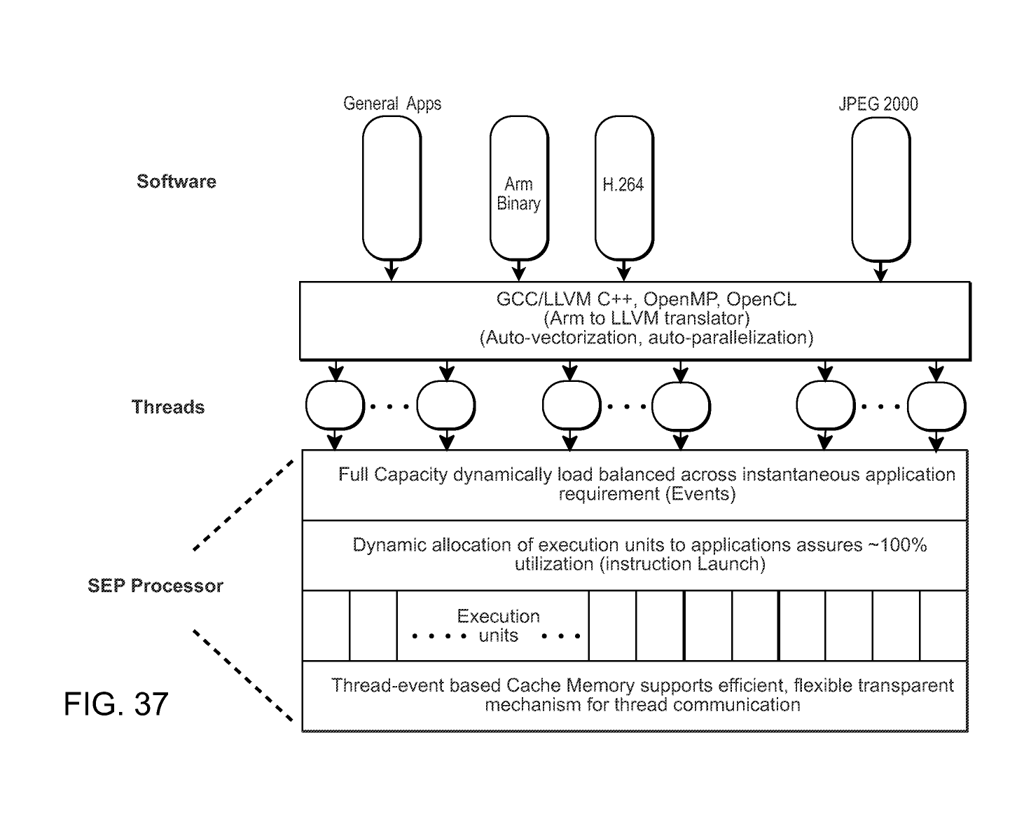

To these ends, FIG. 37 illustrates use of an SEP processor in accord with the invention for parallel execution of applications, ARM binaries, media framework (here, e.g., H.264 and JPEG 2000 logic) and other components of the runtime environment of a system according to the invention, all by way of example.

Referring to FIG. 46, the illustrated cores are general purpose processors capable of executing pipelines of software components in lieu of like pipelines of hardware components of the type normally employed by prior art devices. Thus, for example, core 14 executes, by way of non-limiting example, software components pipelined for video processing and including a H.264 decoder software module, a scalar and noise reduction software module, a color correction software module, a frame race control software module, e.g., as shown. This is in lieu of inclusion execution of a like hardware pipeline 226 on dedicated chips, e.g., a semiconductor chip that functions as a system controller with H.264 decoding, pipelined to a semiconductor chip that functions as a scaler and noise reduction module, pipelined to a semiconductor chip that functions for color correction, and further pipelined to a semiconductor chip that functions as a frame rate controller.

In operation, each of the respective software components, e.g., of pipeline 224, executes as one or more threads, all of which for a given task may execute on a single core or which may be distributed among multiple cores.

To facilitate the foregoing, cores 12-16 operate as discussed above and each supports one or more of the following features, all by way of non-limiting example, dynamic assignment of events to threads, a location-independent shared execution environment, the provision of quality of service through thread instantiation, maintenance and optimization, JPEG2000 bit plane stripe column encoding, JPEG2000 binary arithmetic code lookup, arithmetic operation transpose, a cache control instruction set and cache-initiated optimization, and a cache managed memory system.

Shown and described herein are processor modules, systems and methods meeting the objects set forth above, among others. It will be appreciated that the illustrated embodiments are merely examples of the invention and that other embodiments embodying changes thereto fall within the scope of the invention.

1. A digital data processor or processing system comprising
A. one or more nodes that are communicatively coupled to one another,
B. one or more memory elements (“physical memory”) communicatively coupled to at least one of the nodes,
C. at least one of the nodes includes a cache memory that stores at least one of data and instructions any of accessed and expected to be accessed by the respective node,
D. wherein the cache memory additionally stores tags specifying addresses for respective data or instructions in the physical memory.

2. The digital data processor or processing system of claim 1, comprising system memory that includes the physical memory and cache memory.

3. The digital data processor or processing system of claim 2, wherein the system memory comprises the cache memory of multiple nodes.

4. The digital data processor or processing system of claim 3, wherein the tags stored in the cache memory specify addresses for respective data or instructions in system memory.

5. The digital data processor or processing system of claim 3, wherein the tags specify one or more statuses for the respective data or instructions.

6. The digital data processor or processing system of claim 5, where those statuses include any of a modified status and a reference count status.

7. The digital data processor or processing system of claim 1, wherein the cache memory comprises multiple hierarchical levels.

8. The digital data processor or processing system of claim 7, wherein the multiple hierarchical levels include at least one of a level 1 cache, a level 2 cache and a level 2 extended cache.

9. The digital data processor or processing system of claim 1, wherein the addresses specified by the tags form part of a system address space that is common to multiple ones of the nodes.

10. The digital data processor or processing system of claim 9, wherein the addresses specified by the tags form part of a system address space that is common to all of the nodes.

11. A digital data processor or processing system comprising
A. one or more nodes that are communicatively coupled to one another, at least one of which nodes a processing module,
B. one or more memory elements (“physical memory”) communicatively coupled to at least one of the nodes,
C. at least one of the nodes includes a cache memory that stores at least one of data and instructions any of accessed and expected to be accessed by the respective node,
D. wherein at least the cache memory stores tags (“extension tags”) specifies a system address and a physical address for each of at least one datum or instruction that is stored in physical memory.

12. The digital data processor or processing system of claim 11, comprising system memory that includes the physical memory and cache memory.

13. The digital data processor or processing system of claim 12, comprising system memory that includes the physical memory and cache memory of multiple nodes.

14. The digital data processor or processing system of claim 12, wherein a said system address specified by the extension tags form part of a system address space that is common to multiple ones of the nodes.

15. The digital data processor or processing system of claim 14, wherein a said system address specified by the extension tags form part of a system address space that is common to all of the nodes.

16. The digital data processor or processing system of claim 3, wherein the tags specify one or more statuses for a said respective data or instruction.

17. The digital data processor or processing system of claim 16, where those statuses include any of a modified status and a reference count status.

18. The digital data processor or processing system of claim 11, wherein at least one said node comprises address translation that utilizes a said system address and a said physical address specified by a said extension tag to translate a system addresses to a physical addresses.

19. A digital data processor or processing system comprising
A. one or more nodes that are communicatively coupled to one another, at least one of which nodes a processing module,
B. one or more memory elements (“physical memory”) communicatively coupled to at least one of the nodes, where one or more of those memory elements includes any of flash memory or other mounted drive,
C. at least one of the nodes includes a cache memory that stores at least one of data and instructions any of accessed and expected to be accessed by the respective node,
D. the physical memory and cache memory of the nodes together comprising system memory,
E. the cache memory of each node storing at least one of data and instructions any of accessed and expected to be accessed by the respective node and, additionally, storing tags specifying addresses for at least one respective datum or instructions in physical memory, wherein at least one of those tags (“extension tag”) a system address and a physical address for each of at least one datum or instruction that is stored in physical memory.

20. The digital data processor or processing system of claim 19, in which multiple said extension tags are organized as a tree in system memory.

21-190. (canceled)
